(19) United States
(12) Patent Application Publication
(10) Pub. No.: US 2020/0067126 A1
(43) Pub. Date: Feb. 27, 2020

(54) PRESSURIZED ELECTROCHEMICAL CELL

(71) Applicant: QUANTUMSCAPE CORPORATION, San Jose, CA (US)

(72) Inventors: Joseph HAN, Redwood City, CA (US); Wes HERMANN, Palo Alto, CA (US); Joseph SALVI, Santa Clara, CA (US)

(21) Appl. No.: 16/461,119

(22) PCT Filed: Nov. 28, 2017
(86) PCT No.: PCT/US2017/063523

§ 371 Date: May 15, 2019

Related U.S. Application Data
(60) Provisional application No. 62/426,857, filed on Nov. 28, 2016.

(51) Int. Cl. H01M 10/04; H01M 10/052; H01M 10/0562; H01M 10/0565; H01M 4/38; H01M 6/18

(52) U.S. Cl. CPC H01M 10/0468; H01M 10/052; H01M 6/18; H01M 10/0565; H01M 4/382; H01M 10/0562

(57) ABSTRACT

Provided herein are electrochemical cells as well as coin cells, can cells, and pouch cells which include these electrochemical cells. The electrochemical cells herein include lithium metal negative electrodes and solid electrolyte separators. The coin cells, can cells, and pouch cells which include the electrochemical cells provide pressure to the electrochemical cells to maintain Ohmic contact between the lithium metal negative electrode and the solid electrolyte separator. Also provided herein are methods of making and using these electrochemical cells, coin cells, can cells, and pouch cells.

### CROSS-REFERENCE TO RELATED APPLICATION

This application claims priority to and the benefit of U.S. provisional application No. 62/426,857, filed on Nov. 28, 2016, which is incorporated by reference herein in its entirety for all purposes FIELD

The present disclosure concerns electrochemical cells and rechargeable batteries containing the same.

### BACKGROUND

In a rechargeable Li⁺ ion battery, Li⁺ ions move from a negative electrode to a positive electrode during discharge and in the opposite direction during charge. This process produces electrical energy (Energy=Voltage×Current) in a circuit connecting the electrodes, which is electrically insulated from, but parallel to, the Li⁺ ion conduction path. The battery's voltage (V versus Li) is a function of the chemical potential difference for Li situated in the positive electrode as compared to the negative electrode and is maximized when Li metal is used as the negative electrode. An electrolyte physically separates and electrically insulates the positive and negative electrodes while also providing a conduction medium for Li⁺ ions. The electrolyte ensures that when Li metal oxidizes at the negative electrode during discharge (e.g., Li↔Li⁺+e⁻) and produces electrons, these electrons conduct between the electrodes by way of an external circuit which is not the same pathway taken by the Li⁺ ions.

When the positive electrode, electrolyte, and negative electrode are made of solid materials, the resulting rechargeable battery is referred to as a solid-state rechargeable battery. In such a battery having an solid electrolyte separator and a lithium metal negative electrode, the separator-lithium interface requires sufficient pressure to locally flow lithium metal, while plating (i.e., charging) and striping (i.e., discharging), into and out of the separator which is in intimate interfacial contact with it. During the plating and stripping, the electrochemical stack will expand and contract by about 20-40% by volume. This expansion and contraction can lead the delamination of the positive electrode, solid separator, and negative electrode. This delamination results in an increase in the area-specific resistance between these layers and is detrimental to electrochemical performance. In addition, during discharge of an electrochemical stack, which includes a lithium metal anode, gaps and/or cavities tend to build up or be created between the lithium metal anode (i.e., negative electrode), and a solid-state electrolyte that is in contact therewith. As more gaps and cavities build up, the amount of lithium metal which is in direct physical contact with the solid-state electrolyte tends to decrease. Because the edges of the lithium metal are unconstrained, macro-scale pressure can build up near the edges in a non-uniform manner. This increase in pressure non-uniformly can result in cracking or breaking of the electrochemical cell.

To address some of the issues related to pressurizing electrochemical cells, certain battery cell configurations are known, e.g., U.S. Pat. Nos. 3,264,140; 4,923,769; 5,162,171; 5,234,779; 5,825,120; 6,645,668; and 6,689,510 as well as US Patent Publication No. 2004/0247995. See also Ferrese, A., et al., Journal of The Electrochemical Society, 159 (10) A1615-A1623 (2012); Jow, T. R., et al. Solid State Ionics 9 & 10 (1983) 695-698; Jow, T. R., et al. Journal of The Electrochemical Society, 1983, p. 737; Wilkinson, D. P., et al. Journal of Power Sources 36, (1991), 517-527; Wilkinson, D. P., J. Electroanal. Chem., 355 (1993), 193-203; Gireaud, L., et al., Electrochemistry Communications 8 (2006) 1639-1649. However, these publications suffer from a variety of deficiencies which make them unsuitable for current solid-state battery requirements. Accordingly, there is a need in the relevant art to which the instant disclosure pertains for improved methods and devices which can sufficiently pressurize electrochemical cells.

### SUMMARY

In one embodiment, set forth herein is an electrochemical cell including one or more electrode stacks, a hydrostatic material, and an outer-shell material, wherein the one or more electrode stacks each include a lithium metal negative electrode, a solid-state electrolyte, and a positive electrode; wherein the hydrostatic material contacts one of more of the stacks; wherein the hydrostatic material is contained by an outer-shell material; and wherein the bulk modulus of the outer-shell material is greater than the bulk modulus of the hydrostatic material.

In a second embodiment, set forth herein is an electrochemical device including an electrochemical cell set forth herein.

In a third embodiment, set forth herein is an electrochemical device, including one or more electrode stacks, a hydrostatic material, an outer-shell material, and two conductive leads; wherein the one or more electrode stacks each include: a lithium metal negative electrode, a solid-state electrolyte, and a positive electrode; wherein the hydrostatic material contacts the one or more electrode stacks and at least one surface of the outer-shell material; wherein the hydrostatic material is contained by an outer-shell material; and wherein the bulk modulus of the outer-shell material is greater than the bulk modulus of the hydrostatic material; wherein one conductive lead is in electrical contact with the lithium metal negative electrode and one tab; and wherein a second conductive lead is in electrical contact with the positive electrode and one cell tab.

In a fourth embodiment, set forth herein is an electrochemical device, including one or more electrode stacks, a hydrostatic material, an outer-shell material, a device housing which contains the electrochemical device, wherein the device housing includes at least two conductive lead tabs; wherein the one or more electrode stacks each include a lithium metal negative electrode, a solid-state electrolyte, and a positive electrode; wherein the hydrostatic material contacts the electrodes and at least one surface of the outer-shell material; wherein the hydrostatic material is contained by an outer-shell material; and wherein the bulk modulus of the outer-shell material is greater than the bulk modulus of the hydrostatic material; wherein one conductive lead tab is in electrical contact with the lithium metal negative electrode; and wherein a second conductive lead tab is in electrical contact with the positive electrode.

In a fifth embodiment, set forth herein is an electrochemical device, including one or more electrode stacks, a hydrostatic material, an outer-shell material, a device housing which contains the electrochemical device, wherein the device housing includes at least two conductive lead tabs; wherein the one or more electrode stacks each include a lithium metal negative electrode, a solid-state electrolyte, and a positive electrode; wherein the electrode stack is contained within a hydrostatic material; wherein the hydrostatic material is contained by an outer-shell material; and wherein the bulk modulus of the outer-shell material is greater than the bulk modulus of the hydrostatic material; wherein one conductive lead tab is in electrical contact with the lithium metal negative electrode; and wherein a second conductive lead tab is in electrical contact with the positive electrode.

In a sixth embodiment, set forth herein is an electrochemical cell including an electrode stack, and a gas-spring (i.e., a spring which applies the pressure of a gas to an electrochemical stack, such as but not limited to a compressible fluid), an electrochemical cell housing which contains the electrochemical device, wherein the device housing includes at least two conductive lead tabs; wherein the electrode stack includes a lithium metal negative electrode, a solid-state electrolyte, and a positive electrode; wherein the compressible fluid is between and in contact with the electrode stack and one tab; and wherein the compressible fluid maintains a hydrostatic pressure on the electrode stack. In some examples, the compressible fluid is a compressible fluid, which can include a gas, liquid or both.

In a seventh embodiment, set forth herein pressurized stack including an electrode stack: wherein the electrode stack is pressurized; wherein the electrode stack includes: a lithium metal negative electrode, a solid-state electrolyte, and a positive electrode; wherein the stack maintains at least 50% of the surface area of the solid electrolyte in contact with the lithium metal when discharged at a temperature of about 0° C. to about 150° C. and at a current density of about 0.1 mA/cm² to about 10 mA/cm².

In an eighth embodiment, set forth herein pressurized electrochemical cell including an electrode stack: wherein the electrode stack includes: a lithium metal negative electrode, a solid-state electrolyte, and a positive electrode; wherein the pressurized electrochemical cell inhibits an increase in electrochemical cell's bulk interfacial resistance by more than a factor of 10 when discharged at a temperature of about 0° C. to about 150° C. and at a current density of about 0.1 mA/cm² to about 10 mA/cm².

In a ninth embodiment, set forth herein method of using the electrochemical cell or the pressurized electrochemical cell set forth herein, including discharging the stack at a current density of about 0.01 mA/cm² to about 10 mA/cm2 and at a temperature of about 0° C. to about 150° C.; and maintaining at least 50% of the active surface area of the lithium metal.

In a tenth embodiment, set forth herein is a method of using the electrochemical cell or the pressurized electrochemical cell set forth herein, including discharging the stack at a current density of about 0.01 mA/cm² to about 10 mA/cm² and at a temperature of about 0° C. to about 150° C.; and maintaining at least 50% of the active surface area of the lithium metal.

In an eleventh embodiment, set forth herein method of using the electrochemical cell or the pressurized electrochemical cell of claim including discharging the stack at a current density of about 0.01 mA/cm² to about 10 mA/cm² and at a temperature of about 0° C. to about 150° C.; and inhibiting an increase in the electrochemical cell or pressurized stack's interfacial resistance by more than a factor of 10.

In a twelfth embodiment, set forth herein is an electrochemical cell including a positive electrode current collector foil having a first side and a second side; a first positive electrode and a second positive electrode, wherein the first positive electrode contacts the first side of the positive electrode current collector foil and wherein the second positive electrode contacts the second side of the positive electrode current collector foil; a first solid-state electrolyte and a second solid-state electrolyte, wherein the first solid-state electrolyte contacts the first positive electrode and wherein the second solid-state electrolyte contacts the second positive electrode; a first lithium metal negative electrode and a second lithium metal negative electrode, wherein the first lithium metal negative electrodes contacts the first solid-state electrolyte and wherein the second lithium metal negative electrode contacts the second solid-state electrolyte; a first negative electrode current collector and a second current collector, wherein the first negative electrode contacts the first lithium metal negative electrode and wherein the second negative electrode current collector contacts the second lithium metal negative electrode; and a pressure-inducing element in contact with either the first negative electrode current collector or the second negative electrode current collector.

### BRIEF DESCRIPTIONS OF THE DRAWINGS

FIG. 1 shows a plot of number of molecules (kmol) in liquid or gas phase as a function of temperature (° C.) for C₂H₆ and toluene (C₇H₈₍ₗ₎ and C₇H_{8(g)}).

FIG. 2 shows an embodiment of a solid-state cell in accordance with the disclosure set forth herein.

FIG. 3 shows an embodiment of a solid-state coin cell in accordance with the disclosure set forth herein.

FIG. 4 shows an embodiment of a solid-state can cell in accordance with the disclosure set forth herein.

FIG. 5 shows an embodiment of a solid-state pouch (i.e., prismatic) cell in accordance with the disclosure set forth herein.

FIG. 6 shows an embodiment of a stack of solid-state can cells in accordance with the disclosure set forth herein.

FIG. 7 shows a cross-sectional illustration of an embodiment of a stack of solid-state can cells in accordance with the disclosure set forth herein.

FIG. 8 shows an embodiment of an electrochemical cell that includes an embodiment of a compressible fluid spring.

FIG. 9 shows Voltage as a function of active mass-specific capacity, mAh/g, for coin cells in Example 1.

FIG. 10 shows a pouch cell.

FIG. 11 shows discharge energy as a function of cumulative cycle index for coin cells in Example 1.

FIG. 12 shows the amount of gas in the liquid phase of a cell to maintain a constant pressure across an operating temperature range for a single component (ethane) and two components (ethane+toluene).

FIG. 13 shows a schematic of a cell that applies uniaxial and hydrostatic pressure to a cell stack.

### DETAILED DESCRIPTION

### A. General

During discharge of an electrochemical stack, which includes a lithium metal anode, the ionic resistance (i.e., impedance) in the electrochemical stack can increase if gaps and/or cavities build up or are created between the lithium metal anode (i.e., negative electrode), and a solid-state electrolyte that is in contact therewith, or if there is a decrease in the surface area of the lithium metal which is in contact with the solid-state electrolyte. The disclosure detailed herein provides solutions for preventing this decrease in the active surface area of the lithium metal, which is the surface area of the lithium metal which physically contacts the solid-state electrolyte. In some embodiments, the disclosure provides electrochemical cells which are appropriately pressurized, either through stack configurations, cell configurations, cell housings, or internal cell mechanical and/or gas-springs, or springs which apply gas pressure to an electrochemical stack, such that when the stack is discharged, a stable and/or constant transfer/conduction of lithium ions through the solid-state separator is maintained by the application of pressure. The disclosures here set forth devices and electrochemical cells maintains mechanical pressure magnitude and uniformity across the working electrode surface while stack expands/contracts. The disclosure herein facilitates stable ionic transfer of lithium ions (e.g., Li) through a solid separator electrolyte by maintaining the mechanical pressure magnitude and uniformity across the working surface of the electrode stack while the stack expands and contracts. In some examples, the pressure applied is a function of the state-of-charge (SOC) of the electrochemical cell being pressurized. In some examples, the gas-spring is a compressible fluid which can include a gas, liquid or both.

Disclosed herein, in some examples, are electrochemical cell pressure systems which include a hydrostatic material in direct contact with an electrochemical stack (or electrochemical stacks), and wherein the hydrostatic material is surrounded by an outer-shell material. In some examples, the modulus of the hydrostatic material is less than the modulus of the outer-shell material, e.g., Gᵢₙₙₑᵣ/Gₒᵤₜₑᵣ<1. For example, Gᵢₙₙₑᵣ may in some examples be greater than 500 MPa. In some examples, Gᵢₙₙₑᵣ is greater than 1 GPa.

### B. Definitions

As used herein, the term “about,” when qualifying a number, e.g., about 15% w/w, refers to the number qualified and optionally the numbers included in a range about that qualified number that includes +10% of the number. For example, about 15% w/w includes 15% w/w as well as 13.5% w/w, 14% w/w, 14.5% w/w, 15.5% w/w, 16% w/w, or 16.5% w/w. For example, “about 75° C.,” includes 75° C. as well 68° C., 69° C., 70° C., 71° C., 72° C., 73° C., 74° C., 75° C., 76° C., 77° C., 78° C., 79° C., 80° C., 81° C., 82° C., or 83° C.

As used herein, “selected from the group consisting of” refers to a single member from the group, more than one member from the group, or a combination of members from the group. A member selected from the group consisting of A, B, and C includes, for example, A only, B only, or C only, as well as A and B, A and C, B and C, as well as A, B, and C.

As used herein, the term “incompressible,” refers to a material wherein the density does not significantly change as the material is pressurized or as the material flows (at a constant temperature). Herein, a significant change in density is a change of at least 14% or more over a pressure range of 1 to 10,000 PSI. Herein, the phrase “incompressible fluid,” refers to a fluid that is incompressible. For example, a type of mineral oil has a density of 0.85 g/ml at 20° C. If this density does not change by more than 0.043 g/mL when the material is pressurized up to 10,000 PSI at 20° C., then this type of mineral oil is an incompressible fluid insofar as this term is used herein.

As used herein, the term “compressible,” refers to a material wherein the density significantly changes as the material is pressurized or as the material flows (at a constant temperature). Herein, a significant change in density is a change of at least 14% or more over a pressure range of 1 to 10,000 PSI. In a compressible gas (according to ideal gas laws), if the pressure goes up ten-fold at a constant temperature, then the volume decreases ten-fold accordingly.

As used herein, the phrases “electrochemical cell” or “battery cell” shall mean a single cell including a positive electrode and a negative electrode, which have ionic communication between the two by way of an electrolyte. Unless specific to the contrary, the electrolyte is an solid-state electrolyte. In some examples, the electrolyte includes a solid-state electrolyte in addition to a liquid electrolyte and/or a gel electrolyte. In some embodiments, the same battery cell includes multiple positive electrodes and/or multiple negative electrodes enclosed in one container.

As used herein, the phrase “direct contact,” means that two materials are in sufficient physical contact to conduct an electronic or ionic current therebetween, if the materials are electrically or ionically conductive. Direct contact between two materials, one of which is electrically or ionically insulating, means that the two materials share an interface that transmits an applied force or pressure.

As used herein, the phrase “electrochemical device” refers to an energy storage device, such as, but not limited to a Li-secondary battery that operates or produces electricity or an electrical current by an electrochemical reaction, e.g., a conversion chemistry reaction such as 3Li+FeF₃ ↔3LiF+Fe. Electrochemical devices include those that operate or produce electricity or an electrical current by an intercalation chemistry electrochemical reaction, such as but not limited to the Li intercalation reactions that occur with cathode active materials, such as but not limited to cobalt oxide, nickel-cobalt-aluminum oxide (NCA), nickel-manganese-cobalt oxide (NMC), lithium iron phosphate (LFP), and lithium titanate (LTO) cathode active materials.

As used herein the phrase “energy storage electrode,” refers to, for example, an electrode that is suitable for use in an energy storage device, e.g., a lithium rechargeable battery or Li-secondary battery. As used herein, such an electrode is capable of conducting electrons and Li ions as necessary for the charging and discharging of a rechargeable battery.

As used herein the term “making,” refers to the process or method of forming or causing to form the object that is made. For example, making an energy storage electrode includes the process, process steps, or method of causing the electrode of an energy storage device to be formed. The end result of the steps constituting the making of the energy storage electrode is the production of a material that is functional as an electrode for reversibly charging and discharging Li⁺ ions.

As used herein, the phrase “providing” refers to the provision of, generation of, presentation of, or delivery of that which is provided.

As used herein, the term “electrode stack,” refers to at least a positive electrode, a negative electrode, and a solid-state electrolyte positioned between the positive and negative electrodes. In some examples, a stack includes a series of repeating layers of positive electrodes, solid separators, and negative electrodes.

As used herein, the term “hydrostatic material,” refers to a material which can exert a uniform pressure about that which the hydrostatic material surrounds, contains, or encases. Example of hydrostatic materials include, but are not limited to, are gasses such as argon or nitrogen. Hydrostatic pressure may be measured with a gas pressure gauge. Herein, contain includes surrounding a material partially. For example, an architecture comprising two concentric rings in which one ring is inside and directly contacting the other ring would be an example in which the outer ring surrounds and contains the inner ring.

As used herein, the term “outer-shell material,” refers to a material which surrounds, contains, or encases the hydrostatic material. Example outer-shell materials include, but are not limited to, rubbers and/or elastic polymers.

As used herein, the terms “cathode” and “anode” refer to the electrodes of a battery. During a charge cycle in a Li-secondary battery, Li ions leave the cathode and move through an electrolyte and to the anode. During a charge cycle, electrons leave the cathode and move through an external circuit to the anode. During a discharge cycle in a Li-secondary battery, Li ions migrate towards the cathode through an electrolyte and from the anode. During a discharge cycle, electrons leave the anode and move through an external circuit to the cathode.

As used herein, the term “negative electrode,” refers to a lithium metal negative electrode unless specified otherwise to the contrary.

As used herein, the term “a positive electrode,” refers to the portion of an electrochemical cell to which ions and electrons flow during discharge of the electrochemical cell.

As used herein, the term “electrolyte,” refers to an ionically conductive and electrically insulating material. Electrolytes are useful for electrically insulating the positive and negative electrodes of a rechargeable battery while allowing for the conduction of ions, e.g., Li⁺, through the electrolyte. In some of the electrochemical devices described herein, the electrolyte includes a solid-state film, pellet, or monolith of a Li⁺ conducting oxide, such as a lithium-stuffed garnet. In some examples, the electrolyte further includes a gel electrolyte which is laminated to or directly contacting the solid film, pellet, or monolith

As used herein, the term “solid-state electrolyte,” refers to an electrolyte, as defined herein, wherein the electrolyte is a solid.

As used herein, the terms “separator,” and “Li⁺ ion-conducting separator,” are used interchangeably with separator being a short-hand reference for Li⁺ ion-conducting separator, unless specified otherwise explicitly. A separator refers to an solid-state electrolyte which conducts Li⁺ ions, is substantially insulating to electrons, and is suitable for use as a physical barrier or spacer between the positive and negative electrodes in an electrochemical cell or a rechargeable battery. A separator, as used herein, is substantially insulating to electrons. A separator's lithium ion conductivity is at least 10³ times, and typically 10⁶ times, greater than the separator's electron conductivity.

As used herein, the term “the bulk modulus,” is equivalent to a Young's modulus, i.e., elastic modulus or modulus of elasticity. Its value is determined by the slope of a material's stress versus strain curve prior to permanent deformation (e.g., pressure vs. % deformation). The elastic modulus is typically published by the manufacturer or tested by a person having ordinary skill in the art (e.g., engineering). Stiff materials have a high elastic modulus. Pliable materials have a low elastic modulus. For rubbery fluid like materials (materials with non-linear stress strain curves), the bulk modulus is a function of the elastic modulus and is approximately 10× the elastic modulus, though in practice it is actually a function of the material's elastic modulus (E) and poisson's ration (v). A modulus is measured in one of the x, y, or z planes. A stress is applied to a material parallel to one of the x, y, or z planes. As stress is applied to a plane, the relationship between its dimensional change and the dimensional changes of orthogonal planes. Representative modulus values are found in The CES 2009 EDUPACK, Cambridge University, copyright Granta Design January 2009, e.g., page 28 therein, the entire contents of which are herein incorporated by reference in its entirety for all purposes.

As used herein, the term “contact” means direct contact unless specified otherwise. For electrically conductive materials, contact means contact sufficient for electrical conduction to occur between the contacting materials. For ionically conductive materials, contact means contact sufficient for ionic conduction to occur between the contacting materials. Two materials which are in direct contact are positioned without an interleaving layer between the two materials.

As used herein, the term “rational number” refers to any number which can be expressed as the quotient or fraction (e.g., p/q) of two integers (e.g., p and q), with the denominator (e.g., q) not equal to zero. Example rational numbers include, but are not limited to, 1, 1.1, 1.52, 2, 2.5, 3, 3.12, and 7.

Unless specified to the contrary, subscripts and molar coefficients in empirical formulae are based on the quantities of raw materials initially batched to make the material described. For example, for the material, Li₇La₃Zr₂O₁₂0.35Al₂O₃, the subscripts, 7, 3, 2, 12, and the coefficient, 0.35, refer to the respective elemental ratios in the chemical precursors (e.g., LiOH, La₂O₃, ZrO₂, Al₂O₃) used to prepare the Li₇La₃Zr₂O₁₂.0.35Al₂O₃. As used herein, the ratios are molar ratios unless specified to the contrary.

As used herein, the phrases “lithium-stuffed garnet” or “Li-stuffed” refer to oxides that are characterized by a crystal structure related to a garnet crystal structure. US Patent Application Publication No. 2015/0099190, which published Apr. 9, 2015 and was filed Oct. 7, 2014 as Ser. No. 14/509,029, is incorporated by reference herein in its entirety provides non-limiting examples of lithium-stuffed garnets. This application describes Li-stuffed garnet electrolytes used in solid-state lithium rechargeable batteries. These Li-stuffed garnets generally having a composition according to Li_{A}La_{B}M′cM″_{D}Zr_{E}O_{F}, Li_{A}La_{B}M′_{C}M″_{D}Ta_{E}O_{F}, or Li_{A}La_{B}M′_{C}M″_{D}Nb_{E}O_{F}, wherein 4<A<8.5, 1.5<B<4, 0≤C≤2, 0≤D≤2; 0≤E<2, 10<F<13, and M′ and M″ are each, independently in each instance selected from Ga, Al, Mo, W, Nb, Sb, Ca, Ba, Sr, Ce, Hf, Rb, or Ta, or LiₐLa_{b}Zr_{c}Al_{d}Me″ₑO_{f}, wherein 5<a<8.5; 2<b<4; 0<c≤2.5; 0≤d<2; 0≤e<2, and 10<f<13 and Me″ is a metal selected from Ga, Nb, Ta, V, W, Mo, or Sb and as otherwise described in U.S. Patent Application Publication No. US 2015/0099190. As used herein, lithium-stuffed garnets, and garnets, generally, include, but are not limited to, Li_{7.0}La₃(Zrₜ₁+Nbₜ₂+Taₜ₃)O₁₂+0.35Al₂O₃; wherein (t1+t2+t3=2) so that the La:(Zr/Nb/Ta) ratio is 3:2. Also, garnets used herein include, but are not limited to, LiₓLa₃Zr₂O_{F}+yAl₂O₃, wherein x ranges from 5.5 to 9; and y ranges from 0.05 to 1. In these examples, subscripts x and F and coefficient y are selected so that the garnet is charge neutral. In some examples x is 7 and y is 1.0. In some examples, x is 5 and y is 1.0. In some examples, x is 6 and y is 1.0. In some examples, x is 8 and y is 1.0. In some examples, x is 9 and y is 1.0. In some examples x is 7 and y is 0.35. In some examples, x is 5 and y is 0.35. In some examples, x is 6 and y is 0.35. In some examples, x is 8 and y is 0.35. In some examples, x is 9 and y is 0.35. In some examples x is 7 and y is 0.7. In some examples, x is 5 and y is 0.7. In some examples, x is 6 and y is 0.7. In some examples, x is 8 and y is 0.7. In some examples, x is 9 and y is 0.7. In some examples x is 7 and y is 0.75. In some examples, x is 5 and y is 0.75. In some examples, x is 6 and y is 0.75. In some examples, x is 8 and y is 0.75. In some examples, x is 9 and y is 0.75. In some examples x is 7 and y is 0.8. In some examples, x is 5 and y is 0.8. In some examples, x is 6 and y is 0.8. In some examples, x is 8 and y is 0.8. In some examples, x is 9 and y is 0.8. In some examples x is 7 and y is 0.5. In some examples, x is 5 and y is 0.5. In some examples, x is 6 and y is 0.5. In some examples, x is 8 and y is 0.5. In some examples, x is 9 and y is 0.5. In some examples x is 7 and y is 0.4. In some examples, x is 5 and y is 0.4. In some examples, x is 6 and y is 0.4. In some examples, x is 8 and y is 0.4. In some examples, x is 9 and y is 0.4. In some examples x is 7 and y is 0.3. In some examples, x is 5 and y is 0.3. In some examples, x is 6 and y is 0.3. In some examples, x is 8 and y is 0.3. In some examples, x is 9 and y is 0.3. In some examples x is 7 and y is 0.22. In some examples, x is 5 and y is 0.22. In some examples, x is 6 and y is 0.22. In some examples, x is 8 and y is 0.22. In some examples, x is 9 and y is 0.22. Also, garnets as used herein include, but are not limited to, Li₇₋ₓLa₃Zr₂O₂+yAl₂O₃. In one embodiment, the Li-stuffed garnet herein has a composition of Li₇Li₃Zr₂O₁₂. In another embodiment, the Li-stuffed garnet herein has a composition of Li₇Li₃Zr₂O₁₂.Al₂O₃. In yet another embodiment, the Li-stuffed garnet herein has a composition of Li₇Li₃Zr₂O₁₂.0.22Al₂O₃. In yet another embodiment, the Li-stuffed garnet herein has a composition of Li₇Li₃Zr₂O₁₂.0.35Al₂O₃. In certain other embodiments, the Li-stuffed garnet herein has a composition of Li₇Li₃Zr₂O₁₂.0.5Al₂O₃. In another embodiment, the Li-stuffed garnet herein has a composition of Li₇Li₃Zr₂O₁₂.0.75Al₂O₃. In another embodiment, the Li-stuffed garnet herein has a composition of Li₇₋ₓLi₃Zr₂O₁₂.Al₂O₃, wherein x is from 0 to 2.5. In yet another embodiment, the Li-stuffed garnet herein has a composition of Li₇₋ₓLi₃Zr₂O₁₂.0.22Al₂O₃, wherein x is from 0 to 2.5. In some examples, x is 0. In other examples, x is 0.1. In certain other examples, x is 0.2. In yet other examples, x is 0.3. In some other examples, x is 0.4. In yet some other examples, x is 0.5. In some examples, x is 0.6. In other examples, x is 0.7. In certain other examples, x is 0.8. In yet other examples, x is 0.9. In some other examples, x is 1.0. In yet some other examples, x is 1.1. In some examples, x is 1.2. In other examples, x is 1.3. In certain other examples, x is 1.4. In yet other examples, x is 1.5. In some other examples, x is 1.6. In yet some other examples, x is 1.7. In some examples, x is 1.8. In other examples, x is 1.9. In certain other examples, x is 2.1. In yet other examples, x is 2.2. In some other examples, x is 2.3. In yet some other examples, x is 2.4. In other examples, x is 2.5. In yet another embodiment, the Li-stuffed garnet herein has a composition of Li₇₋ₓLi₃Zr₂O₁₂.0.35Al₂O₃, wherein x is from 0 to 2.5. In certain other embodiments, the Li-stuffed garnet herein has a composition of Li₇₋ₓLi₃Zr₂O₁₂.0.5Al₂O₃, wherein x is from 0 to 2.5. In another embodiment, the Li-stuffed garnet herein has a composition of Li₇₋ₓLi₃Zr₂O₁₂.0.75Al₂O₃, wherein x is from 0 to 2.5. In some examples, x is 0. In other examples, x is 0.1. In certain other examples, x is 0.2. In yet other examples, x is 0.3. In some other examples, x is 0.4. In yet some other examples, x is 0.5. In some examples, x is 0.6. In other examples, x is 0.7. In certain other examples, x is 0.8. In yet other examples, x is 0.9. In some other examples, x is 1.0. In yet some other examples, x is 1.1. In some examples, x is 1.2. In other examples, x is 1.3. In certain other examples, x is 1.4. In yet other examples, x is 1.5. In some other examples, x is 1.6. In yet some other examples, x is 1.7. In some examples, x is 1.8. In other examples, x is 1.9. In certain other examples, x is 2.1. In yet other examples, x is 2.2. In some other examples, x is 2.3. In yet some other examples, x is 2.4. In other examples, x is 2.5.

As used herein, garnet does not include YAG-gamets (i.e., yttrium aluminum garnets, or, e.g., Y₃Al₅O₁₂). As used herein, garnet does not include silicate-based garnets such as pyrope, almandine, spessartine, grossular, hessonite, or cinnamon-stone, tsavorite, uvarovite and andradite and the solid solutions pyrope-almandine-spessarite and uvarovite-grossular-andradite. Garnets herein do not include nesosilicates having the general formula X₃Y₂(SiO₄)₃ wherein X is Ca, Mg, Fe, and/or Mn; and Y is Al, Fe, and/or Cr.

As used here, the phrase “sulfide electrolyte,” or “lithium sulfide” includes, but is not limited to, electrolytes referred to herein as LSS, LTS, LXPS, or LXPSO, where X is Si, Ge, Sn, As, Al, or Li—Sn—Si—P—S, or Li—As—Sn—S. In these acronyms (LSS, LTS, LXPS, or LXPSO), S refers to the element S, Si, or combinations thereof, and T refers to the element Sn. “Sulfide electrolyte” may also include LiₐP_{b}S_{c}X_{d}, LiₐB_{b}S_{c}X_{d}, LiₐSn_{b}S_{c}X_{d} or LiₐSi_{b}S_{c}X_{d} where X═F, Cl, Br, I, and 10%≤a≤50%, 10%≤b≤44%, 24%≤c≤70%, 0≤d≤18%. Up to 10 at % oxygen may be present in the sulfide electrolytes, either by design or as a contaminant species.

As used herein, “SLOPS” includes, unless otherwise specified, a 60:40 molar ratio of Li₂S:SiS₂ with 0.1-10 mol. % Li₃PO₄. In some examples, “SLOPS” includes Li₁₀Si₄S₁₃ (50:50 Li₂S:SiS₂) with 0.1-10 mol. % Li₃PO₄. In some examples, “SLOPS” includes Li₂₆Si₇S₂₇ (65:35 Li₂S:SiS₂) with 0.1-10 mol. % Li₃PO₄. In some examples, “SLOPS” includes Li₄SiS₄ (67:33 Li₂S:SiS₂) with 0.1-5 mol. % Li₃PO₄. In some examples, “SLOPS” includes Li₁₄Si₃S₁₃ (70:30 Li₂S:SiS₂) with 0.1-5 mol. % Li₃PO₄. In some examples, “SLOPS” is characterized by the formula (1-x)(60:40 Li₂S:SiS₂)*(x)(Li₃PO₄), wherein x is from 0.01 to 0.99. As used herein, “LBS-POX” refers to an electrolyte composition of Li₂S:B₂S₃:Li₃PO₄:LiX where X is a halogen (X═F, Cl, Br, I). The composition can include Li₃BS₃ or Li₅B₇S₁₃ doped with 0-30% lithium halide such as LiI and/or 0-10% Li₃PO₄.

As used here, “LSS” refers to lithium silicon sulfide which can be described as Li₂S—SiS₂, Li—SiS₂, Li—S—Si, and/or a catholyte consisting essentially of Li, S, and Si. LSS refers to an electrolyte material characterized by the formula LiₓSi_{y}S_{z} where 0.33≤x≤0.5, 0.1≤y≤0.2, 0.4≤z≤0.55, and it may include up to 10 atomic % oxygen. LSS also refers to an electrolyte material including Li, Si, and S. In some examples, LSS is a mixture of Li₂S and SiS₂. In some examples, the ratio of Li₂S:SiS₂ is 90:10, 85:15, 80:20, 75:25, 70:30, 2:1, 65:35, 60:40, 55:45, or 50:50 molar ratio. LSS may be doped with compounds such as LiₓPO_{y}, LiₓBO_{y}, Li₄SiO₄, Li₃MO₄, Li₃MO₃, PSₓ, and/or lithium halides such as, but not limited to, LiI, LiCl, LiF, or LiBr, wherein 0<x≤5 and 0<y≤5.

As used here, “LTS” refers to a lithium tin sulfide compound which can be described as Li₂S:SnS₂:As₂S₅, Li₂S—SnS₂, Li₂S—SnS, Li—S—Sn, and/or a catholyte consisting essentially of Li, S, and Sn. The composition may be LiₓSn_{y}S_{z} where 0.25≤x≤0.65, 0.05≤y≤0.2, and 0.25≤z≤0.65. In some examples, LTS is a mixture of Li₂S and SnS₂ in the ratio of 80:20, 75:25, 70:30, 2:1, or 1:1 molar ratio. LTS may include up to 10 atomic % oxygen. LTS may be doped with Bi, Sb, As, P, B, Al, Ge, Ga, and/or In and/or lithium halides such as, but not limited to, LiI, LiCl, LiF, or LiBr. As used herein, “LATS” refers to LTS, as used above, and further including Arsenic (As).

As used here, “LXPS” refers to a material characterized by the formula LiₐMP_{b}S_{c}, where M is Si, Ge, Sn, and/or Al, and where 2≤a≤8, 0.5≤b≤2.5, 4≤c≤12. “LSPS” refers to an electrolyte material characterized by the formula LₐSiP_{b}S_{c}, where 2≤a≤8, 0.5≤b≤2.5, 4≤c≤12. LSPS refers to an electrolyte material characterized by the formula LₐSiP_{b}S_{c}, wherein, where 2≤a≤8, 0.5≤b≤4≤c≤12, d<3. In these examples, the subscripts are selected so that the compound is neutrally charged. Exemplary LXPS materials are found, for example, in International Patent Application Publication No. PCT/US2014/038283, filed May 16, 2014, and titled SOLID STATE CATHOLYTE OR ELECTROLYTE FOR BATTERY USING LI_{A}MP_{B}S_{C} (M=Si, Ge, AND/OR Sn), which is incorporated by reference herein in its entirety. When M is Sn and Si—both are present—the LXPS material is referred to as LSTPS. As used herein, “LSTPSO,” refers to LSTPS that is doped with, or has, O present. In some examples, “LSTPSO,” is a LSTPS material with an oxygen content between 0.01 and 10 atomic %. “LSPS,” refers to an electrolyte material having Li, Si, P, and S chemical constituents. As used herein “LSTPS,” refers to an electrolyte material having Li, Si, P, Sn, and S chemical constituents. As used herein, “LSPSO,” refers to LSPS that is doped with, or has, O present. In some examples, “LSPSO,” is a LSPS material with an oxygen content between 0.01 and 10 atomic %. As used herein, “LATP,” refers to an electrolyte material having Li, As, Sn, and P chemical constituents. As used herein “LAGP,” refers to an electrolyte material having Li, As, Ge, and P chemical constituents. As used herein, “LXPSO” refers to a catholyte material characterized by the formula LiₐMP_{b}S_{c}O_{d}, where M is Si, Ge, Sn, and/or Al, and where 2≤a≤8, 0.5≤b≤2.5, 4≤c≤12, d<3. LXPSO refers to LXPS, as defined above, and having oxygen doping at from 0.1 to about 10 atomic %. LPSO refers to LPS, as defined above, and having oxygen doping at from 0.1 to about 10 atomic %.

As used here, “LPS,” refers to an electrolyte having Li, P, and S chemical constituents. As used herein, “LPSO,” refers to LPS that is doped with or has O present. In some examples, “LPSO,” is a LPS material with an oxygen content between 0.01 and 10 atomic %. LPS refers to an electrolyte material that can be characterized by the formula LiₓP_{y}S_{z} where 0.33≤x≤0.67, 0.07≤y≤0.2 and 0.4≤z≤0.55. LPS also refers to an electrolyte characterized by a product formed from a mixture of Li₂S:P₂S₅ wherein the molar ratio is 10:1, 9:1, 8:1, 7:1, 6:1 5:1, 4:1, 3:1, 7:3, 2:1, or 1:1. LPS also refers to an electrolyte characterized by a product formed from a mixture of Li₂S:P₂S₅ wherein the reactant or precursor amount of Li₂S is 95 atomic % and P₂S₅ is 5 atomic %. LPS also refers to an electrolyte characterized by a product formed from a mixture of Li₂S:P₂S₅ wherein the reactant or precursor amount of Li₂S is 90 atomic % and P₂S₅ is 10 atomic %. LPS also refers to an electrolyte characterized by a product formed from a mixture of Li₂S:P₂S₅ wherein the reactant or precursor amount of Li₂S is 85 atomic % and P₂S₅ is 15 atomic %. LPS also refers to an electrolyte characterized by a product formed from a mixture of Li₂S:P₂S₅ wherein the reactant or precursor amount of Li₂S is 80 atomic % and P₂S₅ is 20 atomic %. LPS also refers to an electrolyte characterized by a product formed from a mixture of Li₂S:P₂S₅ wherein the reactant or precursor amount of Li₂S is 75 atomic % and P₂S₅ is 25 atomic %. LPS also refers to an electrolyte characterized by a product formed from a mixture of Li₂S:P₂S₅ wherein the reactant or precursor amount of Li₂S is 70 atomic % and P₂S₅ is 30 atomic %. LPS also refers to an electrolyte characterized by a product formed from a mixture of Li₂S:P₂S₅ wherein the reactant or precursor amount of Li₂S is 65 atomic % and P₂S₅ is 35 atomic %. LPS also refers to an electrolyte characterized by a product formed from a mixture of Li₂S:P₂S₅ wherein the reactant or precursor amount of Li₂S is 60 atomic % and P₂S₅ is 40 atomic %. LPS may also be doped with a lithium halide such as LiF, LiCl, LiBr, or LiI at a 0-40% molar content.

As used here, “LBS” refers to an electrolyte material characterized by the formula LiₐB_{b}S_{c} and may include oxygen and/or a lithium halide (LiF, LiCl, LiBr, LiI) at 0-40 mol %.

As used here, “LPSO” refers to an electrolyte material characterized by the formula LiₓP_{y}S_{z}O_{w} where 0.33≤x≤0.67, 0.07≤y≤0.2, 0.4≤z≤0.55, 0≤w≤0.15. Also, LPSO refers to LPS, as defined above, that includes an oxygen content of from 0.01 to 10 atomic %. In some examples, the oxygen content is 1 atomic %. In other examples, the oxygen content is 2 atomic %. In some other examples, the oxygen content is 3 atomic %. In some examples, the oxygen content is 4 atomic %. In other examples, the oxygen content is 5 atomic %. In some other examples, the oxygen content is 6 atomic %. In some examples, the oxygen content is 7 atomic %. In other examples, the oxygen content is 8 atomic %. In some other examples, the oxygen content is 9 atomic %. In some examples, the oxygen content is 10 atomic %.

As used herein, the term “LBHI” refers to a lithium conducting electrolyte including Li, B, H, and I. LBHI includes a compound having the formula aLiBH₄+bLiX where X═Cl, Br, and/or I and where a:b=7:1, 6:1, 5:1, 4:1, 3:1, 2:1, or within the range a/b=2-4. LBHI may further include nitrogen in the form of compound having the formula aLiBH₄+bLiX+cLiNH₂ where (a+c)/b=2-4 and c/a=0-10.

As used herein, the term “LPSI” refers to a lithium conducting electrolyte including Li, P, S, and I. LPSI includes a compound having the formula aLi₂S+bP₂Sy+cLiX where X═Cl, Br, and/or I and where y=3-5 and where a/b=2.5-4.5 and where (a+b)/c=0.5-15. LPSI may also contain up to 10% oxygen.

As used here, the phrase “composite electrolyte,” refers to an electrolyte, as referenced above, having at least two components, e.g., an inorganic solid-state electrolyte and a polymer bonded to the electrolyte, adhered to the electrolyte, or uniformly mixed with the electrolyte. In certain examples, the at least two components include a polymer, or organic binder, and an inorganic solid-state electrolyte. A composite electrolyte may include an inorganic solid-state electrolyte and a polymer, bonded thereto, adhered thereto, adsorbed there onto, or mixed therewith. A composite electrolyte may include an inorganic solid-state electrolyte and a polymer, bonded thereto, adhered thereto, adsorbed there onto, or mixed therewith. A composite electrolyte may include an inorganic solid-state electrolyte and the chemical precursors to a polymer which bonds to, adheres to, adsorbs onto, or mix with and/or entangles with, once polymerized, the inorganic solid-state electrolyte. A composite electrolyte may include an inorganic solid-state electrolyte and monomers which can be polymerized to form a polymer which bonds to, adheres to, adsorbs onto, or mix with and/or entangles with, once polymerized, the inorganic solid-state electrolyte. For example, a composite electrolyte may include a solid-state electrolyte, e.g., a sulfide-including electrolyte, and epoxide monomers or epoxide-including polymers. In such an example, the epoxide monomers can be polymerized by polymerization techniques known in the art, such as but not limited light-initiated or chemical-initiated, polymerization. Example composite electrolytes include, but are not limited to, those composite electrolytes set forth in U.S. patent application Ser. No. 15/192,960, filed Jun. 24, 2016, the entire contents of which are herein incorporated by reference in their entirety for all purposes.

As used herein, the term “LIRAP” refers to a lithium rich antiperovskite and is used synonymously with “LOC” or “Li₃OCl”. The composition of LIRAP is aLi₂O+bLiX+cLiOH+dAl₂O₃ where X═Cl, Br, and/or I, a/b=0.7-9, c/a=0.01-1, d/a=0.001-0.1.

As used herein the phrase “active surface area of the lithium metal” refers to the surface area of the lithium metal anode which is in direct contact with the solid-state electrolyte.

As used herein, the term, “Ra,” is a measure of surface roughness wherein Ra is an arithmetic average of absolute values of sampled surface roughness amplitudes. Surface roughness measurements can be accomplished using, for example, a Keyence VK-X100 instrument that measures surface roughness using a laser. As used herein, the term, “Rt,” is a measure of surface roughness wherein Rt is the maximum peak height of sampled surface roughness amplitudes. Disclosed herein are methods of modifying the surface roughness of an oxide electrolyte, which methods include polishing, ablating, exposing to laser, exposing to plasma, exposing to ozone, exposing to a reducing atmosphere at elevate temperatures such as but not limited to 400° C., 500° C., 600° C., 700° C., 800° C., 900° C., 1000° C., 1100° C., 1200° C., 1300° C., or higher, or annealing the surface in order to achieve the desired surface roughness.

As used herein, surface roughness refers to a measurement of either an arithmetic average of absolute values of sampled surface roughness amplitudes or a measurement of the maximum peak height of sampled surface roughness amplitudes. Herein, surface roughness amplitude refers to the deviations, above or below, in the direction normal to an ideal surface. As used herein, the term, “Ra,” is a measure of surface roughness wherein Ra is an arithmetic average of absolute values of sampled surface roughness amplitudes. Surface roughness measurements can be accomplished using, for example, a Keyence VK-X100 instrument that measures surface roughness using a laser. As used herein, the term, “Rt,” is a measure of surface roughness wherein Rt is the maximum peak height of sampled surface roughness amplitudes.

As used herein, the term “defect” refers to an imperfection or a deviation from a pristine structure. A defect includes a portion of a material that interacts with, absorbs, scatters, reflects, or refracts light, differently than does the rest of the material. Defects may include, but are not limited to, a pore, a grain boundary, a dislocation, a crack, a separation, a chemical inhomogeneity, a pitting, an inclusion, an included pore, a divot, an atomic vacancy, a phase segregation of two or more materials in a solid material, a cavity, a twinned grain, a non-planarity in an otherwise planar surface, the presence of a second phase in a lithium-stuffed garnet, wherein second phase is a phase other than cubic lithium-stuffed garnet. A perfect crystal is an example of a material that lacks defects. A nearly 100% dense oxide electrolyte that has a planar surface, with substantially no pitting, inclusions, cracks, pores, or divots on the surface, is an example of an electrolyte that is substantially lacking in defects. Defects can include a second phase inclusion, e.g., a LiAlO₂ phase inside a Li₇La₃Zr₂O₁₂.aAl₂O₃ electrolyte. Defects can include a grain boundary. Defects can include a vacant space between adjacent grains, wherein the separation of the vacant space is greater than 10 nm. Defects can include a site of crystal grain twinning. Defects can include a crystal dislocation in a crystalline material.

As used herein, the phrase “defect density,” refers to the volumetric density of defects. For example, if the defect in a primary phase is a second phase inclusion, and the second phase inclusion occupies 10% of the volume of the primary phase in which the secondary phase is, then the defect density is 10% by volume.

As used herein, the phrase “density as determined by geometric measurements,” refers to measurements of density obtained by physical mass and volume measurements. Density is determined by the ratio of measured mass to the measured volume. Customary techniques including the Archimedes method have been employed for such determinations.

As used herein, the phrase “density as determined by scanning electron microscopy (SEM),” refers to the analysis of scanning electron microscopy (SEM) images. This analysis includes measuring the relative amounts of the electrolyte separator which are porous or vacant with respect to the electrolyte separator which is fully dense. The SEM images useful for this analysis include those obtained by SEM cross-sectional analysis using focused ion beam (FIB) milling.

As used herein, the phrase “lithium interfacial resistance,” refers to the interfacial resistance of a material towards the incorporation of Li⁺ ions. A lithium interfacial ASR (ASR_{interface}) is calculated from the interfacial resistance (R_{interface}) via ASR_{interface}=R_{interface}*A/2 where A is the area of the electrodes in contact with the separator and the factor of 2 accounts for 2 interfaces, assuming they are symmetric, as demonstrated in Example 4, herein. R_{interface} is measured by electrical impedance spectroscopy.

As used herein, voltage is set forth with respect to lithium (i.e., V vs. Li) metal unless stated otherwise.

As used herein the phrase “bonding layer,” refers to an ionically conductive layer between two other layers, e.g., between the cathode and the solid separator. Exemplary bonding layers include the gel electrolytes, and related separator bonding agents, set forth in US Patent Application Publication No. 2017-0331092 A1, filed Nov. 16, 2017 as U.S. patent application Ser. No. 15/595,755, the entire contents of which are herein incorporated by reference in its entirety for all purposes.

As used herein “median diameter (d₅₀)” refers to the median size, in a distribution of sizes, measured by microscopy techniques or other particle size analysis techniques, including, but not limited to, scanning electron microscopy or dynamic light scattering. D₅₀ includes the characteristic dimension at which 50% of the particles are smaller than the recited size. Unless otherwise specified, the d₅₀ is measured on a volume, not number, basis.

As used herein “diameter (d₉₀)” refers to the size, in a distribution of sizes, measured by microscopy techniques or other particle size analysis techniques, including, but not limited to, scanning electron microscopy or dynamic light scattering. D₉₀ includes the characteristic dimension at which 90% of the particles are smaller than the recited size. Unless otherwise specified, the d₉₀ is measured on a volume, not number, basis.

As used herein “diameter (d₁₀)” refers to the size, in a distribution of sizes, measured by microscopy techniques or other particle size analysis techniques, including, but not limited to, scanning electron microscopy or dynamic light scattering. D₁₀ includes the characteristic dimension at which 10% of the particles are smaller than the recited size. Unless otherwise specified, the d₁₀ is measured on a volume, not number, basis.

As used herein, the term “lithium titanium aluminum phosphate,” refers to a material characterized by the formula Li₁₊ₓAlₓ(Ti_{y})₂₋ₓ(PO₄)₃, wherein x is a rational number from 0 to 2 and y is a rational number from 0 to 1.

As used herein, the term “lithium germanium aluminum phosphate, refers to a material characterized by the formula Li₁₊ₓGeₓ(PO₄)₃, wherein x is a rational number from 0 to 2.

As used herein, the term “lithium germanium titanium aluminum phosphate,” Li₁₊ₓAlₓ(Ge_{1-y}Ti_{y})₂₋ₓ(PO₄)₃, wherein x is a rational number from 0 to 2 and y is a rational number from 0 to 1.

As used herein, the term “OHARA glass,” refers to an oxide electrolyte and includes those relevant oxides set forth in U.S. Pat. Nos. 5,702,995; 6,030,909; 6,315,881; and 6,485,622, incorporated herein by reference.

As used herein, the term “LIPON,” is an acronym for a glassy Li⁺ ion useful as a potential electrolyte for solid-state lithium micro-batteries. Exemplary LIPON materials are found, for example, in U.S. Pat. Nos. 5,597,660; 5,567,210; 5,338,625; and 5,512,147.

As used herein, the term “NASICON,” is an acronym for sodium (Na) Super Ionic Conductor characterized by the chemical formula Na₁₊ₓZr₂SiₓP₃₋ₓO₁₂, 0<x<3.

As used herein, the term “LISICON,” is an acronym for Lithium Super Ionic Conductor characterized by the chemical formula Li₂₊₂ₓZn₁₋ₓGeO₄, wherein 0<x<1.

As used herein, the phrase “compressible fluid is inert to lithium metal” means that that fluids does not react detrimentally with lithium metal. A detrimental reaction with lithium metal includes a reaction with a film of lithium metal that is less than 30 μm in thickness and which results in the lithium metal's electronic conductivity changing beyond 20% of its initial value

Herein, isotropic, hydrostatic, and/or uniaxial pressures are determined as follows by one of two methods of determination. In one method of determination, a load cell (or pressure transducer) is inserted into a sample coin cell or pouch cell during assembly and the pressure inside the coin cell or pouch cell is obtained from it with the cell in assembled state. In another method of determination, pressure paper is inserted into a sample coin cell or pouch cell during assembly and the pressure inside the coin cell or pouch cell is obtained from it upon disassembly in a disassembled state. Isotropic pressure may be measured with a gas pressure gauge. Isotropic, hydrostatic, and/or uniaxial pressures are determined using a pressure transducer unless specified otherwise.

Herein, unless stated otherwise, molecular weights of polymers are determined in accordance with the Handbook of Polymer Synthesis, Characterization, and Processing, First Edition. Edited by Enrique Sald'ivar-Guerra and Eduardo Vivaldo-Lima. O 2013 John Wiley & Sons, Inc. Published 2013 by John Wiley & Sons, Inc

### C. Electrochemical Cells

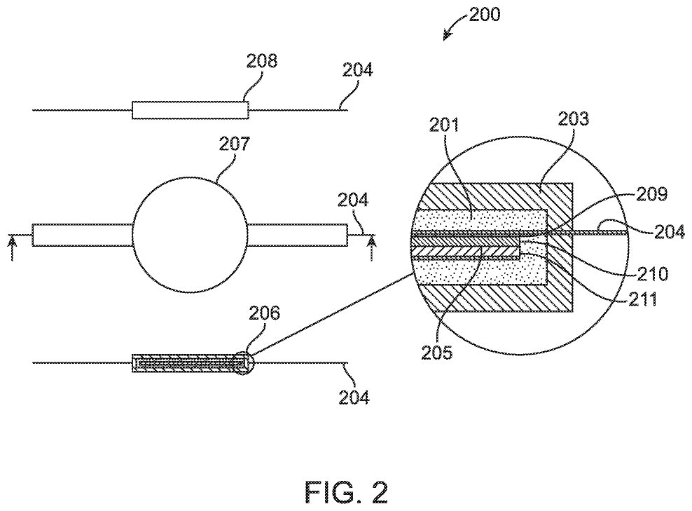

FIG. 2 shows an embodiment of an electrochemical cell, 200, disclosed herein. The electrochemical cell, 200, includes an electrode stack, 205, contained within an electrochemical cell housing, 208, which contains the other components in FIG. 2, described below. A top-down view of the disc-shaped electrochemical cell housing, 208, is shown as 207. A cross-sectional view of electrochemical cell housing, 208, is shown as 206. 206 is magnified in the right inset in FIG. 2 which is magnified to illustrate the hydrostatic material, 201, outer-shell material, 203, conductive leads, 204, and electrode stack, 205.

In 200, an electrode stack, 205, includes a positive electrode, 211, solid electrolyte, 210, and negative electrode, 209. In some embodiments, a bonding layer is used to bond the positive electrolyte to the solid electrolyte. In some embodiments, the negative electrode, 209, is a lithium metal negative electrode. The electrode stack, 205, includes conductive leads, 204, which conduct electrons to and from the positive and negative electrode as the electrochemical cell, 200, discharges and charges. The conductive leads, 204, individually contact the positive and negative electrodes. The conductive leads, 204, extend through the hydrostatic material, 201, and outer-shell material, 203. In some embodiments, the conductive leads, 204, extend through the hydrostatic material, 201, and outer-shell material, 203, and form a hermetic seal through the hydrostatic material, 201, and outer-shell material, 203, which is sufficient to protect the electrode stack, 205, and not expose it to ambient conditions at the points through which the conductive leads, 204, enter and exit the hydrostatic material, 201, and outer-shell material, 203. As shown in FIG. 2, the hydrostatic material, 201, directly contacts the electrode stack, 205. As shown in FIG. 2, the outer-shell material, 203, surrounds the hydrostatic material, 201. The hydrostatic material, 201, is contained within the outer-shell material, 203. In some embodiments, the outer-shell material, 203, is not conductive (i.e., is an insulator). In some embodiments, the hydrostatic material, 201, is not conductive (i.e., is an insulator). The combination of the hydrostatic material, 201, and outer-shell material, 203, provide pressure around the electrode stack, 205. This pressure can be isotropic, uniaxial, or hydrostatic as further described throughout the instant disclosure. In some embodiments, the combination of the hydrostatic material, 201, and outer-shell material, 203, also seal the electrode stack, 205, and protect it from exposure to ambient conditions. In some embodiments, the outer-shell material, 203, has a greater bulk modulus than the hydrostatic material, 201. In some further embodiments, the outer-shell material, 203, is under tensile stress to exert and maintain uniform pressure on the electrode stack, 205, thru the hydrostatic material, 201, as the stack expands and contracts. This pressure can be isotropic, uniaxial, or hydrostatic as further described throughout the instant disclosure. While the electrode stack, 205, expands and contracts, the conductive leads, 204, conduct electrons.

The CES 2009 EDUPACK, Cambridge University, copyright Granta Design January 2009 provides representative Young's Modulus as a function of density for materials which may be suitable for use with the instant disclosure. The entire contents of The CES 2009 EDUPACK, Cambridge University, copyright Granta Design January 2009 is herein incorporated by reference in its entirety for all purposes. In some examples, the hydrostatic material used is an elastomer. In some examples, the hydrostatic material used is polyether ethyl ketone (PEEK). In some examples, the hydrostatic material used is polyethylene terephthalate (PET). In some examples, the hydrostatic material used is polypropylene (PP). In some examples, the hydrostatic material used is polyisobutylene. In some examples, the hydrostatic material used is polybutylene. In some examples, the hydrostatic material is Argon gas. In some examples, the hydrostatic material is Helium gas. In some examples, the hydrostatic material is a mixture of Argon and Helium gas. In some examples, the hydrostatic material is a mixture of hydrocarbon gases.

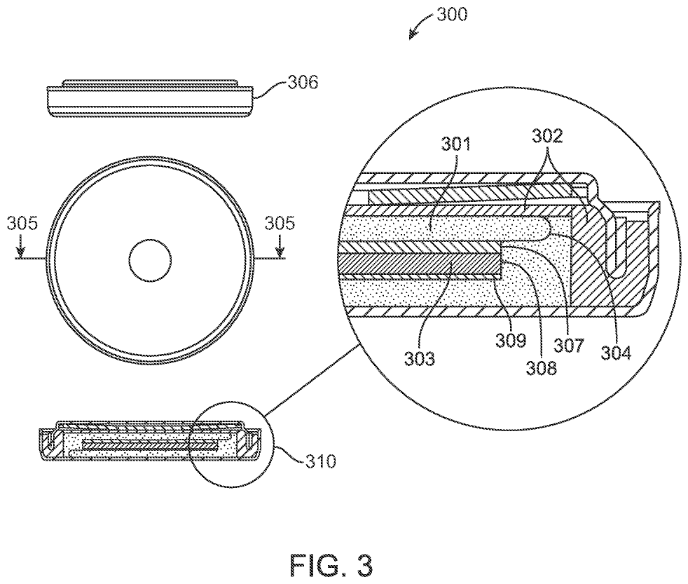

FIG. 3 shows an embodiment of a coin cell, 300, disclosed herein. An electrode stack, 303, is contained within a coin cell housing, 306, which contains the other components in FIG. 3, described below. A top-down view of the coin cell, 306, is shown as 305. A cross-sectional view of the coin cell, 306, is shown as 310. 310 is magnified in the right inset in FIG. 3 which is magnified to illustrate the hydrostatic material, 301, outer-shell material, 302, conductive leads, 304, and electrode stack, 303. Conductive lead, 304, wraps around hydrostatic material, 301.

In 300, an electrode stack, 303, includes a positive electrode, 307, solid electrolyte, 308, and negative electrode, 309. In some embodiments, a bonding layer is used to bond the positive electrolyte to the solid electrolyte. In some embodiments, the negative electrode, 309, is a lithium metal negative electrode. The electrode stack, 303, is in contact with conductive leads, 304, which conduct electrons to and from the positive and negative electrode as the electrochemical cell, 300, discharges and charges. The conductive leads, 304, individually contact the positive and negative electrodes. The conductive leads, 304, extend through the hydrostatic material, 301, and outer-shell material, 302. In some embodiments, the conductive leads, 304, extend through the hydrostatic material, 301, and outer-shell material, 302, and form a hermetic seal with the hydrostatic material, 301, and outer-shell material, 302, which is sufficient to protect the electrode stack, 303, and not expose it to ambient conditions at the points through which the conductive leads, 304, enter and exit the hydrostatic material, 301, and outer-shell material, 302. As shown in FIG. 3, the hydrostatic material, 301, directly contacts the electrode stack, 303. As shown in FIG. 3, the outer-shell material, 302, surrounds the hydrostatic material, 301. The hydrostatic material, 301, is contained within the outer-shell material, 302. In some embodiments, the outer-shell material, 302, is not conductive (i.e., is an insulator). In some embodiments, the hydrostatic material, 301, is not conductive (i.e., is an insulator). The combination of the hydrostatic material, 301, and outer-shell material, 302, provide pressure around the electrode stack, 303. This pressure can be isotropic, uniaxial, or hydrostatic as further described throughout the instant disclosure. In some embodiments, the combination of the hydrostatic material, 301, and outer-shell material, 302, also seal the electrode stack, 303, and protect it from exposure to ambient conditions. In some embodiments, the outer-shell material, 302, has a greater bulk modulus than the hydrostatic material, 301. In some further embodiments, the outer-shell material, 302, is under tensile stress to exert and maintain uniform pressure on the electrode stack, 303, thru the hydrostatic material, 301, as the stack expands and contracts. This pressure can be isotropic, uniaxial, or hydrostatic as further described throughout the instant disclosure. While the electrode stack, 303, expands and contracts, the conductive leads, 304, conduct electrons.

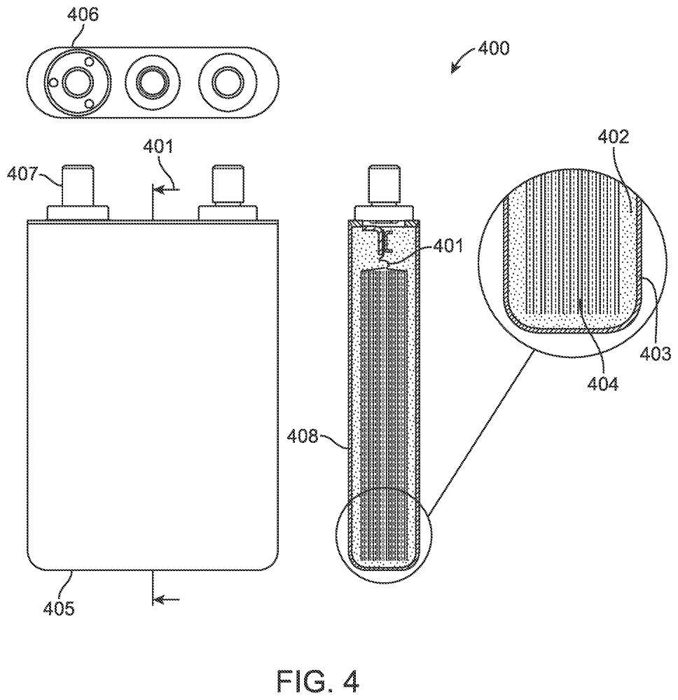

FIG. 4 shows an embodiment of a can cell, 400, disclosed herein. An electrode stack, 404, is contained within a can cell housing, 405, which contains the other components in FIG. 4, described below. A top-down view of the can cell, 405, is shown as 406. The can cell, 405, includes electrically insulated feed through(s), 407. In some examples, 407 is a screw that holds the assembly in FIG. 4 together. A cross-sectional view of the can cell, 405, is shown as 408. 408 is magnified in the right inset in FIG. 4 which is magnified to illustrate the hydrostatic material, 402, outer-shell material, 403, conductive leads, 401, and electrode stack, 404.

In 400, an electrode stack, 404, includes a series of stacks of positive electrodes, solid electrolytes, and negative electrodes. In some embodiments, a bonding layer is used to bond each positive electrolyte to its respective solid electrolyte. In some embodiments, the negative electrode is a lithium metal negative electrode. The electrode stack, 404, is in contact with conductive leads, 401, which conduct electrons to and from the positive and negative electrode as 400 discharges and charges. The conductive leads, 401, individually contact the positive and negative electrodes. The conductive leads, 401, extend through the hydrostatic material, 402, and outer-shell material, 403. In some embodiments, the conductive leads, 401, extend through the hydrostatic material, 402, and outer-shell material, 403, and form a hermetic seal with the hydrostatic material, 402, and outer-shell material, 403, which is sufficient to protect the electrode stack, 404, and not expose it to ambient conditions at the points through which the conductive leads, 401, enter and exit the hydrostatic material, 402, and outer-shell material, 403. As shown in FIG. 4, the hydrostatic material, 402, directly contacts the electrode stack, 404. As shown in FIG. 4, the outer-shell material, 403, surrounds the hydrostatic material, 402. The hydrostatic material, 402, is contained within in the outer-shell material, 403. In some embodiments, the outer-shell material, 403, is not conductive (i.e., is an insulator). In some embodiments, the hydrostatic material, 402, is not conductive (i.e., is an insulator). The combination of the hydrostatic material, 402, and outer-shell material, 403, provide pressure around the electrode stacks, 404. This pressure can be isotropic, uniaxial, or hydrostatic as further described throughout the instant disclosure. In some embodiments, the combination of the hydrostatic material, 402, and outer-shell material, 403, also seal the electrode stacks, 404, and protect them from exposure to ambient conditions. In some embodiments, the outer-shell material, 403, has a greater bulk modulus than the hydrostatic material, 402. In some further embodiments, the outer-shell material, 403, is under tensile stress to exert and maintain uniform pressure on the electrode stacks, 404, thru the hydrostatic material, 402, as the stack expands and contracts. This pressure can be isotropic, uniaxial, or hydrostatic as further described throughout the instant disclosure. While the electrode stacks, 404, expand and contract, the conductive leads, 401, conduct electrons. Conductive leads, 401, are connected to electrically insulated feed through(s), 407, by spot welds or by an ultrasonically-made weld.

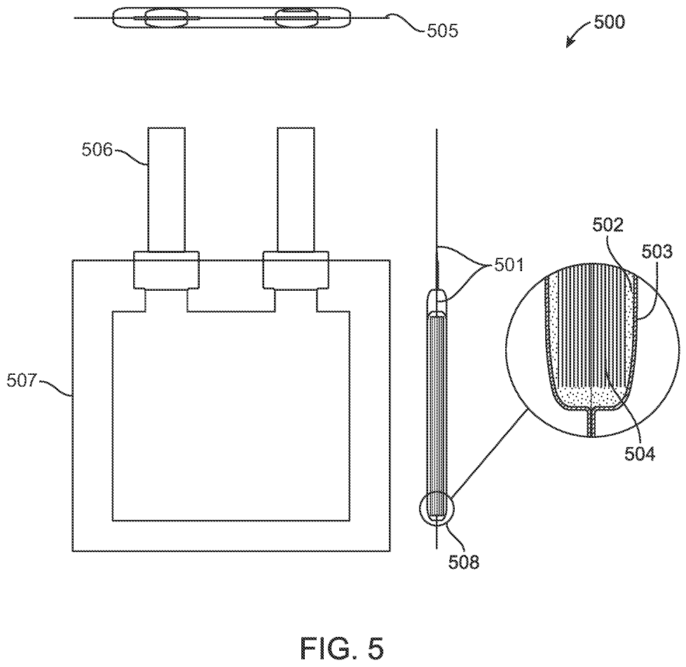

FIG. 5 shows an embodiment of a pouch cell, 500, disclosed herein. An electrode stack, 504, is contained within a pouch, 507, which contains the other components in FIG. 5, described below. A top-down view of the pouch, 507, is shown as 505. The pouch, 507, includes electrically insulated feed through(s), 506. A cross-sectional view of the pouch, 507, is shown as 508. 508 is magnified in the right inset in FIG. 5 which is magnified to illustrate the hydrostatic material, 502, outer-shell material, 503, conductive leads, 501, and electrode stack, 404.

In 500, an electrode stack, 504, includes a series of stacks of positive electrodes, solid electrolytes, and negative electrodes. In some embodiments, a bonding layer is used to bond each positive electrolyte to its respective solid electrolyte. In some embodiments, the negative electrode is a lithium metal negative electrode. The electrode stack, 504, is in contact with conductive leads, 501, which conduct electrons to and from the positive and negative electrode as 500 discharges and charges. The conductive leads, 501, individually contact the positive and negative electrodes. The conductive leads, 501, extend through the hydrostatic material, 502, and outer-shell material, 503. In some embodiments, the conductive leads, 501, extend through the hydrostatic material, 502, and outer-shell material, 503, and form a hermetic seal with the hydrostatic material, 502, and outer-shell material, 503, which is sufficient to protect the electrode stack, 504, and not expose it to ambient conditions at the points through which the conductive leads, 501, enter and exit the hydrostatic material, 502, and outer-shell material, 503. As shown in FIG. 5, the hydrostatic material, 502, directly contacts the electrode stack, 504. As shown in FIG. 5, the outer-shell material, 503, surrounds the hydrostatic material, 502. The hydrostatic material, 502, is contained within the outer-shell material, 503. In some embodiments, the outer-shell material, 503, is not conductive (i.e., is an insulator). In some embodiments, the hydrostatic material, 502, is not conductive (i.e., is an insulator). The combination of the hydrostatic material, 502, and outer-shell material, 503, provide pressure around the electrode stacks, 504. This pressure can be isotropic, uniaxial, or hydrostatic as further described throughout the instant disclosure. In some embodiments, the combination of the hydrostatic material, 502, and outer-shell material, 503, also seal the electrode stacks, 504, and protect them from exposure to ambient conditions. In some embodiments, the outer-shell material, 503, has a greater bulk modulus than the hydrostatic material, 502. In some further embodiments, the outer-shell material, 503, is under tensile stress to exert and maintain uniform pressure on the electrode stacks, 504, thru the hydrostatic material, 502, as the stack expands and contracts. This pressure can be isotropic, uniaxial, or hydrostatic as further described throughout the instant disclosure. While the electrode stacks, 504, expand and contract, the conductive leads, 501, conduct electrons. Conductive leads, 501, are connected to electrically insulated feed through(s), 506 by resistance spot welds or by an ultrasonically-made weld. Other types of similar spot welds, e.g., such as a projection spot welds or ultrasonic welds, may be used in place of a resistance spot weld, in some examples.

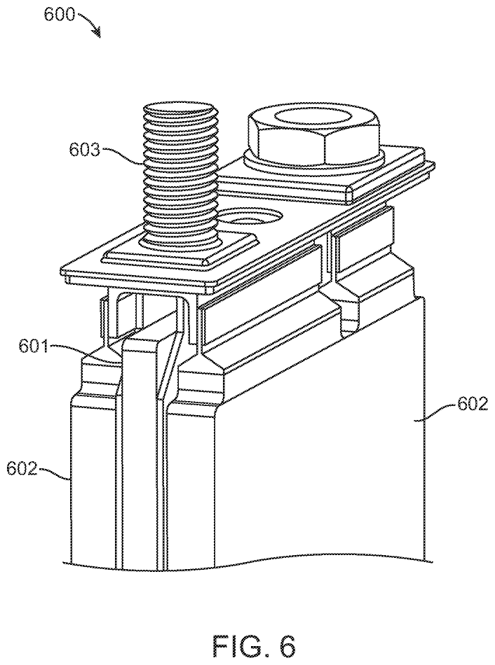

FIG. 6 shows an embodiment wherein two electrode stacks, 602, are stacked and held in place by an assembly with electrical feedthroughs, 603. In between the electrode stacks, 602, is a housing for an incompressible fluids, 601. The combination of the pressure element, 601, and the assembly, 603, provides pressure to the electrode stacks, 602.

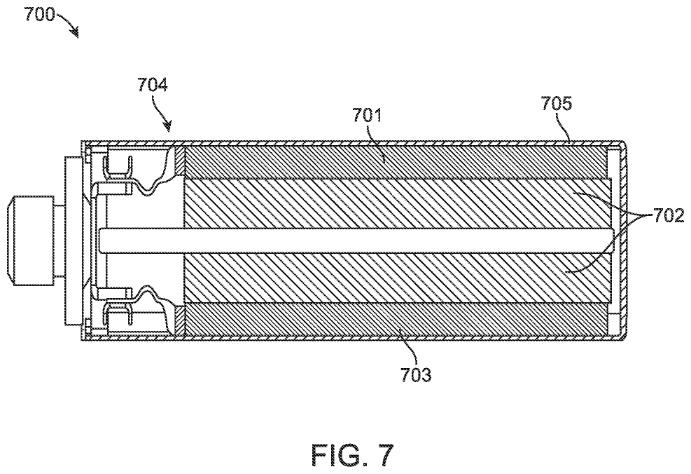

FIG. 7 shows an embodiment wherein two electrode stacks, 702, are stacked and held in place by cell housing, 704. In between the electrode stacks, 702, is a pressure element, 705. The combination of the pressure element, 705, and the assembly, 704, provides pressure to the can cells, 702. In some examples, the pressure element, 705, a rubber material. In some examples, the pressure element, 705, is a rubber band. In some examples, the pressure element, 705, a metal spring. In some examples, the pressure element, 705, a gas. In some examples, the pressure element, 705, is a gas contained within a bladder. In some examples, the pressure element, 705, is a fluid contained within a bladder.

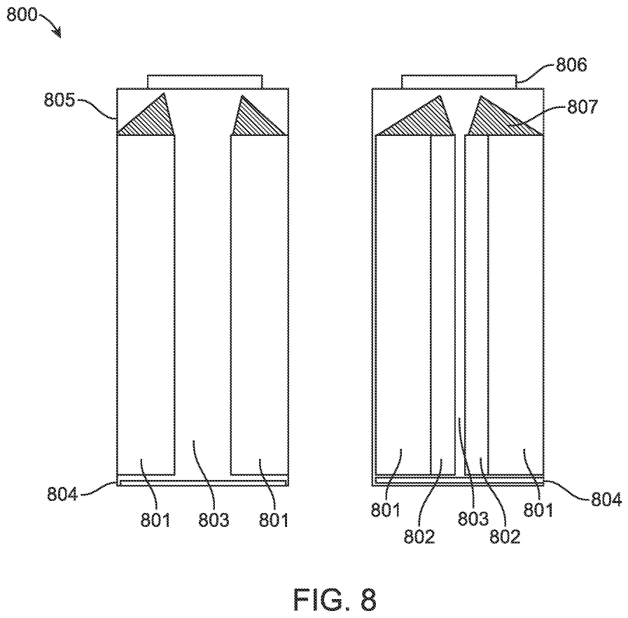

FIG. 8 shows an embodiment of an electrochemical cell, 805, that includes an embodiment of a spring comprised of a liquid and a gas. On the left side, the electrochemical cell, 805, is in a discharged state and is in a contracted state. The plurality of electrode stacks, 801, includes repeating units of a positive electrode, a solid electrolyte separator, and a lithium metal negative electrode. The majority of the lithium metal, in the discharged state shown on the left side, is inside the positive electrode. As the stack expands during a charge, the stack, 801, increases in width by the amount, 802. To accommodate the pressure change that results from this expansion (or the corresponding contraction on discharge), and to maintain a uniform pressure on the stack, 801, a compressible fluid spring comprising a gas and/or liquid is included. In some examples, the compressible fluid spring includes Argon gas. In some examples, the compressible fluid spring includes Helium gas. In some examples, the compressible fluid spring includes polypropylene. In some examples, the compressible fluid spring includes PVdF. In some examples, the compressible fluid spring includes Argon and Helium gas. In some of these examples, the Argon and/or Helium gas is contained within a polypropylene bladder. In some of these examples, the Argon and/or Helium gas is contained within a polyvinylidene fluoride bladder. The compressible fluid includes a liquid, 804, which evaporates to form a gas phase 803. This gas phase 803, exerts a pressure on the stack 801. Also included are conductive leads, 807, which connect to external terminal tabs, 806. In this embodiment, the gas phase, 803, applies pressure to the stack, 801, or to the expanded stack, 801 and 802. In some examples, the liquid, 804, and gas, 803, are a non-reactive mixture in liquid/vapor equilibrium. In some examples, a noble gas is also present in this mixture. In some examples, the liquid, 804, is a short chain hydrocarbon. In some examples, the ratio of the noble gas (e.g., He, Ne, Ar, Kr, or Xe) to the hydrocarbon ˜250:1 by volume. In some examples, the noble gas is He. In some examples, the noble gas is Ne. In some examples, the noble gas is Ar. In some examples, the noble gas is Kr. In some examples, the noble gas is Xe. The gas phase, 803, maintains a uniform pressure as the stack, 801, expands to 802 and contracts during subsequent cycling. In some examples, there is a thermal connection with the walls of 805 and the tabs, 806. In some other examples, external pressure is also applied to 805 by a pressure-inducing module (not shown). In some examples, the pressure-inducing module can induce a pressure of up to 50 PSI, or up to 100 PSI, or up to 300 PSI, or up to 500 PSI, or up to 1000 PSI. In some examples, the pressure-inducing module can induce a pressure of 50 PSI. In some examples, the pressure-inducing module can induce a pressure of 100 PSI. In some examples, the pressure-inducing module can induce a pressure of 300 PSI. In some examples, the pressure-inducing module can induce a pressure of 500 PSI. In some examples, the pressure-inducing module can induce a pressure of 1000 PSI. In some examples, the walls of 805 include a pressure release valve that can be actuated to release the gases, 803, in 805 as a shutdown mechanism. This mechanism would release the gases, 803, in 805 such that the pressure in 805 drops to a point where the area-specific resistance in the stack, 801, exceeds a threshold for conducting a current.

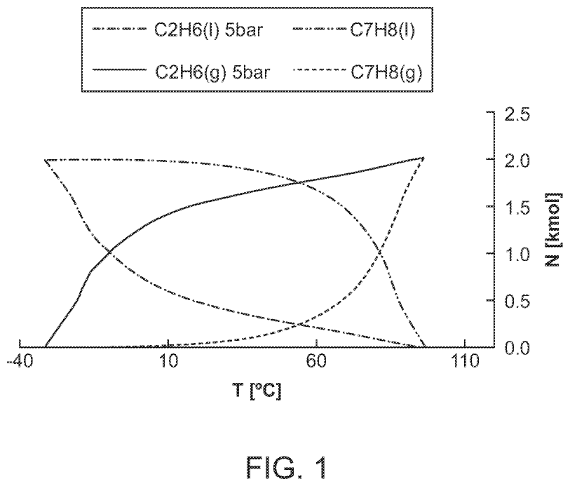

Materials which may be suitable for use in the aforementioned liquid/vapor equilibrium are shown in FIG. 1. With the illustrated mixture of materials as an example, a constant pressure (moles of material in the gas phase) may be maintained across a wide temperature range by using active feedback control with a pressure sensor and an actuator that removes liquid or gas from the cell into a separate reservoir. The actuator may be a peristaltic pump or the like. The liquid-vapor equilibrium may comprise a mixture of different components or one component. The materials should be inert to the other components of the battery, particularly the electrode materials and electrolyte. An additional requirement is that the material or material combination has a continuous, finite vapor pressure across the operating temperature range and retains some liquid phase across the operating temperature range. Examples of suitable materials include short chain hydrocarbons. Therefore, the effective spring constant does not vary with temperature, despite the pressure being provided by a gas. In some examples, the liquid/vapor equilibrium is an equilibrium for a mixture of ethane (i.e., C₂H₆) and toluene.

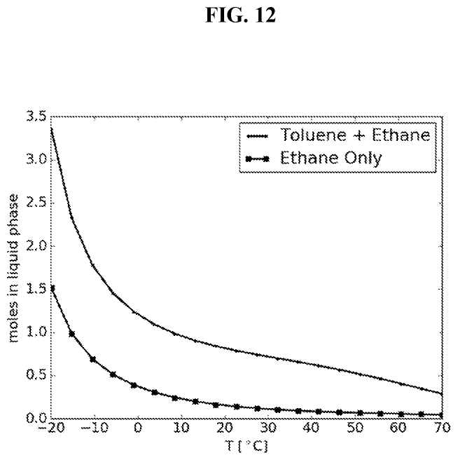

FIG. 12 shows the amount of gas in the liquid phase of a cell to maintain a constant pressure across an operating temperature range of −20 to 70° C. for a single component (ethane) and two components (ethane+toluene). Active feedback is required to exchange liquid between the cell and a reservoir based on the sensed pressure—or temperature—within the cell. An advantage of a multicomponent system is that the pressure sensitivity to liquid volume may be tuned to yield a more linear response, making the control system more robust and accurate.

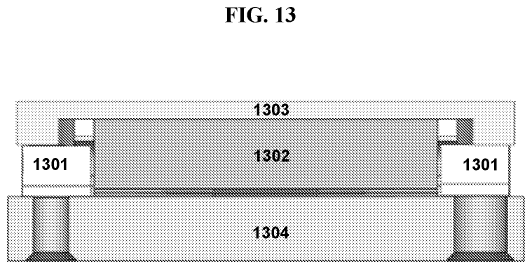

FIG. 13 shows a schematic of a cell that applies uniaxial and hydrostatic pressure to one or more electrochemical cells. The schematic includes a seal, 1301, around the one or more electrochemical cells, 1302. The one or more electrochemical cells, 1302, are enclosed by a top plate, 1303, and a bottom plate, 1304. Screws, 1305, apply tension between top plate, 1303, and a bottom plate, 1304.

In any embodiments herein, a getter which sequesters oxygen and/or water may optionally be present in combination with an electrochemical cell set forth herein. In some examples, the getter is lithium metal.

In some examples, set forth herein is an electrochemical cell including one or more electrode stacks, a hydrostatic material, and an outer-shell material, wherein the electrode stack includes a lithium metal negative electrode, a solid-state electrolyte, and a positive electrode; wherein the hydrostatic material contacts one of more of the stacks; wherein the hydrostatic material is contained by an outer-shell material; and wherein the bulk modulus of the outer-shell material is greater than the bulk modulus of the hydrostatic material. In some of these examples, there is one stack in the electrochemical cell. In some other examples, there are 2, 3, 4, 5, or 6 electrochemical stacks in the electrochemical cell. In some other examples, there are 2 electrochemical stacks in the electrochemical cell. In some other examples, there are 2 electrochemical stacks in the electrochemical cell. In some other examples, there are 3 electrochemical stacks in the electrochemical cell. In some other examples, there are 4 electrochemical stacks in the electrochemical cell. In some other examples, there are 5 electrochemical stacks in the electrochemical cell. In some other examples, there are 6 electrochemical stacks in the electrochemical cell. In some examples, there are at least 50, or at least 75, or at least 100, or at least 125, or at least 150 electrochemical stacks in the electrochemical cell.

In some examples set forth herein, the hydrostatic material is an insulator. In certain examples, the hydrostatic material is not conductive to electrons or ions. In certain examples, the hydrostatic material is not conductive to electrons. In certain examples, the hydrostatic material is not conductive to ions. In certain examples, the hydrostatic material is not conductive to ions such as but not limited to Li⁺. In certain other examples, the hydrostatic material is not conductive to Li⁺ ions. In some examples, the hydrostatic material used is an elastomer. In some examples, the hydrostatic material used is polyether ethyl ketone (PEEK). In some examples, the hydrostatic material used is polyethylene terephthalate (PET). In some examples, the hydrostatic material used is polypropylene (PP). In some examples, the hydrostatic material used is polyisobutylene. In some examples, the hydrostatic material used is PVdF.

In some other examples set forth herein, the hydrostatic material is an incompressible fluid. In certain examples, the hydrostatic material is selected from polyisobutylene, butyl polypropylene, ethylene propylene diene monomer, polypropylene, and thermoplastic olefin. In some of these examples, the hydrostatic material is polyisobutylene. In some of these examples, the hydrostatic material is butyl polypropylene. In some of these examples, the hydrostatic material is ethylene propylene diene monomer. In some of these examples, the hydrostatic material is a polymer made from ethylene propylene diene monomer. In some of these examples, the hydrostatic material is polypropylene. In some of these examples, the hydrostatic material is thermoplastic olefin. In some of these examples, the polyisobutylene has a molecular weight of 10,000-50,000 g/mol

In some examples set forth herein, the electrochemical cell includes conductive leads. These conductive leads are often referred to in the art as current collectors. These conductive leads are electronically conductive. These conductive leads provide a part of the electrical circuit in an electrochemical cell. In some examples, the conductive leads are in contact with the electrode stack and extend through both the hydrostatic material and the outer-shell material. In some of these examples, the conductive leads extend through both the hydrostatic material and the outer-shell material without leaving gaps or spaces through which electrolyte solvents (e.g., ethyl-methyl-carbonate) could flow. In some of these examples, the conductive leads extend through both the hydrostatic material and the outer-shell material by way of a hermetic seal in the hydrostatic material and outer-shell material. In yet some of these examples, the conductive leads are integrated into a can cell housing which contains the electrochemical cell. In yet some of these examples, the electrochemical cell includes a can cell housing which contains the electrochemical cell, wherein the can cell housing includes conductive leads as can cell tabs.

In some examples set forth herein, the outer-shell material is selected from a polyester material. In some of these examples, the polyester material is selected from acrylonitrile-butadiene-styrene, PC, polyethylene tetra phthalate, polyether ether ketone, and polyetherketone ketone. In other examples, the bulk modulus of the hydrostatic material is less than 1 GPa. In other examples, the bulk modulus of the hydrostatic material is greater than 1 GPa.

In some examples set forth herein, the electrochemical cell maintains an isotropic pressure on the one or more stacks. In certain examples, the electrochemical cell maintains an isotropic pressure on the one or more stacks.

In some examples set forth herein, the isotropic pressure is between 0-5000 pounds per square inch (PSI). Herein, isotropic pressure is measured as the compressive force on a load cell and divided by the area of contact, relative to atmospheric pressure (i.e. gauge pressure). In some examples, the pressure is about 1 PSI. In some examples, the pressure is about 2 PSI. In some examples, the pressure is about 3 PSI. In some examples, the pressure is about 4 PSI. In some examples, the pressure is about 5 PSI. In some examples, the pressure is about 6 PSI. In some examples, the pressure is about 7 PSI. In some examples, the pressure is about 8 PSI. In some examples, the pressure is about 9 PSI. In some examples, the pressure is about 10 PSI. In some examples, the pressure is about 11 PSI. In some examples, the pressure is about 12 PSI. In some examples, the pressure is about 13 PSI. In some examples, the pressure is about 14 PSI. In some examples, the pressure is about 15 PSI. In some examples, the pressure is about 16 PSI. In some examples, the pressure is about 17 PSI. In some examples, the pressure is about 18 PSI. In some examples, the pressure is about 19 PSI. In some examples, the pressure is about 20 PSI. In some examples, the pressure is about 21 PSI. In some examples, the pressure is about 22 PSI. In some examples, the pressure is about 23 PSI. In some examples, the pressure is about 24 PSI. In some examples, the pressure is about 25 PSI. In some examples, the pressure is about 26 PSI. In some examples, the pressure is about 27 PSI. In some examples, the pressure is about 28 PSI. In some examples, the pressure is about 29 PSI. In some examples, the pressure is about 30 PSI. In some examples, the pressure is about 31 PSI. In some examples, the pressure is about 32 PSI. In some examples, the pressure is about 33 PSI. In some examples, the pressure is about 34 PSI. In some examples, the pressure is about 35 PSI. In some examples, the pressure is about 36 PSI. In some examples, the pressure is about 37 PSI. In some examples, the pressure is about 38 PSI. In some examples, the pressure is about 39 PSI. In some examples, the pressure is about 40 PSI. In some examples, the pressure is about 41 PSI. In some examples, the pressure is about 42 PSI. In some examples, the pressure is about 43 PSI. In some examples, the pressure is about 44 PSI. In some examples, the pressure is about 45 PSI. In some examples, the pressure is about 46 PSI. In some examples, the pressure is about 47 PSI. In some examples, the pressure is about 48 PSI. In some examples, the pressure is about 49 PSI. In some examples, the pressure is about 50 PSI. In some examples, the pressure is about 51 PSI. In some examples, the pressure is about 52 PSI. In some examples, the pressure is about 53 PSI. In some examples, the pressure is about 54 PSI. In some examples, the pressure is about 55 PSI. In some examples, the pressure is about 56 PSI. In some examples, the pressure is about 57 PSI. In some examples, the pressure is about 58 PSI. In some examples, the pressure is about 19 PSI. In some examples, the pressure is about 60 PSI. In some examples, the pressure is about 61 PSI. In some examples, the pressure is about 62 PSI. In some examples, the pressure is about 63 PSI. In some examples, the pressure is about 64 PSI. In some examples, the pressure is about 65 PSI. In some examples, the pressure is about 66 PSI. In some examples, the pressure is about 67 PSI. In some examples, the pressure is about 68 PSI. In some examples, the pressure is about 69 PSI. In some examples, the pressure is about 70 PSI. In some examples, the pressure is about 71 PSI. In some examples, the pressure is about 72 PSI. In some examples, the pressure is about 73 PSI. In some examples, the pressure is about 74 PSI. In some examples, the pressure is about 75 PSI. In some examples, the pressure is about 76 PSI. In some examples, the pressure is about 77 PSI. In some examples, the pressure is about 78 PSI. In some examples, the pressure is about 79 PSI. In some examples, the pressure is about 80 PSI. In some examples, the pressure is about 88 PSI. In some examples, the pressure is about 82 PSI. In some examples, the pressure is about 83 PSI. In some examples, the pressure is about 84 PSI. In some examples, the pressure is about 85 PSI. In some examples, the pressure is about 86 PSI. In some examples, the pressure is about 87 PSI. In some examples, the pressure is about 88 PSI. In some examples, the pressure is about 89 PSI. In some examples, the pressure is about 90 PSI. In some examples, the pressure is about 99 PSI. In some examples, the pressure is about 92 PSI. In some examples, the pressure is about 93 PSI. In some examples, the pressure is about 94 PSI. In some examples, the pressure is about 95 PSI. In some examples, the pressure is about 96 PSI. In some examples, the pressure is about 97 PSI. In some examples, the pressure is about 98 PSI. In some examples, the pressure is about 99 PSI. In some examples, the pressure is about 100 PSI.

In some examples, the isotropic pressure is about 101 PSI. In some examples, the pressure is about 102 PSI. In some examples, the pressure is about 103 PSI. In some examples, the pressure is about 104 PSI. In some examples, the pressure is about 105 PSI. In some examples, the pressure is about 106 PSI. In some examples, the pressure is about 107 PSI. In some examples, the pressure is about 108 PSI. In some examples, the pressure is about 109 PSI. In some examples, the pressure is about 110 PSI. In some examples, the pressure is about 111 PSI. In some examples, the pressure is about 112 PSI. In some examples, the pressure is about 113 PSI. In some examples, the pressure is about 114 PSI. In some examples, the pressure is about 115 PSI. In some examples, the pressure is about 116 PSI. In some examples, the pressure is about 117 PSI. In some examples, the pressure is about 118 PSI. In some examples, the pressure is about 119 PSI. In some examples, the pressure is about 120 PSI. In some examples, the pressure is about 121 PSI. In some examples, the pressure is about 1212 PSI. In some examples, the pressure is about 123 PSI. In some examples, the pressure is about 124 PSI. In some examples, the pressure is about 125 PSI. In some examples, the pressure is about 126 PSI. In some examples, the pressure is about 127 PSI. In some examples, the pressure is about 128 PSI. In some examples, the pressure is about 129 PSI. In some examples, the pressure is about 130 PSI. In some examples, the pressure is about 131 PSI. In some examples, the pressure is about 132 PSI. In some examples, the pressure is about 1313 PSI. In some examples, the pressure is about 134 PSI. In some examples, the pressure is about 135 PSI. In some examples, the pressure is about 136 PSI. In some examples, the pressure is about 137 PSI. In some examples, the pressure is about 138 PSI. In some examples, the pressure is about 139 PSI. In some examples, the pressure is about 140 PSI. In some examples, the pressure is about 141 PSI. In some examples, the pressure is about 142 PSI. In some examples, the pressure is about 143 PSI. In some examples, the pressure is about 144 PSI. In some examples, the pressure is about 145 PSI. In some examples, the pressure is about 146 PSI. In some examples, the pressure is about 147 PSI. In some examples, the pressure is about 148 PSI. In some examples, the pressure is about 149 PSI. In some examples, the pressure is about 150 PSI. In some examples, the pressure is about 151 PSI. In some examples, the pressure is about 152 PSI. In some examples, the pressure is about 153 PSI. In some examples, the pressure is about 154 PSI. In some examples, the pressure is about 155 PSI. In some examples, the pressure is about 156 PSI. In some examples, the pressure is about 157 PSI. In some examples, the pressure is about 158 PSI. In some examples, the pressure is about 159 PSI. In some examples, the pressure is about 160 PSI. In some examples, the pressure is about 161 PSI. In some examples, the pressure is about 162 PSI. In some examples, the pressure is about 163 PSI. In some examples, the pressure is about 164 PSI. In some examples, the pressure is about 165 PSI. In some examples, the pressure is about 166 PSI. In some examples, the pressure is about 167 PSI. In some examples, the pressure is about 168 PSI. In some examples, the pressure is about 169 PSI. In some examples, the pressure is about 170 PSI. In some examples, the pressure is about 171 PSI. In some examples, the pressure is about 172 PSI. In some examples, the pressure is about 173 PSI. In some examples, the pressure is about 174 PSI. In some examples, the pressure is about 175 PSI. In some examples, the pressure is about 176 PSI. In some examples, the pressure is about 177 PSI. In some examples, the pressure is about 178 PSI. In some examples, the pressure is about 179 PSI. In some examples, the pressure is about 180 PSI. In some examples, the pressure is about 181 PSI. In some examples, the pressure is about 182 PSI. In some examples, the pressure is about 183 PSI. In some examples, the pressure is about 184 PSI. In some examples, the pressure is about 185 PSI. In some examples, the pressure is about 186 PSI. In some examples, the pressure is about 187 PSI. In some examples, the pressure is about 188 PSI. In some examples, the pressure is about 189 PSI. In some examples, the pressure is about 190 PSI. In some examples, the pressure is about 191 PSI. In some examples, the pressure is about 192 PSI. In some examples, the pressure is about 193 PSI. In some examples, the pressure is about 194 PSI. In some examples, the pressure is about 195 PSI. In some examples, the pressure is about 196 PSI. In some examples, the pressure is about 197 PSI. In some examples, the pressure is about 198 PSI. In some examples, the pressure is about 199 PSI. In some examples, the pressure is about 200 PSI.

In some examples, the isotropic pressure is about 201 PSI. In some examples, the pressure is about 202 PSI. In some examples, the pressure is about 203 PSI. In some examples, the pressure is about 204 PSI. In some examples, the pressure is about 205 PSI. In some examples, the pressure is about 206 PSI. In some examples, the pressure is about 207 PSI. In some examples, the pressure is about 208 PSI. In some examples, the pressure is about 209 PSI. In some examples, the pressure is about 210 PSI. In some examples, the pressure is about 211 PSI. In some examples, the pressure is about 212 PSI. In some examples, the pressure is about 213 PSI. In some examples, the pressure is about 214 PSI. In some examples, the pressure is about 215 PSI. In some examples, the pressure is about 216 PSI. In some examples, the pressure is about 217 PSI. In some examples, the pressure is about 218 PSI. In some examples, the pressure is about 219 PSI. In some examples, the pressure is about 220 PSI. In some examples, the pressure is about 221 PSI. In some examples, the pressure is about 222 PSI. In some examples, the pressure is about 223 PSI. In some examples, the pressure is about 224 PSI. In some examples, the pressure is about 225 PSI. In some examples, the pressure is about 226 PSI. In some examples, the pressure is about 227 PSI. In some examples, the pressure is about 228 PSI. In some examples, the pressure is about 229 PSI. In some examples, the pressure is about 230 PSI. In some examples, the pressure is about 231 PSI. In some examples, the pressure is about 232 PSI. In some examples, the pressure is about 233 PSI. In some examples, the pressure is about 234 PSI. In some examples, the pressure is about 235 PSI. In some examples, the pressure is about 236 PSI. In some examples, the pressure is about 237 PSI. In some examples, the pressure is about 238 PSI. In some examples, the pressure is about 239 PSI. In some examples, the pressure is about 240 PSI. In some examples, the pressure is about 241 PSI. In some examples, the pressure is about 242 PSI. In some examples, the pressure is about 243 PSI. In some examples, the pressure is about 244 PSI. In some examples, the pressure is about 245 PSI. In some examples, the pressure is about 246 PSI. In some examples, the pressure is about 247 PSI. In some examples, the pressure is about 248 PSI. In some examples, the pressure is about 249 PSI. In some examples, the pressure is about 250 PSI. In some examples, the pressure is about 251 PSI. In some examples, the pressure is about 252 PSI. In some examples, the pressure is about 253 PSI. In some examples, the pressure is about 254 PSI. In some examples, the pressure is about 255 PSI. In some examples, the pressure is about 256 PSI. In some examples, the pressure is about 257 PSI. In some examples, the pressure is about 258 PSI. In some examples, the pressure is about 259 PSI. In some examples, the pressure is about 260 PSI. In some examples, the pressure is about 261 PSI. In some examples, the pressure is about 262 PSI. In some examples, the pressure is about 263 PSI. In some examples, the pressure is about 264 PSI. In some examples, the pressure is about 265 PSI. In some examples, the pressure is about 266 PSI. In some examples, the pressure is about 267 PSI. In some examples, the pressure is about 268 PSI. In some examples, the pressure is about 269 PSI. In some examples, the pressure is about 270 PSI. In some examples, the pressure is about 271 PSI. In some examples, the pressure is about 272 PSI. In some examples, the pressure is about 273 PSI. In some examples, the pressure is about 274 PSI. In some examples, the pressure is about 275 PSI. In some examples, the pressure is about 276 PSI. In some examples, the pressure is about 277 PSI. In some examples, the pressure is about 278 PSI. In some examples, the pressure is about 279 PSI. In some examples, the pressure is about 280 PSI. In some examples, the pressure is about 281 PSI. In some examples, the pressure is about 282 PSI. In some examples, the pressure is about 283 PSI. In some examples, the pressure is about 284 PSI. In some examples, the pressure is about 285 PSI. In some examples, the pressure is about 286 PSI. In some examples, the pressure is about 287 PSI. In some examples, the pressure is about 288 PSI. In some examples, the pressure is about 289 PSI. In some examples, the pressure is about 290 PSI. In some examples, the pressure is about 291 PSI. In some examples, the pressure is about 292 PSI. In some examples, the pressure is about 293 PSI. In some examples, the pressure is about 294 PSI. In some examples, the pressure is about 295 PSI. In some examples, the pressure is about 296 PSI. In some examples, the pressure is about 297 PSI. In some examples, the pressure is about 298 PSI. In some examples, the pressure is about 299 PSI. In some examples, the pressure is about 300 PSI.

In some examples, the isotropic pressure is about 301 PSI. In some examples, the pressure is about 302 PSI. In some examples, the pressure is about 303 PSI. In some examples, the pressure is about 304 PSI. In some examples, the pressure is about 305 PSI. In some examples, the pressure is about 306 PSI. In some examples, the pressure is about 307 PSI. In some examples, the pressure is about 308 PSI. In some examples, the pressure is about 309 PSI. In some examples, the pressure is about 310 PSI. In some examples, the pressure is about 311 PSI. In some examples, the pressure is about 312 PSI. In some examples, the pressure is about 313 PSI. In some examples, the pressure is about 314 PSI. In some examples, the pressure is about 315 PSI. In some examples, the pressure is about 316 PSI. In some examples, the pressure is about 317 PSI. In some examples, the pressure is about 318 PSI. In some examples, the pressure is about 319 PSI. In some examples, the pressure is about 320 PSI. In some examples, the pressure is about 321 PSI. In some examples, the pressure is about 322 PSI. In some examples, the pressure is about 323 PSI. In some examples, the pressure is about 324 PSI. In some examples, the pressure is about 325 PSI. In some examples, the pressure is about 326 PSI. In some examples, the pressure is about 327 PSI. In some examples, the pressure is about 328 PSI. In some examples, the pressure is about 329 PSI. In some examples, the pressure is about 330 PSI. In some examples, the pressure is about 331 PSI. In some examples, the pressure is about 332 PSI. In some examples, the pressure is about 333 PSI. In some examples, the pressure is about 334 PSI. In some examples, the pressure is about 335 PSI. In some examples, the pressure is about 336 PSI. In some examples, the pressure is about 337 PSI. In some examples, the pressure is about 338 PSI. In some examples, the pressure is about 339 PSI. In some examples, the pressure is about 340 PSI. In some examples, the pressure is about 341 PSI. In some examples, the pressure is about 342 PSI. In some examples, the pressure is about 343 PSI. In some examples, the pressure is about 344 PSI. In some examples, the pressure is about 345 PSI. In some examples, the pressure is about 346 PSI. In some examples, the pressure is about 347 PSI. In some examples, the pressure is about 348 PSI. In some examples, the pressure is about 349 PSI. In some examples, the pressure is about 350 PSI. In some examples, the pressure is about 351 PSI. In some examples, the pressure is about 352 PSI. In some examples, the pressure is about 353 PSI. In some examples, the pressure is about 354 PSI. In some examples, the pressure is about 355 PSI. In some examples, the pressure is about 356 PSI. In some examples, the pressure is about 357 PSI. In some examples, the pressure is about 358 PSI. In some examples, the pressure is about 359 PSI. In some examples, the pressure is about 360 PSI. In some examples, the pressure is about 361 PSI. In some examples, the pressure is about 362 PSI. In some examples, the pressure is about 363 PSI. In some examples, the pressure is about 364 PSI. In some examples, the pressure is about 365 PSI. In some examples, the pressure is about 366 PSI. In some examples, the pressure is about 367 PSI. In some examples, the pressure is about 368 PSI. In some examples, the pressure is about 369 PSI. In some examples, the pressure is about 370 PSI. In some examples, the pressure is about 371 PSI. In some examples, the pressure is about 373 PSI. In some examples, the pressure is about 373 PSI. In some examples, the pressure is about 374 PSI. In some examples, the pressure is about 375 PSI. In some examples, the pressure is about 376 PSI. In some examples, the pressure is about 377 PSI. In some examples, the pressure is about 378 PSI. In some examples, the pressure is about 379 PSI. In some examples, the pressure is about 380 PSI. In some examples, the pressure is about 381 PSI. In some examples, the pressure is about 382 PSI. In some examples, the pressure is about 383 PSI. In some examples, the pressure is about 384 PSI. In some examples, the pressure is about 385 PSI. In some examples, the pressure is about 386 PSI. In some examples, the pressure is about 387 PSI. In some examples, the pressure is about 388 PSI. In some examples, the pressure is about 389 PSI. In some examples, the pressure is about 390 PSI. In some examples, the pressure is about 391 PSI. In some examples, the pressure is about 392 PSI. In some examples, the pressure is about 393 PSI. In some examples, the pressure is about 394 PSI. In some examples, the pressure is about 395 PSI. In some examples, the pressure is about 396 PSI. In some examples, the pressure is about 397 PSI. In some examples, the pressure is about 398 PSI. In some examples, the pressure is about 399 PSI. In some examples, the pressure is about 400 PSI.

In some examples, the isotropic pressure is about 401 PSI. In some examples, the pressure is about 402 PSI. In some examples, the pressure is about 403 PSI. In some examples, the pressure is about 404 PSI. In some examples, the pressure is about 405 PSI. In some examples, the pressure is about 406 PSI. In some examples, the pressure is about 407 PSI. In some examples, the pressure is about 408 PSI. In some examples, the pressure is about 409 PSI. In some examples, the pressure is about 410 PSI. In some examples, the pressure is about 411 PSI. In some examples, the pressure is about 412 PSI. In some examples, the pressure is about 413 PSI. In some examples, the pressure is about 414 PSI. In some examples, the pressure is about 415 PSI. In some examples, the pressure is about 416 PSI. In some examples, the pressure is about 417 PSI. In some examples, the pressure is about 418 PSI. In some examples, the pressure is about 419 PSI. In some examples, the pressure is about 420 PSI. In some examples, the pressure is about 421 PSI. In some examples, the pressure is about 422 PSI. In some examples, the pressure is about 423 PSI. In some examples, the pressure is about 424 PSI. In some examples, the pressure is about 425 PSI. In some examples, the pressure is about 426 PSI. In some examples, the pressure is about 427 PSI. In some examples, the pressure is about 428 PSI. In some examples, the pressure is about 429 PSI. In some examples, the pressure is about 430 PSI. In some examples, the pressure is about 431 PSI. In some examples, the pressure is about 432 PSI. In some examples, the pressure is about 433 PSI. In some examples, the pressure is about 434 PSI. In some examples, the pressure is about 435 PSI. In some examples, the pressure is about 436 PSI. In some examples, the pressure is about 437 PSI. In some examples, the pressure is about 438 PSI. In some examples, the pressure is about 439 PSI. In some examples, the pressure is about 440 PSI. In some examples, the pressure is about 441 PSI. In some examples, the pressure is about 442 PSI. In some examples, the pressure is about 443 PSI. In some examples, the pressure is about 444 PSI. In some examples, the pressure is about 445 PSI. In some examples, the pressure is about 446 PSI. In some examples, the pressure is about 447 PSI. In some examples, the pressure is about 448 PSI. In some examples, the pressure is about 449 PSI. In some examples, the pressure is about 450 PSI. In some examples, the pressure is about 451 PSI. In some examples, the pressure is about 452 PSI. In some examples, the pressure is about 53 PSI. In some examples, the pressure is about 454 PSI. In some examples, the pressure is about 455 PSI. In some examples, the pressure is about 456 PSI. In some examples, the pressure is about 457 PSI. In some examples, the pressure is about 458 PSI. In some examples, the pressure is about 459 PSI. In some examples, the pressure is about 460 PSI. In some examples, the pressure is about 461 PSI. In some examples, the pressure is about 462 PSI. In some examples, the pressure is about 463 PSI. In some examples, the pressure is about 464 PSI. In some examples, the pressure is about 465 PSI. In some examples, the pressure is about 466 PSI. In some examples, the pressure is about 467 PSI. In some examples, the pressure is about 468 PSI. In some examples, the pressure is about 469 PSI. In some examples, the pressure is about 470 PSI. In some examples, the pressure is about 471 PSI. In some examples, the pressure is about 472 PSI. In some examples, the pressure is about 473 PSI. In some examples, the pressure is about 474 PSI. In some examples, the pressure is about 475 PSI. In some examples, the pressure is about 476 PSI. In some examples, the pressure is about 477 PSI. In some examples, the pressure is about 478 PSI. In some examples, the pressure is about 479 PSI. In some examples, the pressure is about 480 PSI. In some examples, the pressure is about 481 PSI. In some examples, the pressure is about 482 PSI. In some examples, the pressure is about 483 PSI. In some examples, the pressure is about 484 PSI. In some examples, the pressure is about 485 PSI. In some examples, the pressure is about 486 PSI. In some examples, the pressure is about 487 PSI. In some examples, the pressure is about 488 PSI. In some examples, the pressure is about 489 PSI. In some examples, the pressure is about 490 PSI. In some examples, the pressure is about 491 PSI. In some examples, the pressure is about 492 PSI. In some examples, the pressure is about 493 PSI. In some examples, the pressure is about 494 PSI. In some examples, the pressure is about 495 PSI. In some examples, the pressure is about 496 PSI. In some examples, the pressure is about 497 PSI. In some examples, the pressure is about 498 PSI. In some examples, the pressure is about 499 PSI. In some examples, the pressure is about 500 PSI.

In some examples, the isotropic pressure is about 501 PSI. In some examples, the pressure is about 502 PSI. In some examples, the pressure is about 503 PSI. In some examples, the pressure is about 504 PSI. In some examples, the pressure is about 505 PSI. In some examples, the pressure is about 506 PSI. In some examples, the pressure is about 507 PSI. In some examples, the pressure is about 508 PSI. In some examples, the pressure is about 509 PSI. In some examples, the pressure is about 510 PSI. In some examples, the pressure is about 511 PSI. In some examples, the pressure is about 512 PSI. In some examples, the pressure is about 513 PSI. In some examples, the pressure is about 514 PSI. In some examples, the pressure is about 515 PSI. In some examples, the pressure is about 516 PSI. In some examples, the pressure is about 517 PSI. In some examples, the pressure is about 518 PSI. In some examples, the pressure is about 519 PSI. In some examples, the pressure is about 520 PSI. In some examples, the pressure is about 521 PSI. In some examples, the pressure is about 522 PSI. In some examples, the pressure is about 523 PSI. In some examples, the pressure is about 524 PSI. In some examples, the pressure is about 525 PSI. In some examples, the pressure is about 526 PSI. In some examples, the pressure is about 527 PSI. In some examples, the pressure is about 528 PSI. In some examples, the pressure is about 529 PSI. In some examples, the pressure is about 530 PSI. In some examples, the pressure is about 531 PSI. In some examples, the pressure is about 532 PSI. In some examples, the pressure is about 533 PSI. In some examples, the pressure is about 534 PSI. In some examples, the pressure is about 535 PSI. In some examples, the pressure is about 536 PSI. In some examples, the pressure is about 537 PSI. In some examples, the pressure is about 538 PSI. In some examples, the pressure is about 539 PSI. In some examples, the pressure is about 540 PSI. In some examples, the pressure is about 541 PSI. In some examples, the pressure is about 542 PSI. In some examples, the pressure is about 543 PSI. In some examples, the pressure is about 544 PSI. In some examples, the pressure is about 545 PSI. In some examples, the pressure is about 546 PSI. In some examples, the pressure is about 547 PSI. In some examples, the pressure is about 548 PSI. In some examples, the pressure is about 549 PSI. In some examples, the pressure is about 550 PSI. In some examples, the pressure is about 551 PSI. In some examples, the pressure is about 552 PSI. In some examples, the pressure is about 553 PSI. In some examples, the pressure is about 554 PSI. In some examples, the pressure is about 555 PSI. In some examples, the pressure is about 556 PSI. In some examples, the pressure is about 557 PSI. In some examples, the pressure is about 558 PSI. In some examples, the pressure is about 559 PSI. In some examples, the pressure is about 560 PSI. In some examples, the pressure is about 561 PSI. In some examples, the pressure is about 562 PSI. In some examples, the pressure is about 563 PSI. In some examples, the pressure is about 564 PSI. In some examples, the pressure is about 565 PSI. In some examples, the pressure is about 566 PSI. In some examples, the pressure is about 567 PSI. In some examples, the pressure is about 568 PSI. In some examples, the pressure is about 569 PSI. In some examples, the pressure is about 570 PSI. In some examples, the pressure is about 571 PSI. In some examples, the pressure is about 572 PSI. In some examples, the pressure is about 573 PSI. In some examples, the pressure is about 574 PSI. In some examples, the pressure is about 575 PSI. In some examples, the pressure is about 576 PSI. In some examples, the pressure is about 577 PSI. In some examples, the pressure is about 578 PSI. In some examples, the pressure is about 579 PSI. In some examples, the pressure is about 580 PSI. In some examples, the pressure is about 581 PSI. In some examples, the pressure is about 582 PSI. In some examples, the pressure is about 583 PSI. In some examples, the pressure is about 584 PSI. In some examples, the pressure is about 585 PSI. In some examples, the pressure is about 586 PSI. In some examples, the pressure is about 587 PSI. In some examples, the pressure is about 588 PSI. In some examples, the pressure is about 589 PSI. In some examples, the pressure is about 590 PSI. In some examples, the pressure is about 591 PSI. In some examples, the pressure is about 592 PSI. In some examples, the pressure is about 593 PSI. In some examples, the pressure is about 594 PSI. In some examples, the pressure is about 595 PSI. In some examples, the pressure is about 596 PSI. In some examples, the pressure is about 597 PSI. In some examples, the pressure is about 598 PSI. In some examples, the pressure is about 599 PSI. In some examples, the pressure is about 600 PSI.

In some examples, the isotropic pressure is about 601 PSI. In some examples, the pressure is about 602 PSI. In some examples, the pressure is about 603 PSI. In some examples, the pressure is about 604 PSI. In some examples, the pressure is about 605 PSI. In some examples, the pressure is about 606 PSI. In some examples, the pressure is about 607 PSI. In some examples, the pressure is about 608 PSI. In some examples, the pressure is about 609 PSI. In some examples, the pressure is about 610 PSI. In some examples, the pressure is about 611 PSI. In some examples, the pressure is about 612 PSI. In some examples, the pressure is about 613 PSI. In some examples, the pressure is about 614 PSI. In some examples, the pressure is about 615 PSI. In some examples, the pressure is about 616 PSI. In some examples, the pressure is about 617 PSI. In some examples, the pressure is about 618 PSI. In some examples, the pressure is about 619 PSI. In some examples, the pressure is about 620 PSI. In some examples, the pressure is about 621 PSI. In some examples, the pressure is about 622 PSI. In some examples, the pressure is about 663 PSI. In some examples, the pressure is about 624 PSI. In some examples, the pressure is about 625 PSI. In some examples, the pressure is about 626 PSI. In some examples, the pressure is about 627 PSI. In some examples, the pressure is about 628 PSI. In some examples, the pressure is about 629 PSI. In some examples, the pressure is about 630 PSI. In some examples, the pressure is about 631 PSI. In some examples, the pressure is about 632 PSI. In some examples, the pressure is about 633 PSI. In some examples, the pressure is about 634 PSI. In some examples, the pressure is about 635 PSI. In some examples, the pressure is about 636 PSI. In some examples, the pressure is about 637 PSI. In some examples, the pressure is about 638 PSI. In some examples, the pressure is about 639 PSI. In some examples, the pressure is about 640 PSI. In some examples, the pressure is about 641 PSI. In some examples, the pressure is about 642 PSI. In some examples, the pressure is about 643 PSI. In some examples, the pressure is about 644 PSI. In some examples, the pressure is about 645 PSI. In some examples, the pressure is about 646 PSI. In some examples, the pressure is about 647 PSI. In some examples, the pressure is about 648 PSI. In some examples, the pressure is about 649 PSI. In some examples, the pressure is about 650 PSI. In some examples, the pressure is about 651 PSI. In some examples, the pressure is about 652 PSI. In some examples, the pressure is about 653 PSI. In some examples, the pressure is about 654 PSI. In some examples, the pressure is about 655 PSI. In some examples, the pressure is about 656 PSI. In some examples, the pressure is about 657 PSI. In some examples, the pressure is about 658 PSI. In some examples, the pressure is about 659 PSI. In some examples, the pressure is about 660 PSI. In some examples, the pressure is about 661 PSI. In some examples, the pressure is about 662 PSI. In some examples, the pressure is about 663 PSI. In some examples, the pressure is about 664 PSI. In some examples, the pressure is about 665 PSI. In some examples, the pressure is about 666 PSI. In some examples, the pressure is about 667 PSI. In some examples, the pressure is about 668 PSI. In some examples, the pressure is about 669 PSI. In some examples, the pressure is about 670 PSI. In some examples, the pressure is about 671 PSI. In some examples, the pressure is about 672 PSI. In some examples, the pressure is about 673 PSI. In some examples, the pressure is about 674 PSI. In some examples, the pressure is about 675 PSI. In some examples, the pressure is about 676 PSI. In some examples, the pressure is about 677 PSI. In some examples, the pressure is about 678 PSI. In some examples, the pressure is about 679 PSI. In some examples, the pressure is about 680 PSI. In some examples, the pressure is about 681 PSI. In some examples, the pressure is about 682 PSI. In some examples, the pressure is about 683 PSI. In some examples, the pressure is about 684 PSI. In some examples, the pressure is about 685 PSI. In some examples, the pressure is about 686 PSI. In some examples, the pressure is about 687 PSI. In some examples, the pressure is about 688 PSI. In some examples, the pressure is about 689 PSI. In some examples, the pressure is about 690 PSI. In some examples, the pressure is about 691 PSI. In some examples, the pressure is about 692 PSI. In some examples, the pressure is about 693 PSI. In some examples, the pressure is about 694 PSI. In some examples, the pressure is about 695 PSI. In some examples, the pressure is about 696 PSI. In some examples, the pressure is about 697 PSI. In some examples, the pressure is about 698 PSI. In some examples, the pressure is about 699 PSI. In some examples, the pressure is about 700 PSI.

In some examples, the isotropic pressure is about 701 PSI. In some examples, the pressure is about 702 PSI. In some examples, the pressure is about 703 PSI. In some examples, the pressure is about 704 PSI. In some examples, the pressure is about 705 PSI. In some examples, the pressure is about 706 PSI. In some examples, the pressure is about 707 PSI. In some examples, the pressure is about 708 PSI. In some examples, the pressure is about 709 PSI. In some examples, the pressure is about 710 PSI. In some examples, the pressure is about 711 PSI. In some examples, the pressure is about 712 PSI. In some examples, the pressure is about 713 PSI. In some examples, the pressure is about 714 PSI. In some examples, the pressure is about 715 PSI. In some examples, the pressure is about 716 PSI. In some examples, the pressure is about 717 PSI. In some examples, the pressure is about 718 PSI. In some examples, the pressure is about 719 PSI. In some examples, the pressure is about 720 PSI. In some examples, the pressure is about 721 PSI. In some examples, the pressure is about 727 PSI. In some examples, the pressure is about 723 PSI. In some examples, the pressure is about 724 PSI. In some examples, the pressure is about 725 PSI. In some examples, the pressure is about 726 PSI. In some examples, the pressure is about 727 PSI. In some examples, the pressure is about 728 PSI. In some examples, the pressure is about 729 PSI. In some examples, the pressure is about 730 PSI. In some examples, the pressure is about 731 PSI. In some examples, the pressure is about 732 PSI. In some examples, the pressure is about 733 PSI. In some examples, the pressure is about 734 PSI. In some examples, the pressure is about 735 PSI. In some examples, the pressure is about 736 PSI. In some examples, the pressure is about 737 PSI. In some examples, the pressure is about 738 PSI. In some examples, the pressure is about 739 PSI. In some examples, the pressure is about 740 PSI. In some examples, the pressure is about 741 PSI. In some examples, the pressure is about 742 PSI. In some examples, the pressure is about 743 PSI. In some examples, the pressure is about 744 PSI. In some examples, the pressure is about 745 PSI. In some examples, the pressure is about 746 PSI. In some examples, the pressure is about 747 PSI. In some examples, the pressure is about 748 PSI. In some examples, the pressure is about 749 PSI. In some examples, the pressure is about 750 PSI. In some examples, the pressure is about 751 PSI. In some examples, the pressure is about 752 PSI. In some examples, the pressure is about 753 PSI. In some examples, the pressure is about 754 PSI. In some examples, the pressure is about 755 PSI. In some examples, the pressure is about 756 PSI. In some examples, the pressure is about 757 PSI. In some examples, the pressure is about 758 PSI. In some examples, the pressure is about 759 PSI. In some examples, the pressure is about 760 PSI. In some examples, the pressure is about 761 PSI. In some examples, the pressure is about 762 PSI. In some examples, the pressure is about 763 PSI. In some examples, the pressure is about 764 PSI. In some examples, the pressure is about 765 PSI. In some examples, the pressure is about 766 PSI. In some examples, the pressure is about 767 PSI. In some examples, the pressure is about 768 PSI. In some examples, the pressure is about 769 PSI. In some examples, the pressure is about 770 PSI. In some examples, the pressure is about 771 PSI. In some examples, the pressure is about 772 PSI. In some examples, the pressure is about 773 PSI. In some examples, the pressure is about 774 PSI. In some examples, the pressure is about 775 PSI. In some examples, the pressure is about 776 PSI. In some examples, the pressure is about 777 PSI. In some examples, the pressure is about 778 PSI. In some examples, the pressure is about 779 PSI. In some examples, the pressure is about 780 PSI. In some examples, the pressure is about 781 PSI. In some examples, the pressure is about 782 PSI. In some examples, the pressure is about 783 PSI. In some examples, the pressure is about 784 PSI. In some examples, the pressure is about 785 PSI. In some examples, the pressure is about 786 PSI. In some examples, the pressure is about 787 PSI. In some examples, the pressure is about 788 PSI. In some examples, the pressure is about 789 PSI. In some examples, the pressure is about 790 PSI. In some examples, the pressure is about 791 PSI. In some examples, the pressure is about 792 PSI. In some examples, the pressure is about 793 PSI. In some examples, the pressure is about 794 PSI. In some examples, the pressure is about 795 PSI. In some examples, the pressure is about 796 PSI. In some examples, the pressure is about 797 PSI. In some examples, the pressure is about 798 PSI. In some examples, the pressure is about 799 PSI. In some examples, the pressure is about 800 PSI.

In some examples, the isotropic pressure is about 701 PSI. In some examples, the pressure is about 702 PSI. In some examples, the pressure is about 703 PSI. In some examples, the pressure is about 704 PSI. In some examples, the pressure is about 705 PSI. In some examples, the pressure is about 706 PSI. In some examples, the pressure is about 707 PSI. In some examples, the pressure is about 708 PSI. In some examples, the pressure is about 709 PSI. In some examples, the pressure is about 710 PSI. In some examples, the pressure is about 711 PSI. In some examples, the pressure is about 712 PSI. In some examples, the pressure is about 713 PSI. In some examples, the pressure is about 714 PSI. In some examples, the pressure is about 715 PSI. In some examples, the pressure is about 716 PSI. In some examples, the pressure is about 717 PSI. In some examples, the pressure is about 718 PSI. In some examples, the pressure is about 719 PSI. In some examples, the pressure is about 720 PSI. In some examples, the pressure is about 721 PSI. In some examples, the pressure is about 727 PSI. In some examples, the pressure is about 723 PSI. In some examples, the pressure is about 724 PSI. In some examples, the pressure is about 725 PSI. In some examples, the pressure is about 726 PSI. In some examples, the pressure is about 727 PSI. In some examples, the pressure is about 728 PSI. In some examples, the pressure is about 729 PSI. In some examples, the pressure is about 730 PSI. In some examples, the pressure is about 731 PSI. In some examples, the pressure is about 732 PSI. In some examples, the pressure is about 733 PSI. In some examples, the pressure is about 734 PSI. In some examples, the pressure is about 735 PSI. In some examples, the pressure is about 736 PSI. In some examples, the pressure is about 737 PSI. In some examples, the pressure is about 738 PSI. In some examples, the pressure is about 739 PSI. In some examples, the pressure is about 740 PSI. In some examples, the pressure is about 741 PSI. In some examples, the pressure is about 742 PSI. In some examples, the pressure is about 743 PSI. In some examples, the pressure is about 744 PSI. In some examples, the pressure is about 745 PSI. In some examples, the pressure is about 746 PSI. In some examples, the pressure is about 747 PSI. In some examples, the pressure is about 748 PSI. In some examples, the pressure is about 749 PSI. In some examples, the pressure is about 750 PSI. In some examples, the pressure is about 751 PSI. In some examples, the pressure is about 752 PSI. In some examples, the pressure is about 753 PSI. In some examples, the pressure is about 754 PSI. In some examples, the pressure is about 755 PSI. In some examples, the pressure is about 756 PSI. In some examples, the pressure is about 757 PSI. In some examples, the pressure is about 758 PSI. In some examples, the pressure is about 759 PSI. In some examples, the pressure is about 760 PSI. In some examples, the pressure is about 761 PSI. In some examples, the pressure is about 762 PSI. In some examples, the pressure is about 763 PSI. In some examples, the pressure is about 764 PSI. In some examples, the pressure is about 765 PSI. In some examples, the pressure is about 766 PSI. In some examples, the pressure is about 767 PSI. In some examples, the pressure is about 768 PSI. In some examples, the pressure is about 769 PSI. In some examples, the pressure is about 770 PSI. In some examples, the pressure is about 771 PSI. In some examples, the pressure is about 772 PSI. In some examples, the pressure is about 773 PSI. In some examples, the pressure is about 774 PSI. In some examples, the pressure is about 775 PSI. In some examples, the pressure is about 776 PSI. In some examples, the pressure is about 777 PSI. In some examples, the pressure is about 778 PSI. In some examples, the pressure is about 779 PSI. In some examples, the pressure is about 780 PSI. In some examples, the pressure is about 781 PSI. In some examples, the pressure is about 782 PSI. In some examples, the pressure is about 783 PSI. In some examples, the pressure is about 784 PSI. In some examples, the pressure is about 785 PSI. In some examples, the pressure is about 786 PSI. In some examples, the pressure is about 787 PSI. In some examples, the pressure is about 788 PSI. In some examples, the pressure is about 789 PSI. In some examples, the pressure is about 790 PSI. In some examples, the pressure is about 791 PSI. In some examples, the pressure is about 792 PSI. In some examples, the pressure is about 793 PSI. In some examples, the pressure is about 794 PSI. In some examples, the pressure is about 795 PSI. In some examples, the pressure is about 796 PSI. In some examples, the pressure is about 797 PSI. In some examples, the pressure is about 798 PSI. In some examples, the pressure is about 799 PSI. In some examples, the pressure is about 800 PSI.

In some examples, the isotropic pressure is about 801 PSI. In some examples, the pressure is about 802 PSI. In some examples, the pressure is about 803 PSI. In some examples, the pressure is about 804 PSI. In some examples, the pressure is about 805 PSI. In some examples, the pressure is about 806 PSI. In some examples, the pressure is about 807 PSI. In some examples, the pressure is about 808 PSI. In some examples, the pressure is about 809 PSI. In some examples, the pressure is about 810 PSI. In some examples, the pressure is about 811 PSI. In some examples, the pressure is about 812 PSI. In some examples, the pressure is about 813 PSI. In some examples, the pressure is about 814 PSI. In some examples, the pressure is about 815 PSI. In some examples, the pressure is about 816 PSI. In some examples, the pressure is about 817 PSI. In some examples, the pressure is about 818 PSI. In some examples, the pressure is about 819 PSI. In some examples, the pressure is about 820 PSI. In some examples, the pressure is about 821 PSI. In some examples, the pressure is about 827 PSI. In some examples, the pressure is about 823 PSI. In some examples, the pressure is about 824 PSI. In some examples, the pressure is about 825 PSI. In some examples, the pressure is about 826 PSI. In some examples, the pressure is about 827 PSI. In some examples, the pressure is about 828 PSI. In some examples, the pressure is about 829 PSI. In some examples, the pressure is about 830 PSI. In some examples, the pressure is about 831 PSI. In some examples, the pressure is about 832 PSI. In some examples, the pressure is about 833 PSI. In some examples, the pressure is about 834 PSI. In some examples, the pressure is about 835 PSI. In some examples, the pressure is about 836 PSI. In some examples, the pressure is about 838 PSI. In some examples, the pressure is about 838 PSI. In some examples, the pressure is about 839 PSI. In some examples, the pressure is about 840 PSI. In some examples, the pressure is about 841 PSI. In some examples, the pressure is about 842 PSI. In some examples, the pressure is about 843 PSI. In some examples, the pressure is about 844 PSI. In some examples, the pressure is about 845 PSI. In some examples, the pressure is about 846 PSI. In some examples, the pressure is about 848 PSI. In some examples, the pressure is about 848 PSI. In some examples, the pressure is about 849 PSI. In some examples, the pressure is about 850 PSI. In some examples, the pressure is about 851 PSI. In some examples, the pressure is about 852 PSI. In some examples, the pressure is about 853 PSI. In some examples, the pressure is about 854 PSI. In some examples, the pressure is about 855 PSI. In some examples, the pressure is about 856 PSI. In some examples, the pressure is about 857 PSI. In some examples, the pressure is about 858 PSI. In some examples, the pressure is about 859 PSI. In some examples, the pressure is about 860 PSI. In some examples, the pressure is about 861 PSI. In some examples, the pressure is about 862 PSI. In some examples, the pressure is about 863 PSI. In some examples, the pressure is about 864 PSI. In some examples, the pressure is about 865 PSI. In some examples, the pressure is about 866 PSI. In some examples, the pressure is about 867 PSI. In some examples, the pressure is about 868 PSI. In some examples, the pressure is about 869 PSI. In some examples, the pressure is about 870 PSI. In some examples, the pressure is about 871 PSI. In some examples, the pressure is about 872 PSI. In some examples, the pressure is about 873 PSI. In some examples, the pressure is about 874 PSI. In some examples, the pressure is about 875 PSI. In some examples, the pressure is about 876 PSI. In some examples, the pressure is about 877 PSI. In some examples, the pressure is about 878 PSI. In some examples, the pressure is about 879 PSI. In some examples, the pressure is about 880 PSI. In some examples, the pressure is about 881 PSI. In some examples, the pressure is about 882 PSI. In some examples, the pressure is about 883 PSI. In some examples, the pressure is about 884 PSI. In some examples, the pressure is about 885 PSI. In some examples, the pressure is about 886 PSI. In some examples, the pressure is about 887 PSI. In some examples, the pressure is about 888 PSI. In some examples, the pressure is about 889 PSI. In some examples, the pressure is about 890 PSI. In some examples, the pressure is about 891 PSI. In some examples, the pressure is about 892 PSI. In some examples, the pressure is about 893 PSI. In some examples, the pressure is about 894 PSI. In some examples, the pressure is about 895 PSI. In some examples, the pressure is about 896 PSI. In some examples, the pressure is about 897 PSI. In some examples, the pressure is about 898 PSI. In some examples, the pressure is about 899 PSI. In some examples, the pressure is about 900 PSI.

In some examples, the isotropic pressure is about 901 PSI. In some examples, the pressure is about 902 PSI. In some examples, the pressure is about 903 PSI. In some examples, the pressure is about 904 PSI. In some examples, the pressure is about 905 PSI. In some examples, the pressure is about 906 PSI. In some examples, the pressure is about 907 PSI. In some examples, the pressure is about 908 PSI. In some examples, the pressure is about 909 PSI. In some examples, the pressure is about 910 PSI. In some examples, the pressure is about 911 PSI. In some examples, the pressure is about 912 PSI. In some examples, the pressure is about 913 PSI. In some examples, the pressure is about 914 PSI. In some examples, the pressure is about 915 PSI. In some examples, the pressure is about 916 PSI. In some examples, the pressure is about 917 PSI. In some examples, the pressure is about 918 PSI. In some examples, the pressure is about 919 PSI. In some examples, the pressure is about 920 PSI. In some examples, the pressure is about 921 PSI. In some examples, the pressure is about 927 PSI. In some examples, the pressure is about 923 PSI. In some examples, the pressure is about 924 PSI. In some examples, the pressure is about 925 PSI. In some examples, the pressure is about 926 PSI. In some examples, the pressure is about 927 PSI. In some examples, the pressure is about 928 PSI. In some examples, the pressure is about 929 PSI. In some examples, the pressure is about 930 PSI. In some examples, the pressure is about 931 PSI. In some examples, the pressure is about 932 PSI. In some examples, the pressure is about 933 PSI. In some examples, the pressure is about 934 PSI. In some examples, the pressure is about 935 PSI. In some examples, the pressure is about 936 PSI. In some examples, the pressure is about 938 PSI. In some examples, the pressure is about 938 PSI. In some examples, the pressure is about 939 PSI. In some examples, the pressure is about 940 PSI. In some examples, the pressure is about 941 PSI. In some examples, the pressure is about 942 PSI. In some examples, the pressure is about 943 PSI. In some examples, the pressure is about 944 PSI. In some examples, the pressure is about 945 PSI. In some examples, the pressure is about 946 PSI. In some examples, the pressure is about 948 PSI. In some examples, the pressure is about 948 PSI. In some examples, the pressure is about 949 PSI. In some examples, the pressure is about 950 PSI. In some examples, the pressure is about 951 PSI. In some examples, the pressure is about 952 PSI. In some examples, the pressure is about 953 PSI. In some examples, the pressure is about 954 PSI. In some examples, the pressure is about 955 PSI. In some examples, the pressure is about 956 PSI. In some examples, the pressure is about 957 PSI. In some examples, the pressure is about 958 PSI. In some examples, the pressure is about 959 PSI. In some examples, the pressure is about 960 PSI. In some examples, the pressure is about 961 PSI. In some examples, the pressure is about 962 PSI. In some examples, the pressure is about 963 PSI. In some examples, the pressure is about 964 PSI. In some examples, the pressure is about 965 PSI. In some examples, the pressure is about 966 PSI. In some examples, the pressure is about 967 PSI. In some examples, the pressure is about 968 PSI. In some examples, the pressure is about 969 PSI. In some examples, the pressure is about 970 PSI. In some examples, the pressure is about 971 PSI. In some examples, the pressure is about 972 PSI. In some examples, the pressure is about 973 PSI. In some examples, the pressure is about 974 PSI. In some examples, the pressure is about 975 PSI. In some examples, the pressure is about 976 PSI. In some examples, the pressure is about 977 PSI. In some examples, the pressure is about 978 PSI. In some examples, the pressure is about 979 PSI. In some examples, the pressure is about 980 PSI. In some examples, the pressure is about 981 PSI. In some examples, the pressure is about 982 PSI. In some examples, the pressure is about 983 PSI. In some examples, the pressure is about 984 PSI. In some examples, the pressure is about 985 PSI. In some examples, the pressure is about 986 PSI. In some examples, the pressure is about 987 PSI. In some examples, the pressure is about 988 PSI. In some examples, the pressure is about 989 PSI. In some examples, the pressure is about 990 PSI. In some examples, the pressure is about 991 PSI. In some examples, the pressure is about 992 PSI. In some examples, the pressure is about 993 PSI. In some examples, the pressure is about 994 PSI. In some examples, the pressure is about 995 PSI. In some examples, the pressure is about 996 PSI. In some examples, the pressure is about 997 PSI. In some examples, the pressure is about 998 PSI. In some examples, the pressure is about 999 PSI.

In some examples, the isotropic pressure is about 1000 PSI. In some examples, the pressure is about 1100 PSI. In some examples, the pressure is about 1200 PSI. In some examples, the pressure is about 1300 PSI. In some examples, the pressure is about 1400 PSI. In some examples, the pressure is about 1500 PSI. In some examples, the pressure is about 1600 PSI. In some examples, the pressure is about 1700 PSI. In some examples, the pressure is about 1800 PSI. In some examples, the pressure is about 1900 PSI.

In some examples, the isotropic pressure is about 2000 PSI. In some examples, the pressure is about 2100 PSI. In some examples, the pressure is about 2200 PSI. In some examples, the pressure is about 2300 PSI. In some examples, the pressure is about 2400 PSI. In some examples, the pressure is about 2500 PSI. In some examples, the pressure is about 2600 PSI. In some examples, the pressure is about 2700 PSI. In some examples, the pressure is about 2800 PSI. In some examples, the pressure is about 2900 PSI.

In some examples, the isotropic pressure is about 3000 PSI. In some examples, the pressure is about 3100 PSI. In some examples, the pressure is about 3200 PSI. In some examples, the pressure is about 3300 PSI. In some examples, the pressure is about 3400 PSI. In some examples, the pressure is about 3500 PSI. In some examples, the pressure is about 3600 PSI. In some examples, the pressure is about 3700 PSI. In some examples, the pressure is about 3800 PSI. In some examples, the pressure is about 3900 PSI.

In some examples, the isotropic pressure is about 4000 PSI. In some examples, the pressure is about 4100 PSI. In some examples, the pressure is about 4200 PSI. In some examples, the pressure is about 4300 PSI. In some examples, the pressure is about 4400 PSI. In some examples, the pressure is about 4500 PSI. In some examples, the pressure is about 4600 PSI. In some examples, the pressure is about 4700 PSI. In some examples, the pressure is about 4800 PSI. In some examples, the pressure is about 4900 PSI.

In some examples, the isotropic pressure is about 5000 PSI.

In some examples set forth herein, the electrochemical cell maintains a hydrostatic pressure. In some examples, the hydrostatic pressure is between 1-5000 PSI.

In some examples set forth herein, the hydrostatic pressure is between 1-5000 pounds per square inch (PSI).). Herein, hydrostatic pressure is measured as the compressive force on a load cell and divided by the area of contact, relative to atmosphere (i.e. gauge pressure). In some examples, the pressure is about 1 PSI. In some examples, the pressure is about 2 PSI. In some examples, the pressure is about 3 PSI. In some examples, the pressure is about 4 PSI. In some examples, the pressure is about 5 PSI. In some examples, the pressure is about 6 PSI. In some examples, the pressure is about 7 PSI. In some examples, the pressure is about 8 PSI. In some examples, the pressure is about 9 PSI. In some examples, the pressure is about 10 PSI. In some examples, the pressure is about 11 PSI. In some examples, the pressure is about 12 PSI. In some examples, the pressure is about 13 PSI. In some examples, the pressure is about 14 PSI. In some examples, the pressure is about 15 PSI. In some examples, the pressure is about 16 PSI. In some examples, the pressure is about 17 PSI. In some examples, the pressure is about 18 PSI. In some examples, the pressure is about 19 PSI. In some examples, the pressure is about 20 PSI. In some examples, the pressure is about 21 PSI. In some examples, the pressure is about 22 PSI. In some examples, the pressure is about 23 PSI. In some examples, the pressure is about 24 PSI. In some examples, the pressure is about 25 PSI. In some examples, the pressure is about 26 PSI. In some examples, the pressure is about 27 PSI. In some examples, the pressure is about 28 PSI. In some examples, the pressure is about 29 PSI. In some examples, the pressure is about 30 PSI. In some examples, the pressure is about 31 PSI. In some examples, the pressure is about 32 PSI. In some examples, the pressure is about 33 PSI. In some examples, the pressure is about 34 PSI. In some examples, the pressure is about 35 PSI. In some examples, the pressure is about 36 PSI. In some examples, the pressure is about 37 PSI. In some examples, the pressure is about 38 PSI. In some examples, the pressure is about 39 PSI. In some examples, the pressure is about 40 PSI. In some examples, the pressure is about 41 PSI. In some examples, the pressure is about 42 PSI. In some examples, the pressure is about 43 PSI. In some examples, the pressure is about 44 PSI. In some examples, the pressure is about 45 PSI. In some examples, the pressure is about 46 PSI. In some examples, the pressure is about 47 PSI. In some examples, the pressure is about 48 PSI. In some examples, the pressure is about 49 PSI. In some examples, the pressure is about 50 PSI. In some examples, the pressure is about 51 PSI. In some examples, the pressure is about 52 PSI. In some examples, the pressure is about 53 PSI. In some examples, the pressure is about 54 PSI. In some examples, the pressure is about 55 PSI. In some examples, the pressure is about 56 PSI. In some examples, the pressure is about 57 PSI. In some examples, the pressure is about 58 PSI. In some examples, the pressure is about 19 PSI. In some examples, the pressure is about 60 PSI. In some examples, the pressure is about 61 PSI. In some examples, the pressure is about 62 PSI. In some examples, the pressure is about 63 PSI. In some examples, the pressure is about 64 PSI. In some examples, the pressure is about 65 PSI. In some examples, the pressure is about 66 PSI. In some examples, the pressure is about 67 PSI. In some examples, the pressure is about 68 PSI. In some examples, the pressure is about 69 PSI. In some examples, the pressure is about 70 PSI. In some examples, the pressure is about 71 PSI. In some examples, the pressure is about 72 PSI. In some examples, the pressure is about 73 PSI. In some examples, the pressure is about 74 PSI. In some examples, the pressure is about 75 PSI. In some examples, the pressure is about 76 PSI. In some examples, the pressure is about 77 PSI. In some examples, the pressure is about 78 PSI. In some examples, the pressure is about 79 PSI. In some examples, the pressure is about 80 PSI. In some examples, the pressure is about 88 PSI. In some examples, the pressure is about 82 PSI. In some examples, the pressure is about 83 PSI. In some examples, the pressure is about 84 PSI. In some examples, the pressure is about 85 PSI. In some examples, the pressure is about 86 PSI. In some examples, the pressure is about 87 PSI. In some examples, the pressure is about 88 PSI. In some examples, the pressure is about 89 PSI. In some examples, the pressure is about 90 PSI. In some examples, the pressure is about 99 PSI. In some examples, the pressure is about 92 PSI. In some examples, the pressure is about 93 PSI. In some examples, the pressure is about 94 PSI. In some examples, the pressure is about 95 PSI. In some examples, the pressure is about 96 PSI. In some examples, the pressure is about 97 PSI. In some examples, the pressure is about 98 PSI. In some examples, the pressure is about 99 PSI. In some examples, the pressure is about 100 PSI.

In some examples, the hydrostatic pressure is about 101 PSI. In some examples, the pressure is about 102 PSI. In some examples, the pressure is about 103 PSI. In some examples, the pressure is about 104 PSI. In some examples, the pressure is about 105 PSI. In some examples, the pressure is about 106 PSI. In some examples, the pressure is about 107 PSI. In some examples, the pressure is about 108 PSI. In some examples, the pressure is about 109 PSI. In some examples, the pressure is about 110 PSI. In some examples, the pressure is about 111 PSI. In some examples, the pressure is about 112 PSI. In some examples, the pressure is about 113 PSI. In some examples, the pressure is about 114 PSI. In some examples, the pressure is about 115 PSI. In some examples, the pressure is about 116 PSI. In some examples, the pressure is about 117 PSI. In some examples, the pressure is about 118 PSI. In some examples, the pressure is about 119 PSI. In some examples, the pressure is about 120 PSI. In some examples, the pressure is about 121 PSI. In some examples, the pressure is about 1212 PSI. In some examples, the pressure is about 123 PSI. In some examples, the pressure is about 124 PSI. In some examples, the pressure is about 125 PSI. In some examples, the pressure is about 126 PSI. In some examples, the pressure is about 127 PSI. In some examples, the pressure is about 128 PSI. In some examples, the pressure is about 129 PSI. In some examples, the pressure is about 130 PSI. In some examples, the pressure is about 131 PSI. In some examples, the pressure is about 132 PSI. In some examples, the pressure is about 1313 PSI. In some examples, the pressure is about 134 PSI. In some examples, the pressure is about 135 PSI. In some examples, the pressure is about 136 PSI. In some examples, the pressure is about 137 PSI. In some examples, the pressure is about 138 PSI. In some examples, the pressure is about 139 PSI. In some examples, the pressure is about 140 PSI. In some examples, the pressure is about 141 PSI. In some examples, the pressure is about 142 PSI. In some examples, the pressure is about 143 PSI. In some examples, the pressure is about 144 PSI. In some examples, the pressure is about 145 PSI. In some examples, the pressure is about 146 PSI. In some examples, the pressure is about 147 PSI. In some examples, the pressure is about 148 PSI. In some examples, the pressure is about 149 PSI. In some examples, the pressure is about 150 PSI. In some examples, the pressure is about 151 PSI. In some examples, the pressure is about 152 PSI. In some examples, the pressure is about 153 PSI. In some examples, the pressure is about 154 PSI. In some examples, the pressure is about 155 PSI. In some examples, the pressure is about 156 PSI. In some examples, the pressure is about 157 PSI. In some examples, the pressure is about 158 PSI. In some examples, the pressure is about 159 PSI. In some examples, the pressure is about 160 PSI. In some examples, the pressure is about 161 PSI. In some examples, the pressure is about 162 PSI. In some examples, the pressure is about 163 PSI. In some examples, the pressure is about 164 PSI. In some examples, the pressure is about 165 PSI. In some examples, the pressure is about 166 PSI. In some examples, the pressure is about 167 PSI. In some examples, the pressure is about 168 PSI. In some examples, the pressure is about 169 PSI. In some examples, the pressure is about 170 PSI. In some examples, the pressure is about 171 PSI. In some examples, the pressure is about 172 PSI. In some examples, the pressure is about 173 PSI. In some examples, the pressure is about 174 PSI. In some examples, the pressure is about 175 PSI. In some examples, the pressure is about 176 PSI. In some examples, the pressure is about 177 PSI. In some examples, the pressure is about 178 PSI. In some examples, the pressure is about 179 PSI. In some examples, the pressure is about 180 PSI. In some examples, the pressure is about 181 PSI. In some examples, the pressure is about 182 PSI. In some examples, the pressure is about 183 PSI. In some examples, the pressure is about 184 PSI. In some examples, the pressure is about 185 PSI. In some examples, the pressure is about 186 PSI. In some examples, the pressure is about 187 PSI. In some examples, the pressure is about 188 PSI. In some examples, the pressure is about 189 PSI. In some examples, the pressure is about 190 PSI. In some examples, the pressure is about 191 PSI. In some examples, the pressure is about 192 PSI. In some examples, the pressure is about 193 PSI. In some examples, the pressure is about 194 PSI. In some examples, the pressure is about 195 PSI. In some examples, the pressure is about 196 PSI. In some examples, the pressure is about 197 PSI. In some examples, the pressure is about 198 PSI. In some examples, the pressure is about 199 PSI. In some examples, the pressure is about 200 PSI.

In some examples, the hydrostatic pressure is about 201 PSI. In some examples, the pressure is about 202 PSI. In some examples, the pressure is about 203 PSI. In some examples, the pressure is about 204 PSI. In some examples, the pressure is about 205 PSI. In some examples, the pressure is about 206 PSI. In some examples, the pressure is about 207 PSI. In some examples, the pressure is about 208 PSI. In some examples, the pressure is about 209 PSI. In some examples, the pressure is about 210 PSI. In some examples, the pressure is about 211 PSI. In some examples, the pressure is about 212 PSI. In some examples, the pressure is about 213 PSI. In some examples, the pressure is about 214 PSI. In some examples, the pressure is about 215 PSI. In some examples, the pressure is about 216 PSI. In some examples, the pressure is about 217 PSI. In some examples, the pressure is about 218 PSI. In some examples, the pressure is about 219 PSI. In some examples, the pressure is about 220 PSI. In some examples, the pressure is about 221 PSI. In some examples, the pressure is about 222 PSI. In some examples, the pressure is about 223 PSI. In some examples, the pressure is about 224 PSI. In some examples, the pressure is about 225 PSI. In some examples, the pressure is about 226 PSI. In some examples, the pressure is about 227 PSI. In some examples, the pressure is about 228 PSI. In some examples, the pressure is about 229 PSI. In some examples, the pressure is about 230 PSI. In some examples, the pressure is about 231 PSI. In some examples, the pressure is about 232 PSI. In some examples, the pressure is about 233 PSI. In some examples, the pressure is about 234 PSI. In some examples, the pressure is about 235 PSI. In some examples, the pressure is about 236 PSI. In some examples, the pressure is about 237 PSI. In some examples, the pressure is about 238 PSI. In some examples, the pressure is about 239 PSI. In some examples, the pressure is about 240 PSI. In some examples, the pressure is about 241 PSI. In some examples, the pressure is about 242 PSI. In some examples, the pressure is about 243 PSI. In some examples, the pressure is about 244 PSI. In some examples, the pressure is about 245 PSI. In some examples, the pressure is about 246 PSI. In some examples, the pressure is about 247 PSI. In some examples, the pressure is about 248 PSI. In some examples, the pressure is about 249 PSI. In some examples, the pressure is about 250 PSI. In some examples, the pressure is about 251 PSI. In some examples, the pressure is about 252 PSI. In some examples, the pressure is about 253 PSI. In some examples, the pressure is about 254 PSI. In some examples, the pressure is about 255 PSI. In some examples, the pressure is about 256 PSI. In some examples, the pressure is about 257 PSI. In some examples, the pressure is about 258 PSI. In some examples, the pressure is about 259 PSI. In some examples, the pressure is about 260 PSI. In some examples, the pressure is about 261 PSI. In some examples, the pressure is about 262 PSI. In some examples, the pressure is about 263 PSI. In some examples, the pressure is about 264 PSI. In some examples, the pressure is about 265 PSI. In some examples, the pressure is about 266 PSI. In some examples, the pressure is about 267 PSI. In some examples, the pressure is about 268 PSI. In some examples, the pressure is about 269 PSI. In some examples, the pressure is about 270 PSI. In some examples, the pressure is about 271 PSI. In some examples, the pressure is about 272 PSI. In some examples, the pressure is about 273 PSI. In some examples, the pressure is about 274 PSI. In some examples, the pressure is about 275 PSI. In some examples, the pressure is about 276 PSI. In some examples, the pressure is about 277 PSI. In some examples, the pressure is about 278 PSI. In some examples, the pressure is about 279 PSI. In some examples, the pressure is about 280 PSI. In some examples, the pressure is about 281 PSI. In some examples, the pressure is about 282 PSI. In some examples, the pressure is about 283 PSI. In some examples, the pressure is about 284 PSI. In some examples, the pressure is about 285 PSI. In some examples, the pressure is about 286 PSI. In some examples, the pressure is about 287 PSI. In some examples, the pressure is about 288 PSI. In some examples, the pressure is about 289 PSI. In some examples, the pressure is about 290 PSI. In some examples, the pressure is about 291 PSI. In some examples, the pressure is about 292 PSI. In some examples, the pressure is about 293 PSI. In some examples, the pressure is about 294 PSI. In some examples, the pressure is about 295 PSI. In some examples, the pressure is about 296 PSI. In some examples, the pressure is about 297 PSI. In some examples, the pressure is about 298 PSI. In some examples, the pressure is about 299 PSI. In some examples, the pressure is about 300 PSI.

In some examples, the hydrostatic pressure is about 301 PSI. In some examples, the pressure is about 302 PSI. In some examples, the pressure is about 303 PSI. In some examples, the pressure is about 304 PSI. In some examples, the pressure is about 305 PSI. In some examples, the pressure is about 306 PSI. In some examples, the pressure is about 307 PSI. In some examples, the pressure is about 308 PSI. In some examples, the pressure is about 309 PSI. In some examples, the pressure is about 310 PSI. In some examples, the pressure is about 311 PSI. In some examples, the pressure is about 312 PSI. In some examples, the pressure is about 313 PSI. In some examples, the pressure is about 314 PSI. In some examples, the pressure is about 315 PSI. In some examples, the pressure is about 316 PSI. In some examples, the pressure is about 317 PSI. In some examples, the pressure is about 318 PSI. In some examples, the pressure is about 319 PSI. In some examples, the pressure is about 320 PSI. In some examples, the pressure is about 321 PSI. In some examples, the pressure is about 322 PSI. In some examples, the pressure is about 323 PSI. In some examples, the pressure is about 324 PSI. In some examples, the pressure is about 325 PSI. In some examples, the pressure is about 326 PSI. In some examples, the pressure is about 327 PSI. In some examples, the pressure is about 328 PSI. In some examples, the pressure is about 329 PSI. In some examples, the pressure is about 330 PSI. In some examples, the pressure is about 331 PSI. In some examples, the pressure is about 332 PSI. In some examples, the pressure is about 333 PSI. In some examples, the pressure is about 334 PSI. In some examples, the pressure is about 335 PSI. In some examples, the pressure is about 336 PSI. In some examples, the pressure is about 337 PSI. In some examples, the pressure is about 338 PSI. In some examples, the pressure is about 339 PSI. In some examples, the pressure is about 340 PSI. In some examples, the pressure is about 341 PSI. In some examples, the pressure is about 342 PSI. In some examples, the pressure is about 343 PSI. In some examples, the pressure is about 344 PSI. In some examples, the pressure is about 345 PSI. In some examples, the pressure is about 346 PSI. In some examples, the pressure is about 347 PSI. In some examples, the pressure is about 348 PSI. In some examples, the pressure is about 349 PSI. In some examples, the pressure is about 350 PSI. In some examples, the pressure is about 351 PSI. In some examples, the pressure is about 352 PSI. In some examples, the pressure is about 353 PSI. In some examples, the pressure is about 354 PSI. In some examples, the pressure is about 355 PSI. In some examples, the pressure is about 356 PSI. In some examples, the pressure is about 357 PSI. In some examples, the pressure is about 358 PSI. In some examples, the pressure is about 359 PSI. In some examples, the pressure is about 360 PSI. In some examples, the pressure is about 361 PSI. In some examples, the pressure is about 362 PSI. In some examples, the pressure is about 363 PSI. In some examples, the pressure is about 364 PSI. In some examples, the pressure is about 365 PSI. In some examples, the pressure is about 366 PSI. In some examples, the pressure is about 367 PSI. In some examples, the pressure is about 368 PSI. In some examples, the pressure is about 369 PSI. In some examples, the pressure is about 370 PSI. In some examples, the pressure is about 371 PSI. In some examples, the pressure is about 373 PSI. In some examples, the pressure is about 373 PSI. In some examples, the pressure is about 374 PSI. In some examples, the pressure is about 375 PSI. In some examples, the pressure is about 376 PSI. In some examples, the pressure is about 377 PSI. In some examples, the pressure is about 378 PSI. In some examples, the pressure is about 379 PSI. In some examples, the pressure is about 380 PSI. In some examples, the pressure is about 381 PSI. In some examples, the pressure is about 382 PSI. In some examples, the pressure is about 383 PSI. In some examples, the pressure is about 384 PSI. In some examples, the pressure is about 385 PSI. In some examples, the pressure is about 386 PSI. In some examples, the pressure is about 387 PSI. In some examples, the pressure is about 388 PSI. In some examples, the pressure is about 389 PSI. In some examples, the pressure is about 390 PSI. In some examples, the pressure is about 391 PSI. In some examples, the pressure is about 392 PSI. In some examples, the pressure is about 393 PSI. In some examples, the pressure is about 394 PSI. In some examples, the pressure is about 395 PSI. In some examples, the pressure is about 396 PSI. In some examples, the pressure is about 397 PSI. In some examples, the pressure is about 398 PSI. In some examples, the pressure is about 399 PSI. In some examples, the pressure is about 400 PSI.

In some examples, the hydrostatic pressure is about 401 PSI. In some examples, the pressure is about 402 PSI. In some examples, the pressure is about 403 PSI. In some examples, the pressure is about 404 PSI. In some examples, the pressure is about 405 PSI. In some examples, the pressure is about 406 PSI. In some examples, the pressure is about 407 PSI. In some examples, the pressure is about 408 PSI. In some examples, the pressure is about 409 PSI. In some examples, the pressure is about 410 PSI. In some examples, the pressure is about 411 PSI. In some examples, the pressure is about 412 PSI. In some examples, the pressure is about 413 PSI. In some examples, the pressure is about 414 PSI. In some examples, the pressure is about 415 PSI. In some examples, the pressure is about 416 PSI. In some examples, the pressure is about 417 PSI. In some examples, the pressure is about 418 PSI. In some examples, the pressure is about 419 PSI. In some examples, the pressure is about 420 PSI. In some examples, the pressure is about 421 PSI. In some examples, the pressure is about 422 PSI. In some examples, the pressure is about 423 PSI. In some examples, the pressure is about 424 PSI. In some examples, the pressure is about 425 PSI. In some examples, the pressure is about 426 PSI. In some examples, the pressure is about 427 PSI. In some examples, the pressure is about 428 PSI. In some examples, the pressure is about 429 PSI. In some examples, the pressure is about 430 PSI. In some examples, the pressure is about 431 PSI. In some examples, the pressure is about 432 PSI. In some examples, the pressure is about 433 PSI. In some examples, the pressure is about 434 PSI. In some examples, the pressure is about 435 PSI. In some examples, the pressure is about 436 PSI. In some examples, the pressure is about 437 PSI. In some examples, the pressure is about 438 PSI. In some examples, the pressure is about 439 PSI. In some examples, the pressure is about 440 PSI. In some examples, the pressure is about 441 PSI. In some examples, the pressure is about 442 PSI. In some examples, the pressure is about 443 PSI. In some examples, the pressure is about 444 PSI. In some examples, the pressure is about 445 PSI. In some examples, the pressure is about 446 PSI. In some examples, the pressure is about 447 PSI. In some examples, the pressure is about 448 PSI. In some examples, the pressure is about 449 PSI. In some examples, the pressure is about 450 PSI. In some examples, the pressure is about 451 PSI. In some examples, the pressure is about 452 PSI. In some examples, the pressure is about 53 PSI. In some examples, the pressure is about 454 PSI. In some examples, the pressure is about 455 PSI. In some examples, the pressure is about 456 PSI. In some examples, the pressure is about 457 PSI. In some examples, the pressure is about 458 PSI. In some examples, the pressure is about 459 PSI. In some examples, the pressure is about 460 PSI. In some examples, the pressure is about 461 PSI. In some examples, the pressure is about 462 PSI. In some examples, the pressure is about 463 PSI. In some examples, the pressure is about 464 PSI. In some examples, the pressure is about 465 PSI. In some examples, the pressure is about 466 PSI. In some examples, the pressure is about 467 PSI. In some examples, the pressure is about 468 PSI. In some examples, the pressure is about 469 PSI. In some examples, the pressure is about 470 PSI. In some examples, the pressure is about 471 PSI. In some examples, the pressure is about 472 PSI. In some examples, the pressure is about 473 PSI. In some examples, the pressure is about 474 PSI. In some examples, the pressure is about 475 PSI. In some examples, the pressure is about 476 PSI. In some examples, the pressure is about 477 PSI. In some examples, the pressure is about 478 PSI. In some examples, the pressure is about 479 PSI. In some examples, the pressure is about 480 PSI. In some examples, the pressure is about 481 PSI. In some examples, the pressure is about 482 PSI. In some examples, the pressure is about 483 PSI. In some examples, the pressure is about 484 PSI. In some examples, the pressure is about 485 PSI. In some examples, the pressure is about 486 PSI. In some examples, the pressure is about 487 PSI. In some examples, the pressure is about 488 PSI. In some examples, the pressure is about 489 PSI. In some examples, the pressure is about 490 PSI. In some examples, the pressure is about 491 PSI. In some examples, the pressure is about 492 PSI. In some examples, the pressure is about 493 PSI. In some examples, the pressure is about 494 PSI. In some examples, the pressure is about 495 PSI. In some examples, the pressure is about 496 PSI. In some examples, the pressure is about 497 PSI. In some examples, the pressure is about 498 PSI. In some examples, the pressure is about 499 PSI. In some examples, the pressure is about 500 PSI.

In some examples, the hydrostatic pressure is about 501 PSI. In some examples, the pressure is about 502 PSI. In some examples, the pressure is about 503 PSI. In some examples, the pressure is about 504 PSI. In some examples, the pressure is about 505 PSI. In some examples, the pressure is about 506 PSI. In some examples, the pressure is about 507 PSI. In some examples, the pressure is about 508 PSI. In some examples, the pressure is about 509 PSI. In some examples, the pressure is about 510 PSI. In some examples, the pressure is about 511 PSI. In some examples, the pressure is about 512 PSI. In some examples, the pressure is about 513 PSI. In some examples, the pressure is about 514 PSI. In some examples, the pressure is about 515 PSI. In some examples, the pressure is about 516 PSI. In some examples, the pressure is about 517 PSI. In some examples, the pressure is about 518 PSI. In some examples, the pressure is about 519 PSI. In some examples, the pressure is about 520 PSI. In some examples, the pressure is about 521 PSI. In some examples, the pressure is about 522 PSI. In some examples, the pressure is about 523 PSI. In some examples, the pressure is about 524 PSI. In some examples, the pressure is about 525 PSI. In some examples, the pressure is about 526 PSI. In some examples, the pressure is about 527 PSI. In some examples, the pressure is about 528 PSI. In some examples, the pressure is about 529 PSI. In some examples, the pressure is about 530 PSI. In some examples, the pressure is about 531 PSI. In some examples, the pressure is about 532 PSI. In some examples, the pressure is about 533 PSI. In some examples, the pressure is about 534 PSI. In some examples, the pressure is about 535 PSI. In some examples, the pressure is about 536 PSI. In some examples, the pressure is about 537 PSI. In some examples, the pressure is about 538 PSI. In some examples, the pressure is about 539 PSI. In some examples, the pressure is about 540 PSI. In some examples, the pressure is about 541 PSI. In some examples, the pressure is about 542 PSI. In some examples, the pressure is about 543 PSI. In some examples, the pressure is about 544 PSI. In some examples, the pressure is about 545 PSI. In some examples, the pressure is about 546 PSI. In some examples, the pressure is about 547 PSI. In some examples, the pressure is about 548 PSI. In some examples, the pressure is about 549 PSI. In some examples, the pressure is about 550 PSI. In some examples, the pressure is about 551 PSI. In some examples, the pressure is about 552 PSI. In some examples, the pressure is about 553 PSI. In some examples, the pressure is about 554 PSI. In some examples, the pressure is about 555 PSI. In some examples, the pressure is about 556 PSI. In some examples, the pressure is about 557 PSI. In some examples, the pressure is about 558 PSI. In some examples, the pressure is about 559 PSI. In some examples, the pressure is about 560 PSI. In some examples, the pressure is about 561 PSI. In some examples, the pressure is about 562 PSI. In some examples, the pressure is about 563 PSI. In some examples, the pressure is about 564 PSI. In some examples, the pressure is about 565 PSI. In some examples, the pressure is about 566 PSI. In some examples, the pressure is about 567 PSI. In some examples, the pressure is about 568 PSI. In some examples, the pressure is about 569 PSI. In some examples, the pressure is about 570 PSI. In some examples, the pressure is about 571 PSI. In some examples, the pressure is about 572 PSI. In some examples, the pressure is about 573 PSI. In some examples, the pressure is about 574 PSI. In some examples, the pressure is about 575 PSI. In some examples, the pressure is about 576 PSI. In some examples, the pressure is about 577 PSI. In some examples, the pressure is about 578 PSI. In some examples, the pressure is about 579 PSI. In some examples, the pressure is about 580 PSI. In some examples, the pressure is about 581 PSI. In some examples, the pressure is about 582 PSI. In some examples, the pressure is about 583 PSI. In some examples, the pressure is about 584 PSI. In some examples, the pressure is about 585 PSI. In some examples, the pressure is about 586 PSI. In some examples, the pressure is about 587 PSI. In some examples, the pressure is about 588 PSI. In some examples, the pressure is about 589 PSI. In some examples, the pressure is about 590 PSI. In some examples, the pressure is about 591 PSI. In some examples, the pressure is about 592 PSI. In some examples, the pressure is about 593 PSI. In some examples, the pressure is about 594 PSI. In some examples, the pressure is about 595 PSI. In some examples, the pressure is about 596 PSI. In some examples, the pressure is about 597 PSI. In some examples, the pressure is about 598 PSI. In some examples, the pressure is about 599 PSI. In some examples, the pressure is about 600 PSI.

In some examples, the hydrostatic pressure is about 601 PSI. In some examples, the pressure is about 602 PSI. In some examples, the pressure is about 603 PSI. In some examples, the pressure is about 604 PSI. In some examples, the pressure is about 605 PSI. In some examples, the pressure is about 606 PSI. In some examples, the pressure is about 607 PSI. In some examples, the pressure is about 608 PSI. In some examples, the pressure is about 609 PSI. In some examples, the pressure is about 610 PSI. In some examples, the pressure is about 611 PSI. In some examples, the pressure is about 612 PSI. In some examples, the pressure is about 613 PSI. In some examples, the pressure is about 614 PSI. In some examples, the pressure is about 615 PSI. In some examples, the pressure is about 616 PSI. In some examples, the pressure is about 617 PSI. In some examples, the pressure is about 618 PSI. In some examples, the pressure is about 619 PSI. In some examples, the pressure is about 620 PSI. In some examples, the pressure is about 621 PSI. In some examples, the pressure is about 622 PSI. In some examples, the pressure is about 663 PSI. In some examples, the pressure is about 624 PSI. In some examples, the pressure is about 625 PSI. In some examples, the pressure is about 626 PSI. In some examples, the pressure is about 627 PSI. In some examples, the pressure is about 628 PSI. In some examples, the pressure is about 629 PSI. In some examples, the pressure is about 630 PSI. In some examples, the pressure is about 631 PSI. In some examples, the pressure is about 632 PSI. In some examples, the pressure is about 633 PSI. In some examples, the pressure is about 634 PSI. In some examples, the pressure is about 635 PSI. In some examples, the pressure is about 636 PSI. In some examples, the pressure is about 637 PSI. In some examples, the pressure is about 638 PSI. In some examples, the pressure is about 639 PSI. In some examples, the pressure is about 640 PSI. In some examples, the pressure is about 641 PSI. In some examples, the pressure is about 642 PSI. In some examples, the pressure is about 643 PSI. In some examples, the pressure is about 644 PSI. In some examples, the pressure is about 645 PSI. In some examples, the pressure is about 646 PSI. In some examples, the pressure is about 647 PSI. In some examples, the pressure is about 648 PSI. In some examples, the pressure is about 649 PSI. In some examples, the pressure is about 650 PSI. In some examples, the pressure is about 651 PSI. In some examples, the pressure is about 652 PSI. In some examples, the pressure is about 653 PSI. In some examples, the pressure is about 654 PSI. In some examples, the pressure is about 655 PSI. In some examples, the pressure is about 656 PSI. In some examples, the pressure is about 657 PSI. In some examples, the pressure is about 658 PSI. In some examples, the pressure is about 659 PSI. In some examples, the pressure is about 660 PSI. In some examples, the pressure is about 661 PSI. In some examples, the pressure is about 662 PSI. In some examples, the pressure is about 663 PSI. In some examples, the pressure is about 664 PSI. In some examples, the pressure is about 665 PSI. In some examples, the pressure is about 666 PSI. In some examples, the pressure is about 667 PSI. In some examples, the pressure is about 668 PSI. In some examples, the pressure is about 669 PSI. In some examples, the pressure is about 670 PSI. In some examples, the pressure is about 671 PSI. In some examples, the pressure is about 672 PSI. In some examples, the pressure is about 673 PSI. In some examples, the pressure is about 674 PSI. In some examples, the pressure is about 675 PSI. In some examples, the pressure is about 676 PSI. In some examples, the pressure is about 677 PSI. In some examples, the pressure is about 678 PSI. In some examples, the pressure is about 679 PSI. In some examples, the pressure is about 680 PSI. In some examples, the pressure is about 681 PSI. In some examples, the pressure is about 682 PSI. In some examples, the pressure is about 683 PSI. In some examples, the pressure is about 684 PSI. In some examples, the pressure is about 685 PSI. In some examples, the pressure is about 686 PSI. In some examples, the pressure is about 687 PSI. In some examples, the pressure is about 688 PSI. In some examples, the pressure is about 689 PSI. In some examples, the pressure is about 690 PSI. In some examples, the pressure is about 691 PSI. In some examples, the pressure is about 692 PSI. In some examples, the pressure is about 693 PSI. In some examples, the pressure is about 694 PSI. In some examples, the pressure is about 695 PSI. In some examples, the pressure is about 696 PSI. In some examples, the pressure is about 697 PSI. In some examples, the pressure is about 698 PSI. In some examples, the pressure is about 699 PSI. In some examples, the pressure is about 700 PSI.

In some examples, the hydrostatic pressure is about 701 PSI. In some examples, the pressure is about 702 PSI. In some examples, the pressure is about 703 PSI. In some examples, the pressure is about 704 PSI. In some examples, the pressure is about 705 PSI. In some examples, the pressure is about 706 PSI. In some examples, the pressure is about 707 PSI. In some examples, the pressure is about 708 PSI. In some examples, the pressure is about 709 PSI. In some examples, the pressure is about 710 PSI. In some examples, the pressure is about 711 PSI. In some examples, the pressure is about 712 PSI. In some examples, the pressure is about 713 PSI. In some examples, the pressure is about 714 PSI. In some examples, the pressure is about 715 PSI. In some examples, the pressure is about 716 PSI. In some examples, the pressure is about 717 PSI. In some examples, the pressure is about 718 PSI. In some examples, the pressure is about 719 PSI. In some examples, the pressure is about 720 PSI. In some examples, the pressure is about 721 PSI. In some examples, the pressure is about 727 PSI. In some examples, the pressure is about 723 PSI. In some examples, the pressure is about 724 PSI. In some examples, the pressure is about 725 PSI. In some examples, the pressure is about 726 PSI. In some examples, the pressure is about 727 PSI. In some examples, the pressure is about 728 PSI. In some examples, the pressure is about 729 PSI. In some examples, the pressure is about 730 PSI. In some examples, the pressure is about 731 PSI. In some examples, the pressure is about 732 PSI. In some examples, the pressure is about 733 PSI. In some examples, the pressure is about 734 PSI. In some examples, the pressure is about 735 PSI. In some examples, the pressure is about 736 PSI. In some examples, the pressure is about 737 PSI. In some examples, the pressure is about 738 PSI. In some examples, the pressure is about 739 PSI. In some examples, the pressure is about 740 PSI. In some examples, the pressure is about 741 PSI. In some examples, the pressure is about 742 PSI. In some examples, the pressure is about 743 PSI. In some examples, the pressure is about 744 PSI. In some examples, the pressure is about 745 PSI. In some examples, the pressure is about 746 PSI. In some examples, the pressure is about 747 PSI. In some examples, the pressure is about 748 PSI. In some examples, the pressure is about 749 PSI. In some examples, the pressure is about 750 PSI. In some examples, the pressure is about 751 PSI. In some examples, the pressure is about 752 PSI. In some examples, the pressure is about 753 PSI. In some examples, the pressure is about 754 PSI. In some examples, the pressure is about 755 PSI. In some examples, the pressure is about 756 PSI. In some examples, the pressure is about 757 PSI. In some examples, the pressure is about 758 PSI. In some examples, the pressure is about 759 PSI. In some examples, the pressure is about 760 PSI. In some examples, the pressure is about 761 PSI. In some examples, the pressure is about 762 PSI. In some examples, the pressure is about 763 PSI. In some examples, the pressure is about 764 PSI. In some examples, the pressure is about 765 PSI. In some examples, the pressure is about 766 PSI. In some examples, the pressure is about 767 PSI. In some examples, the pressure is about 768 PSI. In some examples, the pressure is about 769 PSI. In some examples, the pressure is about 770 PSI. In some examples, the pressure is about 771 PSI. In some examples, the pressure is about 772 PSI. In some examples, the pressure is about 773 PSI. In some examples, the pressure is about 774 PSI. In some examples, the pressure is about 775 PSI. In some examples, the pressure is about 776 PSI. In some examples, the pressure is about 777 PSI. In some examples, the pressure is about 778 PSI. In some examples, the pressure is about 779 PSI. In some examples, the pressure is about 780 PSI. In some examples, the pressure is about 781 PSI. In some examples, the pressure is about 782 PSI. In some examples, the pressure is about 783 PSI. In some examples, the pressure is about 784 PSI. In some examples, the pressure is about 785 PSI. In some examples, the pressure is about 786 PSI. In some examples, the pressure is about 787 PSI. In some examples, the pressure is about 788 PSI. In some examples, the pressure is about 789 PSI. In some examples, the pressure is about 790 PSI. In some examples, the pressure is about 791 PSI. In some examples, the pressure is about 792 PSI. In some examples, the pressure is about 793 PSI. In some examples, the pressure is about 794 PSI. In some examples, the pressure is about 795 PSI. In some examples, the pressure is about 796 PSI. In some examples, the pressure is about 797 PSI. In some examples, the pressure is about 798 PSI. In some examples, the pressure is about 799 PSI. In some examples, the pressure is about 800 PSI.

In some examples, the hydrostatic pressure is about 701 PSI. In some examples, the pressure is about 702 PSI. In some examples, the pressure is about 703 PSI. In some examples, the pressure is about 704 PSI. In some examples, the pressure is about 705 PSI. In some examples, the pressure is about 706 PSI. In some examples, the pressure is about 707 PSI. In some examples, the pressure is about 708 PSI. In some examples, the pressure is about 709 PSI. In some examples, the pressure is about 710 PSI. In some examples, the pressure is about 711 PSI. In some examples, the pressure is about 712 PSI. In some examples, the pressure is about 713 PSI. In some examples, the pressure is about 714 PSI. In some examples, the pressure is about 715 PSI. In some examples, the pressure is about 716 PSI. In some examples, the pressure is about 717 PSI. In some examples, the pressure is about 718 PSI. In some examples, the pressure is about 719 PSI. In some examples, the pressure is about 720 PSI. In some examples, the pressure is about 721 PSI. In some examples, the pressure is about 727 PSI. In some examples, the pressure is about 723 PSI. In some examples, the pressure is about 724 PSI. In some examples, the pressure is about 725 PSI. In some examples, the pressure is about 726 PSI. In some examples, the pressure is about 727 PSI. In some examples, the pressure is about 728 PSI. In some examples, the pressure is about 729 PSI. In some examples, the pressure is about 730 PSI. In some examples, the pressure is about 731 PSI. In some examples, the pressure is about 732 PSI. In some examples, the pressure is about 733 PSI. In some examples, the pressure is about 734 PSI. In some examples, the pressure is about 735 PSI. In some examples, the pressure is about 736 PSI. In some examples, the pressure is about 737 PSI. In some examples, the pressure is about 738 PSI. In some examples, the pressure is about 739 PSI. In some examples, the pressure is about 740 PSI. In some examples, the pressure is about 741 PSI. In some examples, the pressure is about 742 PSI. In some examples, the pressure is about 743 PSI. In some examples, the pressure is about 744 PSI. In some examples, the pressure is about 745 PSI. In some examples, the pressure is about 746 PSI. In some examples, the pressure is about 747 PSI. In some examples, the pressure is about 748 PSI. In some examples, the pressure is about 749 PSI. In some examples, the pressure is about 750 PSI. In some examples, the pressure is about 751 PSI. In some examples, the pressure is about 752 PSI. In some examples, the pressure is about 753 PSI. In some examples, the pressure is about 754 PSI. In some examples, the pressure is about 755 PSI. In some examples, the pressure is about 756 PSI. In some examples, the pressure is about 757 PSI. In some examples, the pressure is about 758 PSI. In some examples, the pressure is about 759 PSI. In some examples, the pressure is about 760 PSI. In some examples, the pressure is about 761 PSI. In some examples, the pressure is about 762 PSI. In some examples, the pressure is about 763 PSI. In some examples, the pressure is about 764 PSI. In some examples, the pressure is about 765 PSI. In some examples, the pressure is about 766 PSI. In some examples, the pressure is about 767 PSI. In some examples, the pressure is about 768 PSI. In some examples, the pressure is about 769 PSI. In some examples, the pressure is about 770 PSI. In some examples, the pressure is about 771 PSI. In some examples, the pressure is about 772 PSI. In some examples, the pressure is about 773 PSI. In some examples, the pressure is about 774 PSI. In some examples, the pressure is about 775 PSI. In some examples, the pressure is about 776 PSI. In some examples, the pressure is about 777 PSI. In some examples, the pressure is about 778 PSI. In some examples, the pressure is about 779 PSI. In some examples, the pressure is about 780 PSI. In some examples, the pressure is about 781 PSI. In some examples, the pressure is about 782 PSI. In some examples, the pressure is about 783 PSI. In some examples, the pressure is about 784 PSI. In some examples, the pressure is about 785 PSI. In some examples, the pressure is about 786 PSI. In some examples, the pressure is about 787 PSI. In some examples, the pressure is about 788 PSI. In some examples, the pressure is about 789 PSI. In some examples, the pressure is about 790 PSI. In some examples, the pressure is about 791 PSI. In some examples, the pressure is about 792 PSI. In some examples, the pressure is about 793 PSI. In some examples, the pressure is about 794 PSI. In some examples, the pressure is about 795 PSI. In some examples, the pressure is about 796 PSI. In some examples, the pressure is about 797 PSI. In some examples, the pressure is about 798 PSI. In some examples, the pressure is about 799 PSI. In some examples, the pressure is about 800 PSI.

In some examples, the hydrostatic pressure is about 801 PSI. In some examples, the pressure is about 802 PSI. In some examples, the pressure is about 803 PSI. In some examples, the pressure is about 804 PSI. In some examples, the pressure is about 805 PSI. In some examples, the pressure is about 806 PSI. In some examples, the pressure is about 807 PSI. In some examples, the pressure is about 808 PSI. In some examples, the pressure is about 809 PSI. In some examples, the pressure is about 810 PSI. In some examples, the pressure is about 811 PSI. In some examples, the pressure is about 812 PSI. In some examples, the pressure is about 813 PSI. In some examples, the pressure is about 814 PSI. In some examples, the pressure is about 815 PSI. In some examples, the pressure is about 816 PSI. In some examples, the pressure is about 817 PSI. In some examples, the pressure is about 818 PSI. In some examples, the pressure is about 819 PSI. In some examples, the pressure is about 820 PSI. In some examples, the pressure is about 821 PSI. In some examples, the pressure is about 827 PSI. In some examples, the pressure is about 823 PSI. In some examples, the pressure is about 824 PSI. In some examples, the pressure is about 825 PSI. In some examples, the pressure is about 826 PSI. In some examples, the pressure is about 827 PSI. In some examples, the pressure is about 828 PSI. In some examples, the pressure is about 829 PSI. In some examples, the pressure is about 830 PSI. In some examples, the pressure is about 831 PSI. In some examples, the pressure is about 832 PSI. In some examples, the pressure is about 833 PSI. In some examples, the pressure is about 834 PSI. In some examples, the pressure is about 835 PSI. In some examples, the pressure is about 836 PSI. In some examples, the pressure is about 838 PSI. In some examples, the pressure is about 838 PSI. In some examples, the pressure is about 839 PSI. In some examples, the pressure is about 840 PSI. In some examples, the pressure is about 841 PSI. In some examples, the pressure is about 842 PSI. In some examples, the pressure is about 843 PSI. In some examples, the pressure is about 844 PSI. In some examples, the pressure is about 845 PSI. In some examples, the pressure is about 846 PSI. In some examples, the pressure is about 848 PSI. In some examples, the pressure is about 848 PSI. In some examples, the pressure is about 849 PSI. In some examples, the pressure is about 850 PSI. In some examples, the pressure is about 851 PSI. In some examples, the pressure is about 852 PSI. In some examples, the pressure is about 853 PSI. In some examples, the pressure is about 854 PSI. In some examples, the pressure is about 855 PSI. In some examples, the pressure is about 856 PSI. In some examples, the pressure is about 857 PSI. In some examples, the pressure is about 858 PSI. In some examples, the pressure is about 859 PSI. In some examples, the pressure is about 860 PSI. In some examples, the pressure is about 861 PSI. In some examples, the pressure is about 862 PSI. In some examples, the pressure is about 863 PSI. In some examples, the pressure is about 864 PSI. In some examples, the pressure is about 865 PSI. In some examples, the pressure is about 866 PSI. In some examples, the pressure is about 867 PSI. In some examples, the pressure is about 868 PSI. In some examples, the pressure is about 869 PSI. In some examples, the pressure is about 870 PSI. In some examples, the pressure is about 871 PSI. In some examples, the pressure is about 872 PSI. In some examples, the pressure is about 873 PSI. In some examples, the pressure is about 874 PSI. In some examples, the pressure is about 875 PSI. In some examples, the pressure is about 876 PSI. In some examples, the pressure is about 877 PSI. In some examples, the pressure is about 878 PSI. In some examples, the pressure is about 879 PSI. In some examples, the pressure is about 880 PSI. In some examples, the pressure is about 881 PSI. In some examples, the pressure is about 882 PSI. In some examples, the pressure is about 883 PSI. In some examples, the pressure is about 884 PSI. In some examples, the pressure is about 885 PSI. In some examples, the pressure is about 886 PSI. In some examples, the pressure is about 887 PSI. In some examples, the pressure is about 888 PSI. In some examples, the pressure is about 889 PSI. In some examples, the pressure is about 890 PSI. In some examples, the pressure is about 891 PSI. In some examples, the pressure is about 892 PSI. In some examples, the pressure is about 893 PSI. In some examples, the pressure is about 894 PSI. In some examples, the pressure is about 895 PSI. In some examples, the pressure is about 896 PSI. In some examples, the pressure is about 897 PSI. In some examples, the pressure is about 898 PSI. In some examples, the pressure is about 899 PSI. In some examples, the pressure is about 900 PSI.

In some examples, the hydrostatic pressure is about 901 PSI. In some examples, the pressure is about 902 PSI. In some examples, the pressure is about 903 PSI. In some examples, the pressure is about 904 PSI. In some examples, the pressure is about 905 PSI. In some examples, the pressure is about 906 PSI. In some examples, the pressure is about 907 PSI. In some examples, the pressure is about 908 PSI. In some examples, the pressure is about 909 PSI. In some examples, the pressure is about 910 PSI. In some examples, the pressure is about 911 PSI. In some examples, the pressure is about 912 PSI. In some examples, the pressure is about 913 PSI. In some examples, the pressure is about 914 PSI. In some examples, the pressure is about 915 PSI. In some examples, the pressure is about 916 PSI. In some examples, the pressure is about 917 PSI. In some examples, the pressure is about 918 PSI. In some examples, the pressure is about 919 PSI. In some examples, the pressure is about 920 PSI. In some examples, the pressure is about 921 PSI. In some examples, the pressure is about 927 PSI. In some examples, the pressure is about 923 PSI. In some examples, the pressure is about 924 PSI. In some examples, the pressure is about 925 PSI. In some examples, the pressure is about 926 PSI. In some examples, the pressure is about 927 PSI. In some examples, the pressure is about 928 PSI. In some examples, the pressure is about 929 PSI. In some examples, the pressure is about 930 PSI. In some examples, the pressure is about 931 PSI. In some examples, the pressure is about 932 PSI. In some examples, the pressure is about 933 PSI. In some examples, the pressure is about 934 PSI. In some examples, the pressure is about 935 PSI. In some examples, the pressure is about 936 PSI. In some examples, the pressure is about 938 PSI. In some examples, the pressure is about 938 PSI. In some examples, the pressure is about 939 PSI. In some examples, the pressure is about 940 PSI. In some examples, the pressure is about 941 PSI. In some examples, the pressure is about 942 PSI. In some examples, the pressure is about 943 PSI. In some examples, the pressure is about 944 PSI. In some examples, the pressure is about 945 PSI. In some examples, the pressure is about 946 PSI. In some examples, the pressure is about 948 PSI. In some examples, the pressure is about 948 PSI. In some examples, the pressure is about 949 PSI. In some examples, the pressure is about 950 PSI. In some examples, the pressure is about 951 PSI. In some examples, the pressure is about 952 PSI. In some examples, the pressure is about 953 PSI. In some examples, the pressure is about 954 PSI. In some examples, the pressure is about 955 PSI. In some examples, the pressure is about 956 PSI. In some examples, the pressure is about 957 PSI. In some examples, the pressure is about 958 PSI. In some examples, the pressure is about 959 PSI. In some examples, the pressure is about 960 PSI. In some examples, the pressure is about 961 PSI. In some examples, the pressure is about 962 PSI. In some examples, the pressure is about 963 PSI. In some examples, the pressure is about 964 PSI. In some examples, the pressure is about 965 PSI. In some examples, the pressure is about 966 PSI. In some examples, the pressure is about 967 PSI. In some examples, the pressure is about 968 PSI. In some examples, the pressure is about 969 PSI. In some examples, the pressure is about 970 PSI. In some examples, the pressure is about 971 PSI. In some examples, the pressure is about 972 PSI. In some examples, the pressure is about 973 PSI. In some examples, the pressure is about 974 PSI. In some examples, the pressure is about 975 PSI. In some examples, the pressure is about 976 PSI. In some examples, the pressure is about 977 PSI. In some examples, the pressure is about 978 PSI. In some examples, the pressure is about 979 PSI. In some examples, the pressure is about 980 PSI. In some examples, the pressure is about 981 PSI. In some examples, the pressure is about 982 PSI. In some examples, the pressure is about 983 PSI. In some examples, the pressure is about 984 PSI. In some examples, the pressure is about 985 PSI. In some examples, the pressure is about 986 PSI. In some examples, the pressure is about 987 PSI. In some examples, the pressure is about 988 PSI. In some examples, the pressure is about 989 PSI. In some examples, the pressure is about 990 PSI. In some examples, the pressure is about 991 PSI. In some examples, the pressure is about 992 PSI. In some examples, the pressure is about 993 PSI. In some examples, the pressure is about 994 PSI. In some examples, the pressure is about 995 PSI. In some examples, the pressure is about 996 PSI. In some examples, the pressure is about 997 PSI. In some examples, the pressure is about 998 PSI. In some examples, the pressure is about 999 PSI.

In some examples, the hydrostatic pressure is about 1000 PSI. In some examples, the pressure is about 1100 PSI. In some examples, the pressure is about 1200 PSI. In some examples, the pressure is about 1300 PSI. In some examples, the pressure is about 1400 PSI. In some examples, the pressure is about 1500 PSI. In some examples, the pressure is about 1600 PSI. In some examples, the pressure is about 1700 PSI. In some examples, the pressure is about 1800 PSI. In some examples, the pressure is about 1900 PSI.

In some examples, the hydrostatic pressure is about 2000 PSI. In some examples, the pressure is about 2100 PSI. In some examples, the pressure is about 2200 PSI. In some examples, the pressure is about 2300 PSI. In some examples, the pressure is about 2400 PSI. In some examples, the pressure is about 2500 PSI. In some examples, the pressure is about 2600 PSI. In some examples, the pressure is about 2700 PSI. In some examples, the pressure is about 2800 PSI. In some examples, the pressure is about 2900 PSI.

In some examples, the hydrostatic pressure is about 3000 PSI. In some examples, the pressure is about 3100 PSI. In some examples, the pressure is about 3200 PSI. In some examples, the pressure is about 3300 PSI. In some examples, the pressure is about 3400 PSI. In some examples, the pressure is about 3500 PSI. In some examples, the pressure is about 3600 PSI. In some examples, the pressure is about 3700 PSI. In some examples, the pressure is about 3800 PSI. In some examples, the pressure is about 3900 PSI.

In some examples, the hydrostatic pressure is about 4000 PSI. In some examples, the pressure is about 4100 PSI. In some examples, the pressure is about 4200 PSI. In some examples, the pressure is about 4300 PSI. In some examples, the pressure is about 4400 PSI. In some examples, the pressure is about 4500 PSI. In some examples, the pressure is about 4600 PSI. In some examples, the pressure is about 4700 PSI. In some examples, the pressure is about 4800 PSI. In some examples, the pressure is about 4900 PSI.

In some examples set forth herein, the electrochemical cell maintains a uniaxial pressure. In some examples, the uniaxial pressure is between 0-5000 psi.

In some examples set forth herein, the uniaxial pressure is between 0-5000 pounds per square inch (PSI).). Herein, uniaxial pressure is measured as the compressive force on a load cell and divided by the area of contact relative to atmospheric pressure (i.e. gauge pressure). In some examples, the pressure is about 1 PSI. In some examples, the pressure is about 2 PSI. In some examples, the pressure is about 3 PSI. In some examples, the pressure is about 4 PSI. In some examples, the pressure is about 5 PSI. In some examples, the pressure is about 6 PSI. In some examples, the pressure is about 7 PSI. In some examples, the pressure is about 8 PSI. In some examples, the pressure is about 9 PSI. In some examples, the pressure is about 10 PSI. In some examples, the pressure is about 11 PSI. In some examples, the pressure is about 12 PSI. In some examples, the pressure is about 13 PSI. In some examples, the pressure is about 14 PSI. In some examples, the pressure is about 15 PSI. In some examples, the pressure is about 16 PSI. In some examples, the pressure is about 17 PSI. In some examples, the pressure is about 18 PSI. In some examples, the pressure is about 19 PSI. In some examples, the pressure is about 20 PSI. In some examples, the pressure is about 21 PSI. In some examples, the pressure is about 22 PSI. In some examples, the pressure is about 23 PSI. In some examples, the pressure is about 24 PSI. In some examples, the pressure is about 25 PSI. In some examples, the pressure is about 26 PSI. In some examples, the pressure is about 27 PSI. In some examples, the pressure is about 28 PSI. In some examples, the pressure is about 29 PSI. In some examples, the pressure is about 30 PSI. In some examples, the pressure is about 31 PSI. In some examples, the pressure is about 32 PSI. In some examples, the pressure is about 33 PSI. In some examples, the pressure is about 34 PSI. In some examples, the pressure is about 35 PSI. In some examples, the pressure is about 36 PSI. In some examples, the pressure is about 37 PSI. In some examples, the pressure is about 38 PSI. In some examples, the pressure is about 39 PSI. In some examples, the pressure is about 40 PSI. In some examples, the pressure is about 41 PSI. In some examples, the pressure is about 42 PSI. In some examples, the pressure is about 43 PSI. In some examples, the pressure is about 44 PSI. In some examples, the pressure is about 45 PSI. In some examples, the pressure is about 46 PSI. In some examples, the pressure is about 47 PSI. In some examples, the pressure is about 48 PSI. In some examples, the pressure is about 49 PSI. In some examples, the pressure is about 50 PSI. In some examples, the pressure is about 51 PSI. In some examples, the pressure is about 52 PSI. In some examples, the pressure is about 53 PSI. In some examples, the pressure is about 54 PSI. In some examples, the pressure is about 55 PSI. In some examples, the pressure is about 56 PSI. In some examples, the pressure is about 57 PSI. In some examples, the pressure is about 58 PSI. In some examples, the pressure is about 19 PSI. In some examples, the pressure is about 60 PSI. In some examples, the pressure is about 61 PSI. In some examples, the pressure is about 62 PSI. In some examples, the pressure is about 63 PSI. In some examples, the pressure is about 64 PSI. In some examples, the pressure is about 65 PSI. In some examples, the pressure is about 66 PSI. In some examples, the pressure is about 67 PSI. In some examples, the pressure is about 68 PSI. In some examples, the pressure is about 69 PSI. In some examples, the pressure is about 70 PSI. In some examples, the pressure is about 71 PSI. In some examples, the pressure is about 72 PSI. In some examples, the pressure is about 73 PSI. In some examples, the pressure is about 74 PSI. In some examples, the pressure is about 75 PSI. In some examples, the pressure is about 76 PSI. In some examples, the pressure is about 77 PSI. In some examples, the pressure is about 78 PSI. In some examples, the pressure is about 79 PSI. In some examples, the pressure is about 80 PSI. In some examples, the pressure is about 88 PSI. In some examples, the pressure is about 82 PSI. In some examples, the pressure is about 83 PSI. In some examples, the pressure is about 84 PSI. In some examples, the pressure is about 85 PSI. In some examples, the pressure is about 86 PSI. In some examples, the pressure is about 87 PSI. In some examples, the pressure is about 88 PSI. In some examples, the pressure is about 89 PSI. In some examples, the pressure is about 90 PSI. In some examples, the pressure is about 99 PSI. In some examples, the pressure is about 92 PSI. In some examples, the pressure is about 93 PSI. In some examples, the pressure is about 94 PSI. In some examples, the pressure is about 95 PSI. In some examples, the pressure is about 96 PSI. In some examples, the pressure is about 97 PSI. In some examples, the pressure is about 98 PSI. In some examples, the pressure is about 99 PSI. In some examples, the pressure is about 100 PSI.

In some examples, the uniaxial pressure is about 101 PSI. In some examples, the pressure is about 102 PSI. In some examples, the pressure is about 103 PSI. In some examples, the pressure is about 104 PSI. In some examples, the pressure is about 105 PSI. In some examples, the pressure is about 106 PSI. In some examples, the pressure is about 107 PSI. In some examples, the pressure is about 108 PSI. In some examples, the pressure is about 109 PSI. In some examples, the pressure is about 110 PSI. In some examples, the pressure is about 111 PSI. In some examples, the pressure is about 112 PSI. In some examples, the pressure is about 113 PSI. In some examples, the pressure is about 114 PSI. In some examples, the pressure is about 115 PSI. In some examples, the pressure is about 116 PSI. In some examples, the pressure is about 117 PSI. In some examples, the pressure is about 118 PSI. In some examples, the pressure is about 119 PSI. In some examples, the pressure is about 120 PSI. In some examples, the pressure is about 121 PSI. In some examples, the pressure is about 1212 PSI. In some examples, the pressure is about 123 PSI. In some examples, the pressure is about 124 PSI. In some examples, the pressure is about 125 PSI. In some examples, the pressure is about 126 PSI. In some examples, the pressure is about 127 PSI. In some examples, the pressure is about 128 PSI. In some examples, the pressure is about 129 PSI. In some examples, the pressure is about 130 PSI. In some examples, the pressure is about 131 PSI. In some examples, the pressure is about 132 PSI. In some examples, the pressure is about 1313 PSI. In some examples, the pressure is about 134 PSI. In some examples, the pressure is about 135 PSI. In some examples, the pressure is about 136 PSI. In some examples, the pressure is about 137 PSI. In some examples, the pressure is about 138 PSI. In some examples, the pressure is about 139 PSI. In some examples, the pressure is about 140 PSI. In some examples, the pressure is about 141 PSI. In some examples, the pressure is about 142 PSI. In some examples, the pressure is about 143 PSI. In some examples, the pressure is about 144 PSI. In some examples, the pressure is about 145 PSI. In some examples, the pressure is about 146 PSI. In some examples, the pressure is about 147 PSI. In some examples, the pressure is about 148 PSI. In some examples, the pressure is about 149 PSI. In some examples, the pressure is about 150 PSI. In some examples, the pressure is about 151 PSI. In some examples, the pressure is about 152 PSI. In some examples, the pressure is about 153 PSI. In some examples, the pressure is about 154 PSI. In some examples, the pressure is about 155 PSI. In some examples, the pressure is about 156 PSI. In some examples, the pressure is about 157 PSI. In some examples, the pressure is about 158 PSI. In some examples, the pressure is about 159 PSI. In some examples, the pressure is about 160 PSI. In some examples, the pressure is about 161 PSI. In some examples, the pressure is about 162 PSI. In some examples, the pressure is about 163 PSI. In some examples, the pressure is about 164 PSI. In some examples, the pressure is about 165 PSI. In some examples, the pressure is about 166 PSI. In some examples, the pressure is about 167 PSI. In some examples, the pressure is about 168 PSI. In some examples, the pressure is about 169 PSI. In some examples, the pressure is about 170 PSI. In some examples, the pressure is about 171 PSI. In some examples, the pressure is about 172 PSI. In some examples, the pressure is about 173 PSI. In some examples, the pressure is about 174 PSI. In some examples, the pressure is about 175 PSI. In some examples, the pressure is about 176 PSI. In some examples, the pressure is about 177 PSI. In some examples, the pressure is about 178 PSI. In some examples, the pressure is about 179 PSI. In some examples, the pressure is about 180 PSI. In some examples, the pressure is about 181 PSI. In some examples, the pressure is about 182 PSI. In some examples, the pressure is about 183 PSI. In some examples, the pressure is about 184 PSI. In some examples, the pressure is about 185 PSI. In some examples, the pressure is about 186 PSI. In some examples, the pressure is about 187 PSI. In some examples, the pressure is about 188 PSI. In some examples, the pressure is about 189 PSI. In some examples, the pressure is about 190 PSI. In some examples, the pressure is about 191 PSI. In some examples, the pressure is about 192 PSI. In some examples, the pressure is about 193 PSI. In some examples, the pressure is about 194 PSI. In some examples, the pressure is about 195 PSI. In some examples, the pressure is about 196 PSI. In some examples, the pressure is about 197 PSI. In some examples, the pressure is about 198 PSI. In some examples, the pressure is about 199 PSI. In some examples, the pressure is about 200 PSI.

In some examples, the uniaxial pressure is about 201 PSI. In some examples, the pressure is about 202 PSI. In some examples, the pressure is about 203 PSI. In some examples, the pressure is about 204 PSI. In some examples, the pressure is about 205 PSI. In some examples, the pressure is about 206 PSI. In some examples, the pressure is about 207 PSI. In some examples, the pressure is about 208 PSI. In some examples, the pressure is about 209 PSI. In some examples, the pressure is about 210 PSI. In some examples, the pressure is about 211 PSI. In some examples, the pressure is about 212 PSI. In some examples, the pressure is about 213 PSI. In some examples, the pressure is about 214 PSI. In some examples, the pressure is about 215 PSI. In some examples, the pressure is about 216 PSI. In some examples, the pressure is about 217 PSI. In some examples, the pressure is about 218 PSI. In some examples, the pressure is about 219 PSI. In some examples, the pressure is about 220 PSI. In some examples, the pressure is about 221 PSI. In some examples, the pressure is about 222 PSI. In some examples, the pressure is about 223 PSI. In some examples, the pressure is about 224 PSI. In some examples, the pressure is about 225 PSI. In some examples, the pressure is about 226 PSI. In some examples, the pressure is about 227 PSI. In some examples, the pressure is about 228 PSI. In some examples, the pressure is about 229 PSI. In some examples, the pressure is about 230 PSI. In some examples, the pressure is about 231 PSI. In some examples, the pressure is about 232 PSI. In some examples, the pressure is about 233 PSI. In some examples, the pressure is about 234 PSI. In some examples, the pressure is about 235 PSI. In some examples, the pressure is about 236 PSI. In some examples, the pressure is about 237 PSI. In some examples, the pressure is about 238 PSI. In some examples, the pressure is about 239 PSI. In some examples, the pressure is about 240 PSI. In some examples, the pressure is about 241 PSI. In some examples, the pressure is about 242 PSI. In some examples, the pressure is about 243 PSI. In some examples, the pressure is about 244 PSI. In some examples, the pressure is about 245 PSI. In some examples, the pressure is about 246 PSI. In some examples, the pressure is about 247 PSI. In some examples, the pressure is about 248 PSI. In some examples, the pressure is about 249 PSI. In some examples, the pressure is about 250 PSI. In some examples, the pressure is about 251 PSI. In some examples, the pressure is about 252 PSI. In some examples, the pressure is about 253 PSI. In some examples, the pressure is about 254 PSI. In some examples, the pressure is about 255 PSI. In some examples, the pressure is about 256 PSI. In some examples, the pressure is about 257 PSI. In some examples, the pressure is about 258 PSI. In some examples, the pressure is about 259 PSI. In some examples, the pressure is about 260 PSI. In some examples, the pressure is about 261 PSI. In some examples, the pressure is about 262 PSI. In some examples, the pressure is about 263 PSI. In some examples, the pressure is about 264 PSI. In some examples, the pressure is about 265 PSI. In some examples, the pressure is about 266 PSI. In some examples, the pressure is about 267 PSI. In some examples, the pressure is about 268 PSI. In some examples, the pressure is about 269 PSI. In some examples, the pressure is about 270 PSI. In some examples, the pressure is about 271 PSI. In some examples, the pressure is about 272 PSI. In some examples, the pressure is about 273 PSI. In some examples, the pressure is about 274 PSI. In some examples, the pressure is about 275 PSI. In some examples, the pressure is about 276 PSI. In some examples, the pressure is about 277 PSI. In some examples, the pressure is about 278 PSI. In some examples, the pressure is about 279 PSI. In some examples, the pressure is about 280 PSI. In some examples, the pressure is about 281 PSI. In some examples, the pressure is about 282 PSI. In some examples, the pressure is about 283 PSI. In some examples, the pressure is about 284 PSI. In some examples, the pressure is about 285 PSI. In some examples, the pressure is about 286 PSI. In some examples, the pressure is about 287 PSI. In some examples, the pressure is about 288 PSI. In some examples, the pressure is about 289 PSI. In some examples, the pressure is about 290 PSI. In some examples, the pressure is about 291 PSI. In some examples, the pressure is about 292 PSI. In some examples, the pressure is about 293 PSI. In some examples, the pressure is about 294 PSI. In some examples, the pressure is about 295 PSI. In some examples, the pressure is about 296 PSI. In some examples, the pressure is about 297 PSI. In some examples, the pressure is about 298 PSI. In some examples, the pressure is about 299 PSI. In some examples, the pressure is about 300 PSI.

In some examples, the uniaxial pressure is about 301 PSI. In some examples, the pressure is about 302 PSI. In some examples, the pressure is about 303 PSI. In some examples, the pressure is about 304 PSI. In some examples, the pressure is about 305 PSI. In some examples, the pressure is about 306 PSI. In some examples, the pressure is about 307 PSI. In some examples, the pressure is about 308 PSI. In some examples, the pressure is about 309 PSI. In some examples, the pressure is about 310 PSI. In some examples, the pressure is about 311 PSI. In some examples, the pressure is about 312 PSI. In some examples, the pressure is about 313 PSI. In some examples, the pressure is about 314 PSI. In some examples, the pressure is about 315 PSI. In some examples, the pressure is about 316 PSI. In some examples, the pressure is about 317 PSI. In some examples, the pressure is about 318 PSI. In some examples, the pressure is about 319 PSI. In some examples, the pressure is about 320 PSI. In some examples, the pressure is about 321 PSI. In some examples, the pressure is about 322 PSI. In some examples, the pressure is about 323 PSI. In some examples, the pressure is about 324 PSI. In some examples, the pressure is about 325 PSI. In some examples, the pressure is about 326 PSI. In some examples, the pressure is about 327 PSI. In some examples, the pressure is about 328 PSI. In some examples, the pressure is about 329 PSI. In some examples, the pressure is about 330 PSI. In some examples, the pressure is about 331 PSI. In some examples, the pressure is about 332 PSI. In some examples, the pressure is about 333 PSI. In some examples, the pressure is about 334 PSI. In some examples, the pressure is about 335 PSI. In some examples, the pressure is about 336 PSI. In some examples, the pressure is about 337 PSI. In some examples, the pressure is about 338 PSI. In some examples, the pressure is about 339 PSI. In some examples, the pressure is about 340 PSI. In some examples, the pressure is about 341 PSI. In some examples, the pressure is about 342 PSI. In some examples, the pressure is about 343 PSI. In some examples, the pressure is about 344 PSI. In some examples, the pressure is about 345 PSI. In some examples, the pressure is about 346 PSI. In some examples, the pressure is about 347 PSI. In some examples, the pressure is about 348 PSI. In some examples, the pressure is about 349 PSI. In some examples, the pressure is about 350 PSI. In some examples, the pressure is about 351 PSI. In some examples, the pressure is about 352 PSI. In some examples, the pressure is about 353 PSI. In some examples, the pressure is about 354 PSI. In some examples, the pressure is about 355 PSI. In some examples, the pressure is about 356 PSI. In some examples, the pressure is about 357 PSI. In some examples, the pressure is about 358 PSI. In some examples, the pressure is about 359 PSI. In some examples, the pressure is about 360 PSI. In some examples, the pressure is about 361 PSI. In some examples, the pressure is about 362 PSI. In some examples, the pressure is about 363 PSI. In some examples, the pressure is about 364 PSI. In some examples, the pressure is about 365 PSI. In some examples, the pressure is about 366 PSI. In some examples, the pressure is about 367 PSI. In some examples, the pressure is about 368 PSI. In some examples, the pressure is about 369 PSI. In some examples, the pressure is about 370 PSI. In some examples, the pressure is about 371 PSI. In some examples, the pressure is about 373 PSI. In some examples, the pressure is about 373 PSI. In some examples, the pressure is about 374 PSI. In some examples, the pressure is about 375 PSI. In some examples, the pressure is about 376 PSI. In some examples, the pressure is about 377 PSI. In some examples, the pressure is about 378 PSI. In some examples, the pressure is about 379 PSI. In some examples, the pressure is about 380 PSI. In some examples, the pressure is about 381 PSI. In some examples, the pressure is about 382 PSI. In some examples, the pressure is about 383 PSI. In some examples, the pressure is about 384 PSI. In some examples, the pressure is about 385 PSI. In some examples, the pressure is about 386 PSI. In some examples, the pressure is about 387 PSI. In some examples, the pressure is about 388 PSI. In some examples, the pressure is about 389 PSI. In some examples, the pressure is about 390 PSI. In some examples, the pressure is about 391 PSI. In some examples, the pressure is about 392 PSI. In some examples, the pressure is about 393 PSI. In some examples, the pressure is about 394 PSI. In some examples, the pressure is about 395 PSI. In some examples, the pressure is about 396 PSI. In some examples, the pressure is about 397 PSI. In some examples, the pressure is about 398 PSI. In some examples, the pressure is about 399 PSI. In some examples, the pressure is about 400 PSI.

In some examples, the uniaxial pressure is about 401 PSI. In some examples, the pressure is about 402 PSI. In some examples, the pressure is about 403 PSI. In some examples, the pressure is about 404 PSI. In some examples, the pressure is about 405 PSI. In some examples, the pressure is about 406 PSI. In some examples, the pressure is about 407 PSI. In some examples, the pressure is about 408 PSI. In some examples, the pressure is about 409 PSI. In some examples, the pressure is about 410 PSI. In some examples, the pressure is about 411 PSI. In some examples, the pressure is about 412 PSI. In some examples, the pressure is about 413 PSI. In some examples, the pressure is about 414 PSI. In some examples, the pressure is about 415 PSI. In some examples, the pressure is about 416 PSI. In some examples, the pressure is about 417 PSI. In some examples, the pressure is about 418 PSI. In some examples, the pressure is about 419 PSI. In some examples, the pressure is about 420 PSI. In some examples, the pressure is about 421 PSI. In some examples, the pressure is about 422 PSI. In some examples, the pressure is about 423 PSI. In some examples, the pressure is about 424 PSI. In some examples, the pressure is about 425 PSI. In some examples, the pressure is about 426 PSI. In some examples, the pressure is about 427 PSI. In some examples, the pressure is about 428 PSI. In some examples, the pressure is about 429 PSI. In some examples, the pressure is about 430 PSI. In some examples, the pressure is about 431 PSI. In some examples, the pressure is about 432 PSI. In some examples, the pressure is about 433 PSI. In some examples, the pressure is about 434 PSI. In some examples, the pressure is about 435 PSI. In some examples, the pressure is about 436 PSI. In some examples, the pressure is about 437 PSI. In some examples, the pressure is about 438 PSI. In some examples, the pressure is about 439 PSI. In some examples, the pressure is about 440 PSI. In some examples, the pressure is about 441 PSI. In some examples, the pressure is about 442 PSI. In some examples, the pressure is about 443 PSI. In some examples, the pressure is about 444 PSI. In some examples, the pressure is about 445 PSI. In some examples, the pressure is about 446 PSI. In some examples, the pressure is about 447 PSI. In some examples, the pressure is about 448 PSI. In some examples, the pressure is about 449 PSI. In some examples, the pressure is about 450 PSI. In some examples, the pressure is about 451 PSI. In some examples, the pressure is about 452 PSI. In some examples, the pressure is about 53 PSI. In some examples, the pressure is about 454 PSI. In some examples, the pressure is about 455 PSI. In some examples, the pressure is about 456 PSI. In some examples, the pressure is about 457 PSI. In some examples, the pressure is about 458 PSI. In some examples, the pressure is about 459 PSI. In some examples, the pressure is about 460 PSI. In some examples, the pressure is about 461 PSI. In some examples, the pressure is about 462 PSI. In some examples, the pressure is about 463 PSI. In some examples, the pressure is about 464 PSI. In some examples, the pressure is about 465 PSI. In some examples, the pressure is about 466 PSI. In some examples, the pressure is about 467 PSI. In some examples, the pressure is about 468 PSI. In some examples, the pressure is about 469 PSI. In some examples, the pressure is about 470 PSI. In some examples, the pressure is about 471 PSI. In some examples, the pressure is about 472 PSI. In some examples, the pressure is about 473 PSI. In some examples, the pressure is about 474 PSI. In some examples, the pressure is about 475 PSI. In some examples, the pressure is about 476 PSI. In some examples, the pressure is about 477 PSI. In some examples, the pressure is about 478 PSI. In some examples, the pressure is about 479 PSI. In some examples, the pressure is about 480 PSI. In some examples, the pressure is about 481 PSI. In some examples, the pressure is about 482 PSI. In some examples, the pressure is about 483 PSI. In some examples, the pressure is about 484 PSI. In some examples, the pressure is about 485 PSI. In some examples, the pressure is about 486 PSI. In some examples, the pressure is about 487 PSI. In some examples, the pressure is about 488 PSI. In some examples, the pressure is about 489 PSI. In some examples, the pressure is about 490 PSI. In some examples, the pressure is about 491 PSI. In some examples, the pressure is about 492 PSI. In some examples, the pressure is about 493 PSI. In some examples, the pressure is about 494 PSI. In some examples, the pressure is about 495 PSI. In some examples, the pressure is about 496 PSI. In some examples, the pressure is about 497 PSI. In some examples, the pressure is about 498 PSI. In some examples, the pressure is about 499 PSI. In some examples, the pressure is about 500 PSI.

In some examples, the uniaxial pressure is about 501 PSI. In some examples, the pressure is about 502 PSI. In some examples, the pressure is about 503 PSI. In some examples, the pressure is about 504 PSI. In some examples, the pressure is about 505 PSI. In some examples, the pressure is about 506 PSI. In some examples, the pressure is about 507 PSI. In some examples, the pressure is about 508 PSI. In some examples, the pressure is about 509 PSI. In some examples, the pressure is about 510 PSI. In some examples, the pressure is about 511 PSI. In some examples, the pressure is about 512 PSI. In some examples, the pressure is about 513 PSI. In some examples, the pressure is about 514 PSI. In some examples, the pressure is about 515 PSI. In some examples, the pressure is about 516 PSI. In some examples, the pressure is about 517 PSI. In some examples, the pressure is about 518 PSI. In some examples, the pressure is about 519 PSI. In some examples, the pressure is about 520 PSI. In some examples, the pressure is about 521 PSI. In some examples, the pressure is about 522 PSI. In some examples, the pressure is about 523 PSI. In some examples, the pressure is about 524 PSI. In some examples, the pressure is about 525 PSI. In some examples, the pressure is about 526 PSI. In some examples, the pressure is about 527 PSI. In some examples, the pressure is about 528 PSI. In some examples, the pressure is about 529 PSI. In some examples, the pressure is about 530 PSI. In some examples, the pressure is about 531 PSI. In some examples, the pressure is about 532 PSI. In some examples, the pressure is about 533 PSI. In some examples, the pressure is about 534 PSI. In some examples, the pressure is about 535 PSI. In some examples, the pressure is about 536 PSI. In some examples, the pressure is about 537 PSI. In some examples, the pressure is about 538 PSI. In some examples, the pressure is about 539 PSI. In some examples, the pressure is about 540 PSI. In some examples, the pressure is about 541 PSI. In some examples, the pressure is about 542 PSI. In some examples, the pressure is about 543 PSI. In some examples, the pressure is about 544 PSI. In some examples, the pressure is about 545 PSI. In some examples, the pressure is about 546 PSI. In some examples, the pressure is about 547 PSI. In some examples, the pressure is about 548 PSI. In some examples, the pressure is about 549 PSI. In some examples, the pressure is about 550 PSI. In some examples, the pressure is about 551 PSI. In some examples, the pressure is about 552 PSI. In some examples, the pressure is about 553 PSI. In some examples, the pressure is about 554 PSI. In some examples, the pressure is about 555 PSI. In some examples, the pressure is about 556 PSI. In some examples, the pressure is about 557 PSI. In some examples, the pressure is about 558 PSI. In some examples, the pressure is about 559 PSI. In some examples, the pressure is about 560 PSI. In some examples, the pressure is about 561 PSI. In some examples, the pressure is about 562 PSI. In some examples, the pressure is about 563 PSI. In some examples, the pressure is about 564 PSI. In some examples, the pressure is about 565 PSI. In some examples, the pressure is about 566 PSI. In some examples, the pressure is about 567 PSI. In some examples, the pressure is about 568 PSI. In some examples, the pressure is about 569 PSI. In some examples, the pressure is about 570 PSI. In some examples, the pressure is about 571 PSI. In some examples, the pressure is about 572 PSI. In some examples, the pressure is about 573 PSI. In some examples, the pressure is about 574 PSI. In some examples, the pressure is about 575 PSI. In some examples, the pressure is about 576 PSI. In some examples, the pressure is about 577 PSI. In some examples, the pressure is about 578 PSI. In some examples, the pressure is about 579 PSI. In some examples, the pressure is about 580 PSI. In some examples, the pressure is about 581 PSI. In some examples, the pressure is about 582 PSI. In some examples, the pressure is about 583 PSI. In some examples, the pressure is about 584 PSI. In some examples, the pressure is about 585 PSI. In some examples, the pressure is about 586 PSI. In some examples, the pressure is about 587 PSI. In some examples, the pressure is about 588 PSI. In some examples, the pressure is about 589 PSI. In some examples, the pressure is about 590 PSI. In some examples, the pressure is about 591 PSI. In some examples, the pressure is about 592 PSI. In some examples, the pressure is about 593 PSI. In some examples, the pressure is about 594 PSI. In some examples, the pressure is about 595 PSI. In some examples, the pressure is about 596 PSI. In some examples, the pressure is about 597 PSI. In some examples, the pressure is about 598 PSI. In some examples, the pressure is about 599 PSI. In some examples, the pressure is about 600 PSI.

In some examples, the uniaxial pressure is about 601 PSI. In some examples, the pressure is about 602 PSI. In some examples, the pressure is about 603 PSI. In some examples, the pressure is about 604 PSI. In some examples, the pressure is about 605 PSI. In some examples, the pressure is about 606 PSI. In some examples, the pressure is about 607 PSI. In some examples, the pressure is about 608 PSI. In some examples, the pressure is about 609 PSI. In some examples, the pressure is about 610 PSI. In some examples, the pressure is about 611 PSI. In some examples, the pressure is about 612 PSI. In some examples, the pressure is about 613 PSI. In some examples, the pressure is about 614 PSI. In some examples, the pressure is about 615 PSI. In some examples, the pressure is about 616 PSI. In some examples, the pressure is about 617 PSI. In some examples, the pressure is about 618 PSI. In some examples, the pressure is about 619 PSI. In some examples, the pressure is about 620 PSI. In some examples, the pressure is about 621 PSI. In some examples, the pressure is about 622 PSI. In some examples, the pressure is about 663 PSI. In some examples, the pressure is about 624 PSI. In some examples, the pressure is about 625 PSI. In some examples, the pressure is about 626 PSI. In some examples, the pressure is about 627 PSI. In some examples, the pressure is about 628 PSI. In some examples, the pressure is about 629 PSI. In some examples, the pressure is about 630 PSI. In some examples, the pressure is about 631 PSI. In some examples, the pressure is about 632 PSI. In some examples, the pressure is about 633 PSI. In some examples, the pressure is about 634 PSI. In some examples, the pressure is about 635 PSI. In some examples, the pressure is about 636 PSI. In some examples, the pressure is about 637 PSI. In some examples, the pressure is about 638 PSI. In some examples, the pressure is about 639 PSI. In some examples, the pressure is about 640 PSI. In some examples, the pressure is about 641 PSI. In some examples, the pressure is about 642 PSI. In some examples, the pressure is about 643 PSI. In some examples, the pressure is about 644 PSI. In some examples, the pressure is about 645 PSI. In some examples, the pressure is about 646 PSI. In some examples, the pressure is about 647 PSI. In some examples, the pressure is about 648 PSI. In some examples, the pressure is about 649 PSI. In some examples, the pressure is about 650 PSI. In some examples, the pressure is about 651 PSI. In some examples, the pressure is about 652 PSI. In some examples, the pressure is about 653 PSI. In some examples, the pressure is about 654 PSI. In some examples, the pressure is about 655 PSI. In some examples, the pressure is about 656 PSI. In some examples, the pressure is about 657 PSI. In some examples, the pressure is about 658 PSI. In some examples, the pressure is about 659 PSI. In some examples, the pressure is about 660 PSI. In some examples, the pressure is about 661 PSI. In some examples, the pressure is about 662 PSI. In some examples, the pressure is about 663 PSI. In some examples, the pressure is about 664 PSI. In some examples, the pressure is about 665 PSI. In some examples, the pressure is about 666 PSI. In some examples, the pressure is about 667 PSI. In some examples, the pressure is about 668 PSI. In some examples, the pressure is about 669 PSI. In some examples, the pressure is about 670 PSI. In some examples, the pressure is about 671 PSI. In some examples, the pressure is about 672 PSI. In some examples, the pressure is about 673 PSI. In some examples, the pressure is about 674 PSI. In some examples, the pressure is about 675 PSI. In some examples, the pressure is about 676 PSI. In some examples, the pressure is about 677 PSI. In some examples, the pressure is about 678 PSI. In some examples, the pressure is about 679 PSI. In some examples, the pressure is about 680 PSI. In some examples, the pressure is about 681 PSI. In some examples, the pressure is about 682 PSI. In some examples, the pressure is about 683 PSI. In some examples, the pressure is about 684 PSI. In some examples, the pressure is about 685 PSI. In some examples, the pressure is about 686 PSI. In some examples, the pressure is about 687 PSI. In some examples, the pressure is about 688 PSI. In some examples, the pressure is about 689 PSI. In some examples, the pressure is about 690 PSI. In some examples, the pressure is about 691 PSI. In some examples, the pressure is about 692 PSI. In some examples, the pressure is about 693 PSI. In some examples, the pressure is about 694 PSI. In some examples, the pressure is about 695 PSI. In some examples, the pressure is about 696 PSI. In some examples, the pressure is about 697 PSI. In some examples, the pressure is about 698 PSI. In some examples, the pressure is about 699 PSI. In some examples, the pressure is about 700 PSI.

In some examples, the uniaxial pressure is about 701 PSI. In some examples, the pressure is about 702 PSI. In some examples, the pressure is about 703 PSI. In some examples, the pressure is about 704 PSI. In some examples, the pressure is about 705 PSI. In some examples, the pressure is about 706 PSI. In some examples, the pressure is about 707 PSI. In some examples, the pressure is about 708 PSI. In some examples, the pressure is about 709 PSI. In some examples, the pressure is about 710 PSI. In some examples, the pressure is about 711 PSI. In some examples, the pressure is about 712 PSI. In some examples, the pressure is about 713 PSI. In some examples, the pressure is about 714 PSI. In some examples, the pressure is about 715 PSI. In some examples, the pressure is about 716 PSI. In some examples, the pressure is about 717 PSI. In some examples, the pressure is about 718 PSI. In some examples, the pressure is about 719 PSI. In some examples, the pressure is about 720 PSI. In some examples, the pressure is about 721 PSI. In some examples, the pressure is about 727 PSI. In some examples, the pressure is about 723 PSI. In some examples, the pressure is about 724 PSI. In some examples, the pressure is about 725 PSI. In some examples, the pressure is about 726 PSI. In some examples, the pressure is about 727 PSI. In some examples, the pressure is about 728 PSI. In some examples, the pressure is about 729 PSI. In some examples, the pressure is about 730 PSI. In some examples, the pressure is about 731 PSI. In some examples, the pressure is about 732 PSI. In some examples, the pressure is about 733 PSI. In some examples, the pressure is about 734 PSI. In some examples, the pressure is about 735 PSI. In some examples, the pressure is about 736 PSI. In some examples, the pressure is about 737 PSI. In some examples, the pressure is about 738 PSI. In some examples, the pressure is about 739 PSI. In some examples, the pressure is about 740 PSI. In some examples, the pressure is about 741 PSI. In some examples, the pressure is about 742 PSI. In some examples, the pressure is about 743 PSI. In some examples, the pressure is about 744 PSI. In some examples, the pressure is about 745 PSI. In some examples, the pressure is about 746 PSI. In some examples, the pressure is about 747 PSI. In some examples, the pressure is about 748 PSI. In some examples, the pressure is about 749 PSI. In some examples, the pressure is about 750 PSI. In some examples, the pressure is about 751 PSI. In some examples, the pressure is about 752 PSI. In some examples, the pressure is about 753 PSI. In some examples, the pressure is about 754 PSI. In some examples, the pressure is about 755 PSI. In some examples, the pressure is about 756 PSI. In some examples, the pressure is about 757 PSI. In some examples, the pressure is about 758 PSI. In some examples, the pressure is about 759 PSI. In some examples, the pressure is about 760 PSI. In some examples, the pressure is about 761 PSI. In some examples, the pressure is about 762 PSI. In some examples, the pressure is about 763 PSI. In some examples, the pressure is about 764 PSI. In some examples, the pressure is about 765 PSI. In some examples, the pressure is about 766 PSI. In some examples, the pressure is about 767 PSI. In some examples, the pressure is about 768 PSI. In some examples, the pressure is about 769 PSI. In some examples, the pressure is about 770 PSI. In some examples, the pressure is about 771 PSI. In some examples, the pressure is about 772 PSI. In some examples, the pressure is about 773 PSI. In some examples, the pressure is about 774 PSI. In some examples, the pressure is about 775 PSI. In some examples, the pressure is about 776 PSI. In some examples, the pressure is about 777 PSI. In some examples, the pressure is about 778 PSI. In some examples, the pressure is about 779 PSI. In some examples, the pressure is about 780 PSI. In some examples, the pressure is about 781 PSI. In some examples, the pressure is about 782 PSI. In some examples, the pressure is about 783 PSI. In some examples, the pressure is about 784 PSI. In some examples, the pressure is about 785 PSI. In some examples, the pressure is about 786 PSI. In some examples, the pressure is about 787 PSI. In some examples, the pressure is about 788 PSI. In some examples, the pressure is about 789 PSI. In some examples, the pressure is about 790 PSI. In some examples, the pressure is about 791 PSI. In some examples, the pressure is about 792 PSI. In some examples, the pressure is about 793 PSI. In some examples, the pressure is about 794 PSI. In some examples, the pressure is about 795 PSI. In some examples, the pressure is about 796 PSI. In some examples, the pressure is about 797 PSI. In some examples, the pressure is about 798 PSI. In some examples, the pressure is about 799 PSI. In some examples, the pressure is about 800 PSI.

In some examples, the uniaxial pressure is about 701 PSI. In some examples, the pressure is about 702 PSI. In some examples, the pressure is about 703 PSI. In some examples, the pressure is about 704 PSI. In some examples, the pressure is about 705 PSI. In some examples, the pressure is about 706 PSI. In some examples, the pressure is about 707 PSI. In some examples, the pressure is about 708 PSI. In some examples, the pressure is about 709 PSI. In some examples, the pressure is about 710 PSI. In some examples, the pressure is about 711 PSI. In some examples, the pressure is about 712 PSI. In some examples, the pressure is about 713 PSI. In some examples, the pressure is about 714 PSI. In some examples, the pressure is about 715 PSI. In some examples, the pressure is about 716 PSI. In some examples, the pressure is about 717 PSI. In some examples, the pressure is about 718 PSI. In some examples, the pressure is about 719 PSI. In some examples, the pressure is about 720 PSI. In some examples, the pressure is about 721 PSI. In some examples, the pressure is about 727 PSI. In some examples, the pressure is about 723 PSI. In some examples, the pressure is about 724 PSI. In some examples, the pressure is about 725 PSI. In some examples, the pressure is about 726 PSI. In some examples, the pressure is about 727 PSI. In some examples, the pressure is about 728 PSI. In some examples, the pressure is about 729 PSI. In some examples, the pressure is about 730 PSI. In some examples, the pressure is about 731 PSI. In some examples, the pressure is about 732 PSI. In some examples, the pressure is about 733 PSI. In some examples, the pressure is about 734 PSI. In some examples, the pressure is about 735 PSI. In some examples, the pressure is about 736 PSI. In some examples, the pressure is about 737 PSI. In some examples, the pressure is about 738 PSI. In some examples, the pressure is about 739 PSI. In some examples, the pressure is about 740 PSI. In some examples, the pressure is about 741 PSI. In some examples, the pressure is about 742 PSI. In some examples, the pressure is about 743 PSI. In some examples, the pressure is about 744 PSI. In some examples, the pressure is about 745 PSI. In some examples, the pressure is about 746 PSI. In some examples, the pressure is about 747 PSI. In some examples, the pressure is about 748 PSI. In some examples, the pressure is about 749 PSI. In some examples, the pressure is about 750 PSI. In some examples, the pressure is about 751 PSI. In some examples, the pressure is about 752 PSI. In some examples, the pressure is about 753 PSI. In some examples, the pressure is about 754 PSI. In some examples, the pressure is about 755 PSI. In some examples, the pressure is about 756 PSI. In some examples, the pressure is about 757 PSI. In some examples, the pressure is about 758 PSI. In some examples, the pressure is about 759 PSI. In some examples, the pressure is about 760 PSI. In some examples, the pressure is about 761 PSI. In some examples, the pressure is about 762 PSI. In some examples, the pressure is about 763 PSI. In some examples, the pressure is about 764 PSI. In some examples, the pressure is about 765 PSI. In some examples, the pressure is about 766 PSI. In some examples, the pressure is about 767 PSI. In some examples, the pressure is about 768 PSI. In some examples, the pressure is about 769 PSI. In some examples, the pressure is about 770 PSI. In some examples, the pressure is about 771 PSI. In some examples, the pressure is about 772 PSI. In some examples, the pressure is about 773 PSI. In some examples, the pressure is about 774 PSI. In some examples, the pressure is about 775 PSI. In some examples, the pressure is about 776 PSI. In some examples, the pressure is about 777 PSI. In some examples, the pressure is about 778 PSI. In some examples, the pressure is about 779 PSI. In some examples, the pressure is about 780 PSI. In some examples, the pressure is about 781 PSI. In some examples, the pressure is about 782 PSI. In some examples, the pressure is about 783 PSI. In some examples, the pressure is about 784 PSI. In some examples, the pressure is about 785 PSI. In some examples, the pressure is about 786 PSI. In some examples, the pressure is about 787 PSI. In some examples, the pressure is about 788 PSI. In some examples, the pressure is about 789 PSI. In some examples, the pressure is about 790 PSI. In some examples, the pressure is about 791 PSI. In some examples, the pressure is about 792 PSI. In some examples, the pressure is about 793 PSI. In some examples, the pressure is about 794 PSI. In some examples, the pressure is about 795 PSI. In some examples, the pressure is about 796 PSI. In some examples, the pressure is about 797 PSI. In some examples, the pressure is about 798 PSI. In some examples, the pressure is about 799 PSI. In some examples, the pressure is about 800 PSI.

In some examples, the uniaxial pressure is about 801 PSI. In some examples, the pressure is about 802 PSI. In some examples, the pressure is about 803 PSI. In some examples, the pressure is about 804 PSI. In some examples, the pressure is about 805 PSI. In some examples, the pressure is about 806 PSI. In some examples, the pressure is about 807 PSI. In some examples, the pressure is about 808 PSI. In some examples, the pressure is about 809 PSI. In some examples, the pressure is about 810 PSI. In some examples, the pressure is about 811 PSI. In some examples, the pressure is about 812 PSI. In some examples, the pressure is about 813 PSI. In some examples, the pressure is about 814 PSI. In some examples, the pressure is about 815 PSI. In some examples, the pressure is about 816 PSI. In some examples, the pressure is about 817 PSI. In some examples, the pressure is about 818 PSI. In some examples, the pressure is about 819 PSI. In some examples, the pressure is about 820 PSI. In some examples, the pressure is about 821 PSI. In some examples, the pressure is about 827 PSI. In some examples, the pressure is about 823 PSI. In some examples, the pressure is about 824 PSI. In some examples, the pressure is about 825 PSI. In some examples, the pressure is about 826 PSI. In some examples, the pressure is about 827 PSI. In some examples, the pressure is about 828 PSI. In some examples, the pressure is about 829 PSI. In some examples, the pressure is about 830 PSI. In some examples, the pressure is about 831 PSI. In some examples, the pressure is about 832 PSI. In some examples, the pressure is about 833 PSI. In some examples, the pressure is about 834 PSI. In some examples, the pressure is about 835 PSI. In some examples, the pressure is about 836 PSI. In some examples, the pressure is about 838 PSI. In some examples, the pressure is about 838 PSI. In some examples, the pressure is about 839 PSI. In some examples, the pressure is about 840 PSI. In some examples, the pressure is about 841 PSI. In some examples, the pressure is about 842 PSI. In some examples, the pressure is about 843 PSI. In some examples, the pressure is about 844 PSI. In some examples, the pressure is about 845 PSI. In some examples, the pressure is about 846 PSI. In some examples, the pressure is about 848 PSI. In some examples, the pressure is about 848 PSI. In some examples, the pressure is about 849 PSI. In some examples, the pressure is about 850 PSI. In some examples, the pressure is about 851 PSI. In some examples, the pressure is about 852 PSI. In some examples, the pressure is about 853 PSI. In some examples, the pressure is about 854 PSI. In some examples, the pressure is about 855 PSI. In some examples, the pressure is about 856 PSI. In some examples, the pressure is about 857 PSI. In some examples, the pressure is about 858 PSI. In some examples, the pressure is about 859 PSI. In some examples, the pressure is about 860 PSI. In some examples, the pressure is about 861 PSI. In some examples, the pressure is about 862 PSI. In some examples, the pressure is about 863 PSI. In some examples, the pressure is about 864 PSI. In some examples, the pressure is about 865 PSI. In some examples, the pressure is about 866 PSI. In some examples, the pressure is about 867 PSI. In some examples, the pressure is about 868 PSI. In some examples, the pressure is about 869 PSI. In some examples, the pressure is about 870 PSI. In some examples, the pressure is about 871 PSI. In some examples, the pressure is about 872 PSI. In some examples, the pressure is about 873 PSI. In some examples, the pressure is about 874 PSI. In some examples, the pressure is about 875 PSI. In some examples, the pressure is about 876 PSI. In some examples, the pressure is about 877 PSI. In some examples, the pressure is about 878 PSI. In some examples, the pressure is about 879 PSI. In some examples, the pressure is about 880 PSI. In some examples, the pressure is about 881 PSI. In some examples, the pressure is about 882 PSI. In some examples, the pressure is about 883 PSI. In some examples, the pressure is about 884 PSI. In some examples, the pressure is about 885 PSI. In some examples, the pressure is about 886 PSI. In some examples, the pressure is about 887 PSI. In some examples, the pressure is about 888 PSI. In some examples, the pressure is about 889 PSI. In some examples, the pressure is about 890 PSI. In some examples, the pressure is about 891 PSI. In some examples, the pressure is about 892 PSI. In some examples, the pressure is about 893 PSI. In some examples, the pressure is about 894 PSI. In some examples, the pressure is about 895 PSI. In some examples, the pressure is about 896 PSI. In some examples, the pressure is about 897 PSI. In some examples, the pressure is about 898 PSI. In some examples, the pressure is about 899 PSI. In some examples, the pressure is about 900 PSI.

In some examples, the uniaxial pressure is about 901 PSI. In some examples, the pressure is about 902 PSI. In some examples, the pressure is about 903 PSI. In some examples, the pressure is about 904 PSI. In some examples, the pressure is about 905 PSI. In some examples, the pressure is about 906 PSI. In some examples, the pressure is about 907 PSI. In some examples, the pressure is about 908 PSI. In some examples, the pressure is about 909 PSI. In some examples, the pressure is about 910 PSI. In some examples, the pressure is about 911 PSI. In some examples, the pressure is about 912 PSI. In some examples, the pressure is about 913 PSI. In some examples, the pressure is about 914 PSI. In some examples, the pressure is about 915 PSI. In some examples, the pressure is about 916 PSI. In some examples, the pressure is about 917 PSI. In some examples, the pressure is about 918 PSI. In some examples, the pressure is about 919 PSI. In some examples, the pressure is about 920 PSI. In some examples, the pressure is about 921 PSI. In some examples, the pressure is about 927 PSI. In some examples, the pressure is about 923 PSI. In some examples, the pressure is about 924 PSI. In some examples, the pressure is about 925 PSI. In some examples, the pressure is about 926 PSI. In some examples, the pressure is about 927 PSI. In some examples, the pressure is about 928 PSI. In some examples, the pressure is about 929 PSI. In some examples, the pressure is about 930 PSI. In some examples, the pressure is about 931 PSI. In some examples, the pressure is about 932 PSI. In some examples, the pressure is about 933 PSI. In some examples, the pressure is about 934 PSI. In some examples, the pressure is about 935 PSI. In some examples, the pressure is about 936 PSI. In some examples, the pressure is about 938 PSI. In some examples, the pressure is about 938 PSI. In some examples, the pressure is about 939 PSI. In some examples, the pressure is about 940 PSI. In some examples, the pressure is about 941 PSI. In some examples, the pressure is about 942 PSI. In some examples, the pressure is about 943 PSI. In some examples, the pressure is about 944 PSI. In some examples, the pressure is about 945 PSI. In some examples, the pressure is about 946 PSI. In some examples, the pressure is about 948 PSI. In some examples, the pressure is about 948 PSI. In some examples, the pressure is about 949 PSI. In some examples, the pressure is about 950 PSI. In some examples, the pressure is about 951 PSI. In some examples, the pressure is about 952 PSI. In some examples, the pressure is about 953 PSI. In some examples, the pressure is about 954 PSI. In some examples, the pressure is about 955 PSI. In some examples, the pressure is about 956 PSI. In some examples, the pressure is about 957 PSI. In some examples, the pressure is about 958 PSI. In some examples, the pressure is about 959 PSI. In some examples, the pressure is about 960 PSI. In some examples, the pressure is about 961 PSI. In some examples, the pressure is about 962 PSI. In some examples, the pressure is about 963 PSI. In some examples, the pressure is about 964 PSI. In some examples, the pressure is about 965 PSI. In some examples, the pressure is about 966 PSI. In some examples, the pressure is about 967 PSI. In some examples, the pressure is about 968 PSI. In some examples, the pressure is about 969 PSI. In some examples, the pressure is about 970 PSI. In some examples, the pressure is about 971 PSI. In some examples, the pressure is about 972 PSI. In some examples, the pressure is about 973 PSI. In some examples, the pressure is about 974 PSI. In some examples, the pressure is about 975 PSI. In some examples, the pressure is about 976 PSI. In some examples, the pressure is about 977 PSI. In some examples, the pressure is about 978 PSI. In some examples, the pressure is about 979 PSI. In some examples, the pressure is about 980 PSI. In some examples, the pressure is about 981 PSI. In some examples, the pressure is about 982 PSI. In some examples, the pressure is about 983 PSI. In some examples, the pressure is about 984 PSI. In some examples, the pressure is about 985 PSI. In some examples, the pressure is about 986 PSI. In some examples, the pressure is about 987 PSI. In some examples, the pressure is about 988 PSI. In some examples, the pressure is about 989 PSI. In some examples, the pressure is about 990 PSI. In some examples, the pressure is about 991 PSI. In some examples, the pressure is about 992 PSI. In some examples, the pressure is about 993 PSI. In some examples, the pressure is about 994 PSI. In some examples, the pressure is about 995 PSI. In some examples, the pressure is about 996 PSI. In some examples, the pressure is about 997 PSI. In some examples, the pressure is about 998 PSI. In some examples, the pressure is about 999 PSI.

In some examples, the uniaxial pressure is about 1000 PSI. In some examples, the pressure is about 1100 PSI. In some examples, the pressure is about 1200 PSI. In some examples, the pressure is about 1300 PSI. In some examples, the pressure is about 1400 PSI. In some examples, the pressure is about 1500 PSI. In some examples, the pressure is about 1600 PSI. In some examples, the pressure is about 1700 PSI. In some examples, the pressure is about 1800 PSI. In some examples, the pressure is about 1900 PSI.

In some examples, the uniaxial pressure is about 2000 PSI. In some examples, the pressure is about 2100 PSI. In some examples, the pressure is about 2200 PSI. In some examples, the pressure is about 2300 PSI. In some examples, the pressure is about 2400 PSI. In some examples, the pressure is about 2500 PSI. In some examples, the pressure is about 2600 PSI. In some examples, the pressure is about 2700 PSI. In some examples, the pressure is about 2800 PSI. In some examples, the pressure is about 2900 PSI.

In some examples, the uniaxial pressure is about 3000 PSI. In some examples, the pressure is about 3100 PSI. In some examples, the pressure is about 3200 PSI. In some examples, the pressure is about 3300 PSI. In some examples, the pressure is about 3400 PSI. In some examples, the pressure is about 3500 PSI. In some examples, the pressure is about 3600 PSI. In some examples, the pressure is about 3700 PSI. In some examples, the pressure is about 3800 PSI. In some examples, the pressure is about 3900 PSI.

In some examples, the uniaxial pressure is about 4000 PSI. In some examples, the pressure is about 4100 PSI. In some examples, the pressure is about 4200 PSI. In some examples, the pressure is about 4300 PSI. In some examples, the pressure is about 4400 PSI. In some examples, the pressure is about 4500 PSI. In some examples, the pressure is about 4600 PSI. In some examples, the pressure is about 4700 PSI. In some examples, the pressure is about 4800 PSI. In some examples, the pressure is about 4900 PSI.

In some examples, the pressure is about 5000 PSI.

In some examples, the cell applies both uniaxial and hydrostatic pressure to the stack. In some examples, the uniaxial pressure is 1-100 PSI and the hydrostatic pressure is 1-500 PSI.

In some examples, set forth herein is an electrochemical device including the electrochemical cell set forth herein. In some examples, the device is selected from a coin cell, a pouch cell, and a can cell. In certain examples, the device is a coin cell. In certain examples, the device is a pouch cell. In certain examples, the device is a can cell.

In some examples, set forth herein is an electrochemical device, including one or more electrode stacks, a hydrostatic material, an outer-shell material, and two conductive leads; wherein the electrode stack includes a lithium metal negative electrode, a solid-state electrolyte, and a positive electrode; wherein the hydrostatic material contacts the one or more electrode stacks and at least one surface of the outer-shell material; wherein the hydrostatic material is contained by an outer-shell material; and wherein the bulk modulus of the outer-shell material is greater than the bulk modulus of the hydrostatic material; wherein one conductive lead is in electrical contact with the lithium metal negative electrode and one tab; and wherein a second conductive lead is in electrical contact with the positive electrode and one cell tab.

An electrochemical device, including one or more electrode stacks, a hydrostatic material, an outer-shell material, a device housing which contains the electrochemical device, wherein the device housing includes at least two conductive lead tabs; wherein the electrode stack includes a lithium metal negative electrode, a solid-state electrolyte, and a positive electrode; wherein the hydrostatic material contacts the electrodes and at least one surface of the outer-shell material; wherein the hydrostatic material is contained by an outer-shell material; and wherein the bulk modulus of the outer-shell material is greater than the bulk modulus of the hydrostatic material; wherein one conductive lead tab is in electrical contact with the lithium metal negative electrode; and wherein a second conductive lead tab is in electrical contact with the positive electrode.

An electrochemical device, including one or more electrode stacks, a hydrostatic material, an outer-shell material, a device housing which contains the electrochemical device, wherein the device housing includes at least two conductive lead tabs; wherein the electrode stack includes: a lithium metal negative electrode, a solid-state electrolyte, and a positive electrode; wherein the electrode stack is contained within a hydrostatic material; wherein the hydrostatic material is contained by an outer-shell material; and wherein the bulk modulus of the outer-shell material is greater than the bulk modulus of the hydrostatic material; wherein one conductive lead tab is in electrical contact with the lithium metal negative electrode; and wherein a second conductive lead tab is in electrical contact with the positive electrode.

In some examples, set forth herein is an electrochemical cell including an electrode stack, and a compressible fluid, an electrochemical cell housing which contains the electrochemical device, wherein the device housing includes at least two conductive lead tabs; wherein the electrode stack includes a lithium metal negative electrode, a solid-state electrolyte, and a positive electrode; wherein the compressible fluid is between and in contact with the electrode stack and one tab; and wherein the compressible fluid maintains a hydrostatic pressure on the electrode stack. In some examples, the compressible fluid is a gas, a liquid or both.

In some of these examples, the tabs are in contact with a member selected from a coin cell, a pouch, and a can cell.

In some of these examples, the compressible fluid is a gas contained within the coin cell, pouch, or can cell. In some examples, the compressible fluid is contained within a liquid-tight bladder. In some examples, the compressible fluid is contained within a gas-tight bladder. In some examples, the compressible fluid is contained within a hermetically-sealed bladder. In some examples, the compressible fluid includes a liquid-gas mixture or a sublimating gas. In some examples, the compressible fluid is inert to lithium metal. In some examples, the compressible fluid includes ethane and toluene (TLU). In some examples, the compressible fluid includes equimolar amounts of ethane and toluene at a pressure of 72 PSI. In some examples, the compressible fluid includes non-polar solvent and a polar hydrocarbon. In some examples, the compressible fluid includes non-polar solvent and a polar solvent. In some examples, the compressible fluid (i.e., gas-spring) includes polar solvent and a non-polar hydrocarbon. In some examples, the compressible fluid includes MIDEL 7131 Synthetic Ester, MIDEL eN, mineral oil, or combinations thereof. In some examples, the compressible fluid includes a hydrocarbon and a noble gas. In some examples, the hydrocarbon is a linear or branched alkane. In some examples, the noble gas is He, Ne, Kr, or Ar.

In some examples, the compressible fluid includes a linear or aromatic hydrocarbon (liquid or gas) and a noble gas. In some examples, the compressible fluid includes polyethylene. In some examples, the compressible fluid includes heptane.

In some examples, set forth herein is a pressurized stack including an electrode stack: wherein the electrode stack is pressurized; wherein the electrode stack includes: a lithium metal negative electrode, a solid-state electrolyte, and a positive electrode; wherein the stack maintains at least 50% of the surface area of the solid electrolyte in contact with the lithium metal when discharged at a temperature of about 0° C. to about 150° C. and at a current density of about 0.1 mA/cm² to about 10 mA/cm².

In some examples, set forth herein is a pressurized electrochemical cell including an electrode stack wherein the electrode stack includes a lithium metal negative electrode, a solid-state electrolyte, and a positive electrode; wherein the pressurized electrochemical cell inhibits an increase in electrochemical cell's bulk interfacial resistance by more than a factor of 10 when discharged at a temperature of about 0° C. to about 150° C. and at a current density of about 0.1 mA/cm² to about 10 mA/cm².

In some examples, the pressurized electrochemical cell is an electrochemical cell set forth herein. In some examples, the cell maintains an isotropic pressure. In some examples, the isotropic pressure is 0-5000 psi. In some examples, the cell maintains a hydrostatic pressure. In some examples, the hydrostatic pressure is 0-5000 psi. In some examples, the cell maintains a uniaxial pressure. In some examples, the uniaxial pressure is 0-5000 psi.

In some examples, the solid-state electrolyte is selected from the group consisting of a lithium-stuffed garnet, a lithium sulfide, a lithium borohydride, a lithium oxide, a lithium carbonate, a lithium nitride, a lithium titanium aluminum phosphate, a lithium germanium aluminum phosphate, a lithium germanium titanium aluminum phosphate, OHARA glass, LIPON, NASICON, LISICON, and combinations thereof.

In some examples, the solid-state electrolyte is of a lithium-stuffed garnet. In some examples, the solid-state electrolyte is a lithium sulfide. In some examples, the solid-state electrolyte is a lithium borohydride. In some examples, the solid-state electrolyte is a lithium oxide. In some examples, the solid-state electrolyte is a lithium carbonate. In some examples, the solid-state electrolyte is a lithium nitride. In some examples, the solid-state electrolyte is a lithium titanium aluminum phosphate. In some examples, the solid-state electrolyte is a lithium germanium aluminum phosphate. In some examples, the solid-state electrolyte is a lithium germanium titanium aluminum phosphate. In some examples, the solid-state electrolyte is a OHARA glass. In some examples, the solid-state electrolyte is LIPON. In some examples, the solid-state electrolyte is a NASICON, LISICON, and combinations thereof.

In some examples, the solid-state electrolyte includes at least two or more solid-state electrolytes in a layered configuration.

In some examples, the solid-state electrolyte includes a composite including a non-conducting polymer and a conducting ceramic phase. In some examples, the solid-state electrolyte further includes a polymer. In some examples, the solid-state electrolyte is swollen with a liquid or gel electrolyte.

In some examples, the solid-state electrolyte is characterized by a fracture toughness of 1.2-1.5 MPa-m^{1/2}. In some examples, the solid-state electrolyte has a fracture strength of 500-1500 MPa when measured by ring-on-ring biaxial flexure.

In some examples, the solid-state electrolyte is characterized by a Young's Modulus of 10-500 GPa.

In some examples, the solid-state electrolyte has a defect density less than 5% by volume.

In some examples, the solid-state electrolyte has a surface defect density less than 5% by surface area.

In some examples, the solid-state electrolyte has a surface roughness less than 1 μm Ra.

In some examples, the solid-state electrolyte is a sintered solid-state electrolyte having a density from at least 95% theoretical density to 100% theoretical density.

In some examples, the cell is pressurized to at least 100 PSI.

In some examples, the cell is pressurized to at least 200 PSI.

In some examples, the cell is pressurized to at least 300 PSI.

In some examples, the anode is surrounded by a fluid. In some of these examples, the anode is surrounded by a fluid under pressure. In some examples, the anode is surrounded by a incompressible fluid in pressure.

In some examples, the electrochemical cell or the pressurized electrochemical cell applies a pressure to the lithium metal anode sufficient to maintain or inhibit a decrease in the active surface area of the lithium metal anode, wherein the active surface area is the surface area of the lithium metal anode which is in direct contact with the solid-state electrolyte.

In some examples, the electrochemical cell or the pressurized electrochemical cell includes a port for conducting gases in and out of the electrochemical cell.

In some examples, the electrochemical cell or the pressurized electrochemical cell includes a gel electrolyte.

In some examples, set forth herein is an electrochemical cell including an electrode stack, a hydrostatic material, and an outer-shell material, wherein: the electrode stack includes a lithium metal negative electrode, a solid-state electrolyte, and a positive electrode; wherein the electrode stack is contained within a hydrostatic material; wherein the hydrostatic material is contained by an outer-shell material; wherein the bulk modulus of the outer-shell material is greater than the bulk modulus of the hydrostatic material.

In some examples, the hydrostatic material is not conductive to electrons or ions.

In some examples, the hydrostatic material is an incompressible fluid.

In some examples, the electrochemical cell or pressurized electrochemical cell further including conductive leads, wherein the conductive leads are in contact with the electrode stack and extend through the hydrostatic material and outer-shell material.

In some examples of an electrochemical cell or pressurized stack set forth herein, the hydrostatic material is selected from polyisobutylene, butylpolypropylene, ethylene propylene diene monomer, polypropylene, and thermoplastic olefin.

In some examples of an electrochemical cell or pressurized stack set forth herein, the bulk modulus of the hydrostatic material is <1 GPa.

In some examples of an electrochemical cell or pressurized stack set forth herein, the outer-shell material is selected from a polyester material: acrylonitrile-butadiene-styrene, polycarbonate (PC), polyethylene tetra phthalate, polyether ether ketone, and polyetherketone ketone.

In some examples of an electrochemical cell or pressurized stack set forth herein, the bulk modulus of the outer-shell material is >1 GPa.

In some examples set forth herein, the electrochemical cell maintains a pressure magnitude that varies by less than 20% across the electrode stack. In some examples, the pressure magnitude varies by less than 19% across the electrode stack. In some examples, the pressure magnitude varies by less than 18% across the electrode stack. In some examples, the pressure magnitude varies by less than 17% across the electrode stack. In some examples, the pressure magnitude varies by less than 16% across the electrode stack. In some examples, the pressure magnitude varies by less than 15% across the electrode stack. In some examples, the pressure magnitude varies by less than 14% across the electrode stack. In some examples, the pressure magnitude varies by less than 13% across the electrode stack. In some examples, the pressure magnitude varies by less than 12% across the electrode stack. In some examples, the pressure magnitude varies by less than 11% across the electrode stack. In some examples, the pressure magnitude varies by less than 10% across the electrode stack. In some examples, the pressure magnitude varies by less than 9% across the electrode stack. In some examples, the pressure magnitude varies by less than 9% across the electrode stack. In some examples, the pressure magnitude varies by less than 7% across the electrode stack. In some examples, the pressure magnitude varies by less than 6% across the electrode stack. In some examples, the pressure magnitude varies by less than 5% across the electrode stack. In some examples, the pressure magnitude varies by less than 4% across the electrode stack. In some examples, the pressure magnitude varies by less than 3% across the electrode stack. In some examples, the pressure magnitude varies by less than 2% across the electrode stack. In some examples, the pressure magnitude varies by less than 1% across the electrode stack. In some examples, this pressure magnitude variance is measured by using pressure paper in a mock-up assembly of the electrode stack.

In some examples, set forth herein is an electrochemical cell including one or more electrode stacks, a hydrostatic material, and an outer-shell material, wherein each of the one or more electrode stacks comprises a lithium metal negative electrode, a solid-state electrolyte, and a positive electrode; wherein the hydrostatic material contacts the one or more electrode stacks; wherein the hydrostatic material is contained by an outer-shell material; and wherein the bulk modulus of the outer-shell material is greater than the bulk modulus of the hydrostatic material.

In some examples, the hydrostatic material contacts the sides of the one or more electrode stacks and the outer-shell material partially surrounds the hydrostatic material to contain the hydrostatic material.

In some examples, the hydrostatic material directly contacts the outer-shell material.

In some examples, the hydrostatic material is an insulator.

In some examples, the hydrostatic material is an electrical insulator.

In some examples, the hydrostatic material is not conductive to electrons or ions.

In some examples, the hydrostatic material is a fluid.

In some examples, the hydrostatic material is a Newtonian fluid.

In some examples, the hydrostatic material is an incompressible fluid.

In some examples, the bulk modulus of the hydrostatic material is 10-5000 MPa.

In some examples, the electrochemical cell further includes conductive leads.

In some examples, the conductive leads are in contact with the electrode stack and extend through both the hydrostatic material and the outer-shell material.

In some examples, the conductive leads are integrated into a can cell housing which contains the electrochemical cell.

In some examples, the hydrostatic material is selected from polyisobutylene, butyl polypropylene, ethylene propylene diene monomer, polypropylene, and thermoplastic olefin.

In some examples, the hydrostatic material is a gas.

In some examples, the polyisobutylene has a molecular weight of 10,000-50,000 g/mol.

In some examples, the outer-shell material is selected from a metal, alloy, or combination thereof.

In some examples, the metal or alloy is steel or aluminum.

In some examples, the outer-shell material is selected from a polyester material.

In some examples, the polyester material is selected from acrylonitrile-butadiene-styrene, PC, polyethylene terephthalate, polyether ether ketone, and polyetherketone ketone.

In some examples, the bulk modulus of the hydrostatic material is less than 1 GPa.

In some examples, the bulk modulus of the hydrostatic material is greater than 1 GPa.

In some examples, the cell maintains an isotropic pressure on the one or more stacks.

In some examples, the isotropic pressure is between 0-5000 pounds per square inch (PSI) gauge.

In some examples, the cell maintains a hydrostatic pressure.

In some examples, the hydrostatic pressure is between 0-5000 PSI.

In some examples, the hydrostatic pressure is applied via a gas.

In some examples, the cell maintains a uniaxial pressure.

In some examples, the uniaxial pressure is between 0-5000 PSI.

In some examples, the cell maintains a pressure magnitude that varies by less than 20% across the electrode stack.

In some examples, the cell maintains a pressure magnitude that varies by less than 20% across a surface area of 100 μm² of the electrode stack.

In some examples, the cell maintains a pressure magnitude that varies by less than 20% across a surface area of 1,000 μm² of the electrode stack.

In some examples, the cell maintains a pressure magnitude that varies by less than 20% across a surface area of 10,000 μm² of the electrode stack.

In some examples, the cell maintains a pressure magnitude that varies by less than 20% across a surface area of at least 1000 μm² of the electrode stack.

### D. Method of Using

In some examples, set forth herein is a method of using the electrochemical cell or the pressurized electrochemical cell set forth herein, the method including discharging the stack at a current density of about 0.01 mA/cm² to about 10 mA/cm² and at a temperature of about −30° C. to about 150° C.; and maintaining at least 50% of the active surface area of the lithium metal. In some examples, the methods maintain 60% of the active surface area of the lithium metal. In some examples, the methods maintain 70% of the active surface area of the lithium metal. In some examples, the methods maintain 80% of the active surface area of the lithium metal. In some examples, the methods maintain 90% of the active surface area of the lithium metal. In some examples, the methods maintain 91% of the active surface area of the lithium metal. In some examples, the methods maintain 92% of the active surface area of the lithium metal. In some examples, the methods maintain 93% of the active surface area of the lithium metal. In some examples, the methods maintain 94% of the active surface area of the lithium metal. In some examples, the methods maintain 95% of the active surface area of the lithium metal. In some examples, the methods maintain 96% of the active surface area of the lithium metal. In some examples, the methods maintain 97% of the active surface area of the lithium metal. In some examples, the methods maintain 98% of the active surface area of the lithium metal. In some examples, the methods maintain 99% of the active surface area of the lithium metal. The percent active surface area of lithium metal is measured by monitoring the change in area-specific resistance of the electrode or by capacitance measurement via EIS.

In some examples, set forth herein is a method of using the electrochemical cell or the pressurized electrochemical cell set forth herein, including discharging the stack at a current density of about 0.01 mA/cm² to about 10 mA/cm² and at a temperature of about −30° C. to about 150° C.; and inhibiting an increase in the electrochemical cell or pressurized stack's interfacial resistance by more than a factor of 1.50.

In some examples, the methods include discharging the stack at a current density of at least 1 mA/cm². In some examples, the methods include discharging the stack at a current density of at least 2 mA/cm². In some examples, the methods include discharging the stack at a current density of at least 3 mA/cm². In some examples, the methods include discharging the stack at a current density of at least 4 mA/cm². In some examples, the methods include discharging the stack at a current density of at least 5 mA/cm². In some examples, the methods include discharging the stack at a current density of at least 6 mA/cm². In some examples, the methods include discharging the stack at a current density of at least 7 mA/cm². In some examples, the methods include discharging the stack at a current density of at least 8 mA/cm². In some examples, the methods include discharging the stack at a current density of at least 9 mA/cm². In some examples, the methods include discharging the stack at a current density of at least 10 mA/cm².

### E. Methods of Making

In some examples, provided herein are methods for making an electrochemical cell including one or more electrode stacks, a hydrostatic material, and an outer-shell material, wherein the one or more electrode stacks comprise a lithium metal negative electrode, a solid-state electrolyte, and a positive electrode; wherein the hydrostatic material contacts one of more of the stacks; wherein the hydrostatic material is contained by an outer-shell material; and wherein the bulk modulus of the outer-shell material is greater than the bulk modulus of the hydrostatic material. These methods, in some examples, include the following steps.

In a first step, a positive electrode is stacked on top of, laminated to, or cast on a solid-state electrolyte. In some examples, a gel electrolyte is placed between the positive electrode and the solid-state electrolyte. In a second step, lithium metal is laminated to or deposited on the solid-state electrolyte on the face opposite the face in direct contact with the positive electrode. These two steps result in an electrode stack. In some examples, the lithium metal anode is plated upon the first charge.

In some examples, the electrode stack is then placed in an outer-shell material and conductive leads are connected to the stack and through the shell. Then, the outer-shell material is closed so it seals the electrode stack. Then a material is introduced by injection into the closed and sealed electrode stack. In some examples, this material introduced is a hydrostatic material. In some examples, this material introduced is a gas. In some examples, this material introduced is a gas-liquid combination.

In some other examples, provided herein are methods for making an electrochemical cell including one or more electrode stacks, a hydrostatic material, and an outer-shell material, wherein the one or more electrode stacks comprise a lithium metal negative electrode, a solid-state electrolyte, and a positive electrode; wherein the hydrostatic material contacts one of more of the stacks; wherein the hydrostatic material is contained by an outer-shell material; and wherein the bulk modulus of the outer-shell material is greater than the bulk modulus of the hydrostatic material. These methods, in some examples, include the following steps.

In a first step, a positive electrode is stacked on top of a solid-state electrolyte. In some examples, a gel electrolyte is placed between the positive electrode and the solid-state electrolyte. In a second step, lithium metal is laminated to or deposited on the solid-state electrolyte on the face opposite the face in direct contact with the positive electrode. These two steps result in an electrode stack.

In some examples, the electrode stack is then placed in an outer-shell material and conductive leads are connected to the stack and through the shell. Then, a material is introduced by injection into the closed and sealed electrode stack. In some examples, this material introduced is a hydrostatic material. In some examples, this material introduced is a gas. In some examples, this material introduced is a gas-liquid combination. Then, the resulting assembly is placed in a pressure chamber and pressurized to a pressure above atmospheric pressure. Lastly, the outer-shell material is closed so it seals the electrode stack.

### F. Examples

### Example 1

An electrochemical stack, in a pouch cell, including a positive electrode, a lithium-stuffed garnet solid electrolyte, and a lithium metal negative electrode was prepared. The positive electrode was a mixture of Nickel-Manganese-Cobalt (NMC) oxide, conductive additive and binder cast on 12 μm aluminum foil with 4 mAh/cm² loading. The electrode was calendered. The positive electrode was soaked in EC:EMC with 1M dissolved LiPF₆. Around this electrochemical stack, a polyisobutylene (PIB) hydrostatic media and a steel outer-shell were constructed to seal the electrochemical stack and apply pressure thereto.

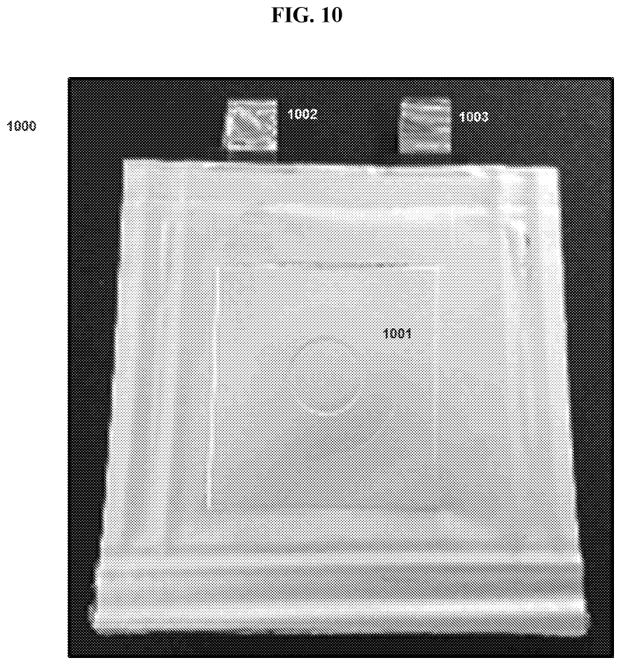

A picture of the pouch cell is shown in FIG. 10. In FIG. 10, pouch cell, 1000, has tabs 1002 and 1003 which extend through polyisobutylene (PIB) hydrostatic media and a steel outer-shell around the electrochemical cell, which is inside a pouch, 1001.

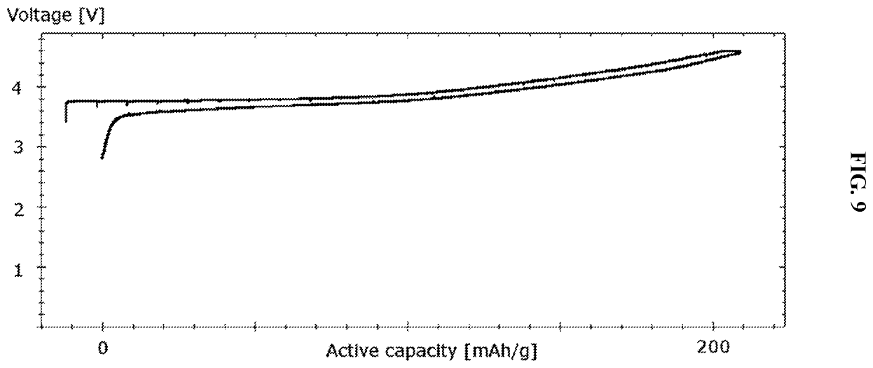

The electrochemical stack was discharged and charged at current rates of C/10 for the first, formation cycle and C/3 thereafter at 45° C. between 2.7-4.5V. Voltage was monitored during the test, and plots of voltage versus active mass-specific capacity, mAh/g is shown in FIG. 9.

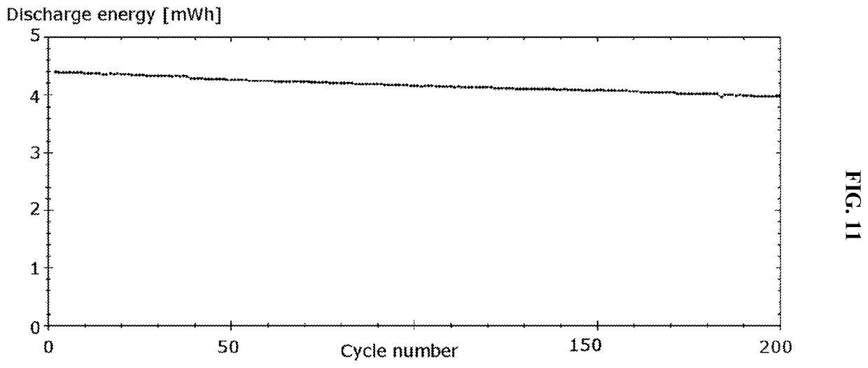

Discharge energy and capacity was calculated during the test from the data in FIG. 9. FIG. 11 shows discharge energy for the coin cells having a PIB hydrostatic media and steel outer-shell.

### Example 2

A multilayer cell was assembled from stacks of Example 1 and placed into a fixture that applied 1-50 PSI gauge of uniaxial pressure and 1-600 PSI gauge of argon to apply hydrostatic pressure. Multilayer cells in this fixture were cycled with a GITT protocol described in Example 1 and completed the test without failing. The fixture is illustrated in FIG. 13.

### Example 3

A multilayer cell was assembled from stacks of Example 1 and placed under uniaxial pressure of 200-600PSI gauge. The cells fractured and did not complete one cycle.

The embodiments and examples described above are intended to be merely illustrative and non-limiting. Those skilled in the art will recognize or will be able to ascertain using no more than routine experimentation, numerous equivalents of specific compounds, materials and procedures. All such equivalents are considered to be within the scope and are encompassed by the appended claims.

What is claimed is:

1. An electrochemical cell comprising one or more electrode stacks and a pressure-inducing element, wherein each electrode stack comprises a lithium metal negative electrode, a solid-state electrolyte, and a positive electrode, and wherein the pressure-inducing element is in direct contact with the one or more electrode stacks or with a positive electrode current collector or a negative electrode current collector which is in direct contact with the one or more electrode stacks.

2. The electrochemical cell of claim 1, wherein a pressure-inducing element is in direct contact with either or both of the lithium metal negative electrode or the positive electrode.

3. The electrochemical cell of claim 1, wherein the pressure-inducing element is in direct contact with the lithium metal negative electrode of one electrode stack and the positive electrode of another electrode stack.

4. The electrochemical cell of claim 1 or 2, wherein a pressure-inducing element is in direct contact with either or both of the negative electrode current collector or the positive electrode current collector.

5. The electrochemical cell of claim 2, wherein the pressure-inducing element is in direct contact with the negative electrode current collector of one electrode stack and the positive electrode of another electrode stack.

6. An electrochemical cell comprising:
a positive electrode current collector foil having a first side and a second side;
a first positive electrode and a second positive electrode, wherein the first positive electrode contacts the first side of the positive electrode current collector foil and wherein the second positive electrode contacts the second side of the positive electrode current collector foil;
a first solid-state electrolyte and a second solid-state electrolyte, wherein the first solid-state electrolyte contacts the first positive electrode and wherein the second solid-state electrolyte contacts the second positive electrode;
a first lithium metal negative electrode and a second lithium metal negative electrode, wherein the first lithium metal negative electrodes contacts the first solid-state electrolyte and wherein the second lithium metal negative electrode contacts the second solid-state electrolyte;
a first negative electrode current collector and a second current collector, wherein the first negative electrode contacts the first lithium metal negative electrode and wherein the second negative electrode current collector contacts the second lithium metal negative electrode; and
a pressure-inducing element in contact with either the first negative electrode current collector or the second negative electrode current collector.

7. The electrochemical cell of claim 6, further comprising a bonding layer between the positive electrode and the solid-state electrolyte.

8. The electrochemical cell of claim 7, wherein the bonding layer is a gel or liquid electrolyte.

9. The electrochemical cell of any one of claims 6-8, wherein a pressure-inducing element is in direct contact with either the first lithium metal negative electrode, the second lithium metal negative electrode, the first positive electrode, or the second positive electrode

10. The electrochemical cell of any one of claims 6-9, wherein a pressure-inducing element is in direct contact with either or both of the first negative electrode current collector or the second negative electrode current collector.

11. The electrochemical cell of any one of claims 6-9, wherein a pressure-inducing element is in direct contact with either or both of the first negative electrode current collector or the second negative electrode current collector.

12. An electrochemical cell comprising one or more electrode stacks, a hydrostatic material, and an outer-shell material, wherein
each of the one or more electrode stacks comprises a lithium metal negative electrode, a solid-state electrolyte, and a positive electrode;
wherein the hydrostatic material contacts the one or more electrode stacks;
wherein the hydrostatic material is contained by an outer-shell material;
wherein the bulk modulus of the outer-shell material is greater than the bulk modulus of the hydrostatic material.

13. The electrochemical cell of claim 12, wherein the hydrostatic material contacts the sides of the one or more electrode stacks and the outer-shell material partially surrounds the hydrostatic material to contain the hydrostatic material.

14. The electrochemical cell of claim 12, wherein the hydrostatic material directly contacts the outer-shell material.

15. The electrochemical cell of any one of claims 12-14, wherein the hydrostatic material is an insulator.

16. The electrochemical cell of any one of claims 12-15, wherein the hydrostatic material is an electrical insulator.

17. The electrochemical cell of any one of claims 12-16, wherein the hydrostatic material is not conductive to electrons or ions.

18. The electrochemical cell of any one of claims 12-16, wherein the hydrostatic material is a fluid.

19. The electrochemical cell of claim 18, wherein the hydrostatic material is a Newtonian fluid.

20. The electrochemical cell of claim 18 or 19, wherein the hydrostatic material is an incompressible fluid.

21. The electrochemical cell of any one of claims 12-20, wherein the bulk modulus of the hydrostatic material is 10-5000 MPa.

22. The electrochemical cell of any one of claims 12-21, further comprising conductive leads, wherein the conductive leads are in contact with the electrode stack and extend through both the hydrostatic material and the outer-shell material.

23. The electrochemical cell of claim 22, wherein the conductive leads are integrated into a can cell housing which contains the electrochemical cell.

24. The electrochemical cell of any one of claims 12-23, wherein the hydrostatic material is selected from polyisobutylene, butyl polypropylene, ethylene propylene diene monomer, polypropylene, and thermoplastic olefin.

25. The electrochemical cell of any one of claims 12-24, wherein the hydrostatic material is a gas.

26. The electrochemical cell of claim 24, wherein the polyisobutylene has a molecular weight of 10,000-50,000 g/mol.

27. The electrochemical cell of any one of claims 12-26, wherein the outer-shell material is selected from a metal, alloy, or combination thereof.

28. The electrochemical cell of claim 27, wherein the metal or alloy is steel or aluminum.

29. The electrochemical cell of any one of claims 12-26, wherein the outer-shell material is selected from a polyester material.

30. The electrochemical cell of claim 29, wherein the polyester material is selected from acrylonitrile-butadiene-styrene, PC, polyethylene terephthalate, polyether ether ketone, and polyetherketone ketone.

31. The electrochemical cell of any one of claims 12-30, wherein the bulk modulus of the hydrostatic material is less than 1 GPa.

32. The electrochemical cell of any one of claims 12-31, wherein the bulk modulus of the hydrostatic material is greater than 1 GPa.

33. The electrochemical cell of any one of claims 12-32, wherein the cell maintains an isotropic pressure on the one or more stacks.

34. The electrochemical cell of any one of claims 12-33, wherein the isotropic pressure is between 0-5000 pounds per square inch (PSI) gauge.

35. The electrochemical cell of any one of claims 12-34, wherein the cell maintains a hydrostatic pressure.

36. The electrochemical cell of claim 35, wherein the hydrostatic pressure is between 0-5000 PSI gauge.

37. The electrochemical cell of claim 35 or 36, wherein the hydrostatis pressure is applied via a gas.

38. The electrochemical cell of any one of claims 12-37, wherein the cell maintains a uniaxial pressure.

39. The electrochemical cell of claim 38, wherein the uniaxial pressure is between 0-5000 PSI gauge.

40. The electrochemical cell of any one of claims 12-39, wherein the cell maintains a pressure magnitude that varies by less than 20% across the electrode stack.

41. The electrochemical cell of claim 40, wherein the cell maintains a pressure magnitude that varies by less than 20% across a surface area of 100 μm² of the electrode stack.

42. The electrochemical cell of claim 40, wherein the cell maintains a pressure magnitude that varies by less than 20% across a surface area of 1,000 μm² of the electrode stack.

43. The electrochemical cell of claim 40, wherein the cell maintains a pressure magnitude that varies by less than 20% across a surface area of 10,000 μm² of the electrode stack.

44. The electrochemical cell of claim 40, wherein the cell maintains a pressure magnitude that varies by less than 20% across a surface area of at least 1000 μm² of the electrode stack.

45. An electrochemical device comprising the electrochemical cell of any one of claims 1-44.

46. The electrochemical device of claim 45, wherein the device is selected from a coin cell, a pouch cell, and a can cell.

47. An electrochemical device, comprising one or more electrode stacks, a hydrostatic material, an outer-shell material, and two conductive leads;
wherein each of the one or more electrode stacks comprises:
a lithium metal negative electrode, a solid-state electrolyte, and a positive electrode;
wherein the hydrostatic material contacts the one or more electrode stacks and at least one surface of the outer-shell material;
wherein the hydrostatic material is contained by an outer-shell material; and
wherein the bulk modulus of the outer-shell material is greater than the bulk modulus of the hydrostatic material;
wherein one conductive lead is in electrical contact with the lithium metal negative electrode and one tab; and
wherein a second conductive lead is in electrical contact with the positive electrode and one cell tab.

48. The electrochemical device of claim 47, wherein the conductive leads are current collectors, which have a tab at one end.

49. An electrochemical device, comprising one or more electrode stacks, a hydrostatic material, an outer-shell material, and a device housing which contains the electrochemical device,
wherein the device housing comprises at least two conductive lead tabs;
wherein each of the one or more electrode stacks comprises:
a lithium metal negative electrode, a solid-state electrolyte, and a positive electrode;
wherein the hydrostatic material contacts the lithium metal negative electrode and positive electrode and at least one surface of the outer-shell material;
wherein the hydrostatic material is contained by an outer-shell material; and
wherein the bulk modulus of the outer-shell material is greater than the bulk modulus of the hydrostatic material;
wherein one conductive lead tab is in electrical contact with the lithium metal negative electrode; and
wherein a second conductive lead tab is in electrical contact with the positive electrode.

50. An electrochemical device, comprising one or more electrode stacks, a hydrostatic material, an outer-shell material, a device housing which contains the electrochemical device,
wherein the device housing comprises at least two conductive lead tabs;
wherein each of the one or more electrode stacks comprises:
a lithium metal negative electrode, a solid-state electrolyte, and a positive electrode;
wherein the electrode stack is contained within a hydrostatic material;
wherein the hydrostatic material is contained by an outer-shell material; and
wherein the bulk modulus of the outer-shell material is greater than the bulk modulus of the hydrostatic material;
wherein one conductive lead tab is in electrical contact with the lithium metal negative electrode; and
wherein a second conductive lead tab is in electrical contact with the positive electrode.

51. An electrochemical cell comprising at least one electrode stack, a compressible fluid, an electrochemical cell housing which contains the remainder of the electrochemical device,
wherein the device housing comprises at least two conductive lead tabs;
wherein the electrode stack comprises a lithium metal negative electrode, a solid-state electrolyte, and a positive electrode;
wherein the compressible fluid is between and in contact with the electrode stack and one tab; and
wherein the compressible fluid maintains a hydrostatic pressure on the electrode stack.

52. The electrochemical cell of claim 51, wherein the compressible fluid is a sublimating gas that applies a gas pressure to the electrode stack.

53. The electrochemical cell of claim 51 or 52, wherein the tabs are in contact with a member selected from a coin cell, a pouch, and a can cell.

54. The electrochemical cell of claim 52, wherein the compressible fluid is a gas contained within the coin cell, pouch, or can cell.

55. The electrochemical cell of claim 51, wherein the compressible fluid is contained within a liquid-tight bladder.

56. The electrochemical cell of claim 51, wherein the compressible fluid is contained within a gas-tight bladder.

57. The electrochemical cell of claim 51, wherein the compressible fluid is contained within a hermetically-sealed bladder.

58. The electrochemical cell of any one of claims 51 to 57, wherein the compressible fluid comprises a liquid-gas mixture or a sublimating solid-gas.

59. The electrochemical cell of any one of claims 51-58, wherein the compressible fluid is inert to lithium metal.

60. The electrochemical cell of any one of claims 51-58, wherein the compressible fluid comprises ethane and toluene.

61. The electrochemical cell any one of claims 51-60, wherein the compressible fluid comprises equimolar amounts of ethane and toluene at a pressure of 72 PSI.

62. The electrochemical cell of any one of claims 51-58, wherein the compressible fluid comprises a non-polar solvent and a polar hydrocarbon.

63. The electrochemical cell of any one of claims 51-58, wherein the compressible fluid comprises a polar solvent and a non-polar hydrocarbon.

64. The electrochemical cell of any one of claims 51-58, wherein the compressible fluid comprises MIDEL 7131 Synthetic Ester, MIDEL eN, mineral oil, or combinations thereof.

65. The electrochemical cell of any one of claims 51-58, wherein the compressible fluid comprises fatty acids, C₅₋₁₀ linear alkanes, C₅₋₁₀ branched alkanes branched, pentaerythritol, mixed esters with pentaerythritol.

66. The electrochemical cell of any one of claims 51-58, wherein the compressible fluid comprises a mixture of a hydrocarbon and a noble gas.

67. The electrochemical cell of any one of claims 51-58, wherein the compressible fluid comprises a linear or aromatic hydrocarbon and a noble gas.

68. The electrochemical cell of any one of claims 51-58, wherein the compressible fluid comprises ethylene.

69. The electrochemical cell of any one of claims 51-48, wherein the compressible fluid comprises heptane

70. The electrochemical cell of any one of claims 51-58, wherein the compressible fluid is a fluid in liquid-vapor equilibrium.

71. The electrochemical cell of any one of claims 51-70, wherein the compressible fluid is contained within a fluid-tight bladder.

72. The electrochemical cell of any one of claims 51-70, wherein the compressible fluid is contained within a hermetically-sealed bladder.

73. A pressurized stack comprising at least one electrode stack:
wherein the electrode stack is pressurized;
wherein the electrode stack comprises:
a lithium metal negative electrode, a solid-state electrolyte, and a positive electrode;
wherein the stack maintains at least 50% of the surface area of the solid electrolyte in contact with the lithium metal when discharged at a temperature of about −30° C. to about 150° C. and at a current density of about 0.1 mA/cm² to about 10 mA/cm².

74. A pressurized electrochemical cell comprising at least one electrode stack:
wherein the electrode stack comprises:
a lithium metal negative electrode, a solid-state electrolyte, and a positive electrode;
wherein the pressurized electrochemical cell inhibits an increase in electrochemical cell's bulk interfacial resistance by more than a factor of 10 when discharged at a temperature of about −30° C. to about 150° C. and at a current density of about 0.1 mA/cm² to about 10 mA/cm².

75. The pressurized electrochemical cell of claim 73 or 74, wherein the cell maintains an isotropic pressure.

76. The pressurized electrochemical cell of claim 75 wherein the isotropic pressure is 0-5000 psi.

77. The pressurized electrochemical cell of claim 73 or 74, wherein the cell maintains a hydrostatic pressure.

78. The pressurized electrochemical cell of claim 77, wherein the hydrostatic pressure is 0-5000 psi.

79. The pressurized electrochemical cell of claim 73 or 74, wherein the cell maintains a uniaxial pressure.

80. The pressurized electrochemical cell of claim 79, wherein the uniaxial pressure is 0-5000 psi.

81. The electrochemical cell of any one of claims 1-72 or the pressurized electrochemical cell of any one of claims 73-80, wherein the solid-state electrolyte is selected from the group consisting of a lithium-stuffed garnet, a lithium sulfide, a lithium borohydride, a lithium oxide, a lithium carbonate, a lithium nitride, a lithium titanium aluminum phosphate, a lithium germanium aluminum phosphate, a lithium germanium titanium aluminum phosphate, OHARA glass, LIPON, NASICON, LISICON, and combinations thereof.

82. The electrochemical cell or the pressurized electrochemical cell of claim 81, wherein the solid-state electrolyte comprises at least two or more solid-state electrolytes in a layered configuration.

83. The electrochemical cell or the pressurized electrochemical cell of claim 81, wherein the solid-state electrolyte comprises a composite comprising a non-conducting polymer and a conducting ceramic phase.

84. The electrochemical cell or the pressurized electrochemical cell of claim 81, wherein the solid-state electrolyte further comprises a polymer.

85. The electrochemical cell or the pressurized electrochemical cell of claim 1, wherein the solid-state electrolyte is swollen with a liquid or gel electrolyte.

86. The electrochemical cell or the pressurized electrochemical cell of claim 81, wherein the solid-state electrolyte is characterized by a fracture toughness of 1.2-1.5 MPa-m².

87. The electrochemical cell or the pressurized electrochemical cell of claim 81, wherein the solid-state electrolyte is characterized by a Young's Modulus of 10-500 GPa.

88. A method of using the electrochemical cell or the pressurized electrochemical cell of claim 81, comprising
discharging the stack at a current density of about 0.01 mA/cm² to about 10 mA/cm² and at a temperature of about −30° C. to about 150° C.; and
maintaining at least 50% of the active surface area of the lithium metal.

89. The electrochemical cell or the pressurized electrochemical cell of claim 81, wherein the solid-state electrolyte has a defect density less than 5% by volume.

90. The electrochemical cell or the pressurized electrochemical cell of claim 81, wherein the solid-state electrolyte has a surface defect density less than 5% by surface area.

91. The electrochemical cell or the pressurized electrochemical cell of claim 81, wherein the solid-state electrolyte has a surface roughness less than 1 nm Ra.

92. The electrochemical cell or the pressurized electrochemical cell of claim 81, wherein the solid-state electrolyte is a sintered solid-state electrolyte having a density from at least 95% theoretical density to 100% theoretical density.

93. The electrochemical cell or the pressurized electrochemical cell of claim 81, wherein the electrochemical cell is pressurized to at least 100 PSI at 30° C.

94. The electrochemical cell or the pressurized electrochemical cell of claim 81, wherein the electrochemical cell is pressurized to at least 200 PSI at 30° C.

95. The electrochemical cell or the pressurized electrochemical cell of claim 81, wherein the electrochemical cell is pressurized to at least 300 PSI at 30° C.

96. The electrochemical cell or the pressurized electrochemical cell of claim 81, wherein the anode is surrounded by a fluid.

97. The electrochemical cell or the pressurized electrochemical cell of claim 81, wherein the anode is surrounded by a fluid under pressure.

98. The electrochemical cell or the pressurized electrochemical cell of claim 81, wherein the anode is surrounded by a incompressible fluid in pressure.

99. The electrochemical cell or the pressurized electrochemical cell of claim 81, wherein the electrochemical cell or the pressurized electrochemical cell applies a pressure to the lithium metal anode sufficient to maintain or inhibit a decrease in the active surface area of the lithium metal anode, wherein the active surface area is the surface area of the lithium metal anode which is in direct contact with the solid-state electrolyte.

100. The electrochemical cell or the pressurized electrochemical cell of claim 81, wherein the electrochemical cell or the pressurized electrochemical cell comprises a port for conducting gases in and out of the electrochemical cell.

101. The electrochemical cell or the pressurized electrochemical cell of claim 81, wherein the electrochemical cell or the pressurized electrochemical cell comprises a gel electrolyte.

102. A method of using the electrochemical cell of claim 81, comprising
discharging the stack at a current density of about 0.01 mA/cm² to about 10 mA/cm² and at a temperature of about −30° C. to about 150° C.; and
maintaining at least 50% of the active surface area of the lithium metal.

103. A method of using the electrochemical cell of claim 81, comprising
discharging the stack at a current density of about 0.01 mA/cm² to about 10 mA/cm² and at a temperature of about −30° C. to about 150° C.; and
inhibiting an increase in the electrochemical cell or pressurized stack's interfacial resistance by more than a factor of 10.

104. The method of claim 103, wherein inhibiting an increase in the electrochemical cell or pressurized stack's interfacial resistance by more than a factor of 10 comprising applying pressure.

105. The method of claim 103, wherein inhibiting an increase in the electrochemical cell or pressurized stack's interfacial resistance by more than a factor of 10 comprising applying pressure of at least 100 PSI.

106. The method of claim 103, wherein inhibiting an increase in the electrochemical cell or pressurized stack's interfacial resistance by more than a factor of 10 comprising applying pressure of at least 500 PSI.

107. The method of any one of claims 104-106, wherein the pressure is applied uniformly.

108. The method of any one of claims 104-107, comprising discharging the stack at a current density of at least 1 mA/cm².

109. An electrochemical cell comprising an electrode stack, a hydrostatic material, and an outer-shell material, wherein:
the electrode stack comprises a lithium metal negative electrode, a solid-state electrolyte, and a positive electrode;
wherein the electrode stack is contained within a hydrostatic material;
wherein the hydrostatic material is contained by an outer-shell material;
wherein the bulk modulus of the outer-shell material is greater than the bulk modulus of the hydrostatic material.

110. The electrochemical cell of claim 109, wherein the hydrostatic material is not conductive to electrons or ions.

111. The electrochemical cell of claim 109, wherein the hydrostatic material is an incompressible fluid.

112. The electrochemical cell of claim 109, further comprising conductive leads, wherein the conductive leads are in contact with the electrode stack and extend through the hydrostatic material and outer-shell material.

113. The electrochemical cell of claim 4, wherein the hydrostatic material is selected from polyisobutylene, butylpolypropylene, ethylene propylene diene monomer, polypropylene, and thermoplastic olefin.

114. The electrochemical cell of any one of claims 1-113, wherein the bulk modulus of the hydrostatic material is <1 GPa.

115. The electrochemical cell of any one of claims 1-114, wherein the outer-shell material is selected from a polyester material: acrylonitrile-butadiene-styrene, PC, polyethylene tetra phthalate, polyether ether ketone, and polyetherketone ketone.

116. The electrochemical cell of any one of claims 1-115, wherein the bulk modulus of the outer-shell material is >1 GPa.

117. The electrochemical cell of any one of claims 1-116, wherein the bulk modulus of the hydrostatic material is about 1 GPa or greater.

118. An electrochemical cell comprising one or more electrode stacks, a fluid, and a housing, wherein the electrode stack comprises a lithium metal negative electrode, a solid-state electrolyte, and a positive electrode; wherein the fluid contacts one of more of the stacks; wherein the bulk modulus of the housing is greater than the bulk modulus of the fluid.

119. The electrochemical cell of claim 18, wherein the fluid is an incompressible hydrostatic liquid.

120. The electrochemical cell of claim 18 or 119, wherein the fluid is a gas.

121. An electrochemical cell comprising one or more electrode stacks, a hydrostatic material, a compressible material, and an outer-shell material, wherein:
each of the one or more electrode stacks comprises a negative current collector, a solid-state electrolyte, a positive electrode, and a positive current collector;
wherein the hydrostatic material is contained by an outer-shell material; wherein the hydrostatic material applies a hydrostatic pressure to the negative current collector of 5-500 PSI gauge at 30° C.;
wherein the outer-shell material comprises a metal or metal alloy;
wherein the compressible material applies a uniaxial pressure to the one or more electrochemical stacks of 5-500 PSI gauge at 30° C.

122. A control apparatus for an electrochemical cell that controls a hydrostatic pressure in the electrochemical cell across the temperature range of 0-40° C. by modulating the quantity of liquid or gas in the cell.
